(19) United States
(12) Patent Application Publication
(10) Pub. No.: US 2005/0156780 A1
(43) Pub. Date: Jul. 21, 2005

(54) Methods and apparatus for automotive radar sensors

(75) Inventors: Andrew J. Bonthron, Los Angeles, CA (US); Gerald Juskovic, Newport Beach, CA (US)

Correspondence Address: IRELL & MANELLA LLP, 840 NEWPORT CENTER DRIVE, SUITE 400, NEWPORT BEACH, CA, 92660, US

(73) Assignee: GHz TR Corporation

(21) Appl. No.: 11/036,318

(22) Filed: Jan. 14, 2005

Related U.S. Application Data
(60) Provisional application No. 60/537,287, filed on Jan. 16, 2004.

(51) Int. Cl. G01S 13/93

(52) U.S. Cl. 342/107; 342/70; 342/196; 342/134; 342/137; 342/139

(57) ABSTRACT

Methods and apparatus are presented that reduce the overall system cost for automotive radar sensing applications through reduction of the number of the radar sensors required. In accordance with aspects of the present invention, one way sensor count reduction can be achieved is through the combination of target range, direction, and velocity determination capability with wide angular field of view coverage within a single sensor unit. One embodiment combines a wide field of view antenna means with a wideband/ultra-wideband/precision-ultra-wideband radar transmitter-receiver and an interferometric direction-finding means into a single sensor unit. Other methods and apparatus are presented.

### CROSS-REFERENCE TO RELATED APPLICATIONS

This application claims priority to U.S. Provisional Patent Application No. 60/537,287, filed Jan. 16, 2004, which is incorporated herein by reference.

### BACKGROUND OF THE INVENTION

1. Technical Field of the Invention

The subject matter disclosed generally relates to the field of automotive electronic systems and methods. More specifically, the subject matter disclosed relates to radar sensor arrangements that allow cost reduction and increased utility for automotive radar collision avoidance and driver aid applications.

2. Background of Related Art

To facilitate mass deployment of automotive radar sensors, reducing the total system cost per vehicle without compromising the capability, performance, or reliability of the system is desirable. Automotive short range sensing applications typically aim to provide a complete or nearly complete surrounding coverage around a vehicle, with high resolution target range, velocity, and angular resolution capability, and the ability to discriminate between multiple targets as required in near-distance driving scenarios. One way to reduce the system cost is to reduce the number of radar sensors necessary to provide the required coverage area and functionality for automotive collision avoidance and driving aid applications. One way this can be accomplished is through the creation of a compact radar sensor unit having a wide angular field of view coverage and containing target range, velocity, and direction-finding capability. By eliminating the need for multiple sensors having overlapping coverage area to determine a target direction, and by having a wide angular field of view coverage sensor with direction-finding capability over the entire field of view, cost reduction can be achieved for the overall system. Furthermore, by increasing the ability to discriminate between multiple targets at the same range, a more practical near-distance driving solution can be provided.

Typical automotive short-range radar sensor systems are composed of multiple discrete sensor units, each of which determines a target's range. A target's direction is typically determined through the comparison of the range measurements from a plurality of these sensor units, and calculated at the system level. A target's relative velocity is typically determined by positional variations over time by the system. Such systems may contain up to 12 sensors mounted around a car to achieve full-surround coverage area.

FIG. 1 illustrates one reduced sensor count configuration that is possible by integrating an antenna means having a wide angular field of view coverage with a radar sensing means having target range, velocity, and direction-finding capability into a single radar sensor unit. In this arrangement, a vehicle 66 such as a car or truck uses four of such integrated sensors 75, 76, 77, 78 to cover the front, rear, left and right side quadrants of the vehicle to provide a nearly complete surround coverage.

In applications for use in the United States, it would be desirable to have radar methods and apparatus capable of determining target range, direction, and velocity over a wide angular field of view coverage in a single compact, low-cost, mass-producible sensor that is compliant with the FCC UWB (ultra wide-band) regulations for automotive radar applications. Similarly, in applications for use in Europe, it would be desirable to have such methods and apparatus that are compliant with expected European regulations for automotive radar applications, as are currently being defined by the European Telecommunications Standards Institute (ETSI).

### BRIEF SUMMARY OF THE INVENTION

Methods and apparatus are presented which reduce the overall system cost for automotive radar sensing applications through reduction of the number of the radar sensors required. In accordance with aspects of the present invention, one way sensor count reduction can be achieved is through the combination of target range, direction, and velocity determination capability with wide angular field of view coverage within a single sensor unit. One embodiment combines a wide angle field of view antenna means with a wideband/ultra-wideband/precision-ultra-wideband radar transmitter-receiver and an interferometric direction-finding means in a single radar sensor unit. Other methods and apparatus are presented. Other aspects and advantages of the present invention can be seen upon review of the figures, the detailed description, and the claims which follow.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1 is a diagram illustrating a typical sensor arrangement for automotive sensor applications using radar sensors according to aspects of the present invention.

FIG. 2A is an electrical block diagram illustrating functions that enable radar sensor implementation with integrated target direction-finding capability according to one embodiment of the present invention.

FIG. 2B is an electrical block diagram illustrating functions that enable radar sensor implementation with integrated target direction-finding capability according to another embodiment of the present invention.

FIG. 3A is an electrical block diagram illustrating functions that enable radar sensor implementation with integrated target direction-finding capability according to a further embodiment of the present invention.

FIG. 3B is an electrical block diagram illustrating functions that enable radar sensor implementation with integrated target direction-finding capability according to a yet further embodiment of the present invention.

FIG. 3C is an electrical block diagram illustrating functions that enable radar sensor implementation with integrated target direction-finding capability according to another embodiment of the present invention.

FIG. 3D is an electrical block diagram illustrating functions that enable radar sensor implementation with integrated target direction-finding capability according to a further embodiment of the present invention.

FIG. 4A is a block diagram illustrating features of one embodiment of the Interferometric Signal Processor 300 according to aspects of the present invention.

FIG. 4B is a block diagram illustrating features of another embodiment of the Interferometric Signal Processor 300 according to aspects of the present invention.

FIG. 4C is a block diagram illustrating features of a further embodiment of the Interferometric Signal Processor 300 according to aspects of the present invention.

FIG. 4D is a block diagram illustrating features of a yet further embodiment of the Interferometric Signal Processor 300 according to aspects of the present invention.

FIG. 4E is a block diagram illustrating features of one embodiment of the Signal Processor 380 according to aspects of the present invention.

FIG. 4F is a block diagram illustrating features of another embodiment of the Signal Processor 380 according to aspects of the present invention.

FIG. 4G is a block diagram illustrating features of a further embodiment of the Signal Processor 380 according to aspects of the present invention.

FIG. 4H is a block diagram illustrating features of a yet further embodiment of the Signal Processor 380 according to aspects of the present invention.

FIG. 5A shows a multiple baseline receiver antenna means arrangement for the multiple baseline interferometry direction-finding technique in accordance with one embodiment of the present invention.

FIG. 5B shows a multiple baseline receiver antenna means arrangement for the multiple baseline interferometry direction-finding technique in accordance with another embodiment of the present invention.

FIG. 5C shows an example of a binary multiple-baseline receiver antenna means arrangement for the multiple baseline interferometry direction-finding technique in accordance with one aspect of the present invention.

FIG. 6 shows a receiver antenna means arrangement for the phase-comparison monopulse direction-finding technique in accordance with one embodiment of the present invention.

FIG. 7 shows a receiver antenna means arrangement and antenna gain pattern for the amplitude-comparison monopulse direction-finding technique in accordance with one embodiment of the present invention.

FIG. 8 shows a receiver antenna means arrangement for the multilateration direction-finding technique in accordance with one embodiment of the present invention.

FIG. 9A shows the top view of a low-cost, planar antenna element as an antenna means in accordance with one embodiment of the present invention.

FIG. 9B shows the cross-sectional view of a low-cost, planar antenna element as an antenna means in accordance with one embodiment of the present invention.

FIG. 10A shows a transmit-and-receive antenna means arrangement in accordance with one embodiment of the present invention.

FIG. 10B shows a switched antenna means arrangement in accordance with another embodiment of the present invention.

FIG. 10C shows a parallel-fed antenna means arrangement in accordance with a further embodiment of the present invention.

FIG. 10D shows a series-fed antenna means arrangement in accordance with a yet further embodiment of the present invention.

FIG. 10E shows a wide beam-width antenna gain pattern in accordance with one embodiment of the present invention.

FIG. 10F shows a narrow beam-width antenna gain pattern in accordance with another embodiment of the present invention.

FIG. 10G shows a parallel-fed, switched-beam antenna means arrangement in accordance with one embodiment of the present invention.

FIG. 10H shows a series-fed, switched-beam antenna means arrangement in accordance with one embodiment of the present invention.

FIG. 10i shows a switched-beam antenna means gain pattern in accordance with one embodiment of the present invention.

FIG. 11A is an electrical block diagram illustrating features of one embodiment of the Wideband/UWB/PUWB radar transmitter-receiver 200 according to aspects of the present invention.

FIG. 11B is an electrical block diagram illustrating features of another embodiment of the Wideband/UWB/PUWB radar transmitter-receiver 200 according to aspects of the present invention.

FIG. 11C is an electrical block diagram illustrating features of a further embodiment of the Wideband/UWB/PUWB radar transmitter-receiver 200 according to aspects of the present invention.

FIG. 11D is an electrical block diagram illustrating features of a yet further embodiment of the Wideband/UWB/PUWB radar transmitter-receiver 200 according to aspects of the present invention.

FIG. 12A is an electrical block diagram illustrating features of one embodiment of the modulation signal generator 230 according to aspects of the present invention.

FIG. 12B is an electrical block diagram illustrating features of another embodiment of the modulation signal generator 230 according to aspects of the present invention.

FIG. 12C is an electrical block diagram illustrating features of a further embodiment of the modulation signal generator 230 according to aspects of the present invention.

FIG. 12D is an electrical block diagram illustrating features of a yet further embodiment of the modulation signal generator 230 according to aspects of the present invention.

FIG. 12E is an electrical block diagram illustrating features of an alternate embodiment of the modulation signal generator 230 according to aspects of the present invention.

FIG. 12F is an electrical block diagram illustrating features of another embodiment of the modulation signal generator 230 according to aspects of the present invention.

FIG. 12G is an electrical block diagram illustrating features of a further embodiment of the modulation signal generator 230 according to aspects of the present invention.

FIG. 13A illustrates an output waveform from the modulation signal generator 230 in accordance with one embodiment of the present invention.

FIG. 13B illustrates an output waveform from the modulation signal generator 230 in accordance with another embodiment of the present invention.

FIG. 13C illustrates an output waveform from the modulation signal generator 230 in accordance with a further embodiment of the present invention.

FIG. 14A illustrates the PRI (pulse repetition interval) timing of the output waveform from the modulation signal generator 230 in accordance with one embodiment of the present invention.

FIG. 14B illustrates the PRI timing of the output waveform from the modulation signal generator 230 in accordance with another embodiment of the present invention.

FIG. 14C illustrates the PRI timing of the output waveform from the modulation signal generator 230 in accordance with a further embodiment of the present invention.

FIG. 14D illustrates the PRI timing of the output waveform from the modulation signal generator 230 in accordance with a yet further embodiment of the present invention.

FIG. 14E illustrates the PRI timing of the output waveform from the modulation signal generator 230 in accordance with an alternate embodiment of the present invention.

FIG. 14F illustrates the PRI timing of the output waveform from the modulation signal generator 230 in accordance with another embodiment of the present invention.

FIG. 14G illustrates the PRI timing of the output waveform from the modulation signal generator 230 in accordance with a further embodiment of the present invention.

FIG. 15A is an electrical block diagram illustrating features of one embodiment of the Wideband/UWB/PUWB radar transmitter-receiver 200 according to aspects of the present invention.

FIG. 15B is an electrical block diagram illustrating features of another embodiment of the Wideband/UWB/PUWB radar transmitter-receiver 200 according to aspects of the present invention.

FIG. 16A is an electrical block diagram illustrating features of one embodiment of the Wideband/UWB/PUWB radar transmitter-receiver 200 according to aspects of the present invention.

FIG. 16B is an electrical block diagram illustrating features of another embodiment of the Wideband/UWB/PUWB radar transmitter-receiver 200 according to aspects of the present invention.

FIG. 16C is an electrical block diagram illustrating features of a further embodiment of the Wideband/UWB/PUWB radar transmitter-receiver 200 according to aspects of the present invention.

FIG. 16D is an electrical block diagram illustrating features of yet a further embodiment of the Wideband/UWB/PUWB radar transmitter-receiver 200 according to aspects of the present invention.

FIG. 17A is an electrical block diagram illustrating features of one embodiment of the Wideband/UWB/PUWB radar transmitter-receiver 200 according to aspects of the present invention.

FIG. 17B is an electrical block diagram illustrating features of another embodiment of the Wideband/UWB/PUWB radar transmitter-receiver 200 according to aspects of the present invention.

FIG. 18A is an electrical block diagram illustrating features of one embodiment of the Wideband/UWB/PUWB radar transmitter-receiver 200 according to aspects of the present invention.

FIG. 18B is an electrical block diagram illustrating features of another embodiment of the Wideband/UWB/PUWB radar transmitter-receiver 200 according to aspects of the present invention.

FIG. 18C is an electrical block diagram illustrating features of a further embodiment of the Wideband/UWB/PUWB radar transmitter-receiver 200 according to aspects of the present invention.

FIG. 18D is an electrical block diagram illustrating features of a yet further embodiment of the Wideband/UWB/PUWB radar transmitter-receiver 200 according to aspects of the present invention.

FIG. 18E is an electrical block diagram illustrating features of another embodiment of the Wideband/UWB/PUWB radar transmitter-receiver 200 according to aspects of the present invention.

FIG. 18F is an electrical block diagram illustrating features of a further embodiment of the Wideband/UWB/PUWB radar transmitter-receiver 200 according to aspects of the present invention.

FIG. 19A is an electrical block diagram illustrating features of one embodiment of the Wideband/UWB/PUWB radar transmitter-receiver 200 according to aspects of the present invention.

FIG. 19B is an electrical block diagram illustrating features of another embodiment of the Wideband/UWB/PUWB radar transmitter-receiver 200 according to aspects of the present invention.

FIG. 19C is an electrical block diagram illustrating features of a further embodiment of the Wideband/UWB/PUWB radar transmitter-receiver 200 according to aspects of the present invention.

FIG. 19D is an electrical block diagram illustrating features of a yet further embodiment of the Wideband/UWB/PUWB radar transmitter-receiver 200 according to aspects of the present invention.

FIG. 19E is an electrical block diagram illustrating features of another embodiment of the Wideband/UWB/PUWB radar transmitter-receiver 200 according to aspects of the present invention.

FIG. 19F is an electrical block diagram illustrating features of a further embodiment of the Wideband/UWB/PUWB radar transmitter-receiver 200 according to aspects of the present invention.

FIG. 20A is an electrical block diagram illustrating features of one embodiment of the Frequency Hopping Signal Generator 295 according to aspects of the present invention.

FIG. 20B is an electrical block diagram illustrating features of another embodiment of the Frequency Hopping Signal Generator 295 according to aspects of the present invention.

FIG. 21A illustrates an output modulation pattern from the Frequency Hopping Signal Generator 295 in accordance with one embodiment of the present invention.

FIG. 21B illustrates an output modulation pattern from the Frequency Hopping Signal Generator 295 in accordance with another embodiment of the present invention.

FIG. 21C illustrates an output modulation pattern from the Frequency Hopping Signal Generator 295 in accordance with a further embodiment of the present invention.

FIG. 21D illustrates an output modulation pattern from the Frequency Hopping Signal Generator 295 in accordance with a yet further embodiment of the present invention.

FIG. 21E illustrates an output modulation pattern from the Frequency Hopping Signal Generator 295 in accordance with another embodiment of the present invention.

FIG. 22A is an electrical block diagram illustrating features of one embodiment of the Wideband/UWB/PUWB radar transmitter-receiver 200 according to aspects of the present invention.

FIG. 22B is an electrical block diagram illustrating features of another embodiment of the Wideband/UWB/PUWB radar transmitter-receiver 200 according to aspects of the present invention.

FIG. 23A is an electrical block diagram illustrating features of one embodiment of the Wideband/UWB/PUWB radar transmitter-receiver 200 according to aspects of the present invention.

FIG. 23B is an electrical block diagram illustrating features of another embodiment of the Wideband/UWB/PUWB radar transmitter-receiver 200 according to aspects of the present invention.

FIG. 24A is a block diagram illustrating features that enable low cost, high frequency integrated circuit packaging and external circuit interconnection according to one embodiment of the present invention.

FIG. 24B is a block diagram illustrating features that enable low cost, high frequency integrated circuit packaging and external circuit interconnection according to another embodiment of the present invention.

FIG. 25A shows the top view of an integrated circuit die to substrate attachment means in accordance with one embodiment of the present invention.

FIG. 25B shows the cross-sectional view of an integrated circuit die to substrate attachment means in accordance with one embodiment of the present invention.

FIG. 25C shows the bottom view of a flip-chip connection means pattern in accordance with one embodiment of the present invention.

FIG. 25D shows the bottom view of a flip-chip connection means pattern in accordance with another embodiment of the present invention.

FIG. 26A shows the top view of an integrated circuit die to substrate attachment means in accordance with one embodiment of the present invention.

FIG. 26B shows the cross-sectional view of an integrated circuit die to substrate attachment means in accordance with one embodiment of the present invention.

FIG. 27A shows the top view of a high frequency substrate means in accordance with one embodiment of the present invention.

FIG. 27B shows the cross-sectional view of a high frequency substrate means in accordance with one embodiment of the present invention.

FIG. 28A shows the bottom view of a substrate external interconnection means in accordance with one embodiment of the present invention.

FIG. 28B shows the top view of a substrate external interconnection method in accordance with one embodiment of the present invention.

FIG. 28C shows the cross-sectional view of a substrate external interconnection method in accordance with one embodiment of the present invention.

FIG. 28D shows the bottom view of a substrate external interconnection means in accordance with another embodiment of the present invention.

FIG. 28E shows the top view of a substrate external interconnection method in accordance with another embodiment of the present invention.

FIG. 28F shows the cross-sectional view of a substrate external interconnection method in accordance with another embodiment of the present invention.

FIG. 28G shows the bottom view of a substrate external interconnection means in accordance with a further embodiment of the present invention.

FIG. 28H shows the top view of a substrate external interconnection method in accordance with a further embodiment of the present invention.

FIG. 28i shows the cross-sectional view of a substrate external interconnection method in accordance with a further embodiment of the present invention.

FIG. 29A shows the top view of a cover means for a substrate in accordance with one embodiment of the present invention.

FIG. 29B shows the cross-sectional view of a cover means for a substrate in accordance with one embodiment of the present invention.

FIG. 29C shows the top view of a cover means for a substrate in accordance with another embodiment of the present invention.

FIG. 29D shows the cross-sectional view of a cover means for a substrate in accordance with another embodiment of the present invention.

FIG. 29E shows the top view of a cover means for a substrate in accordance with a further embodiment of the present invention.

FIG. 29F shows the cross-sectional view of a cover means for a substrate in accordance with a further embodiment of the present invention.

FIG. 30A shows the top view of an exemplary integrated circuit packaging and external mounting method in accordance with aspects of the present invention.

FIG. 30B shows the cross-sectional view of an exemplary integrated circuit packaging and external mounting method in accordance with aspects of the present invention.

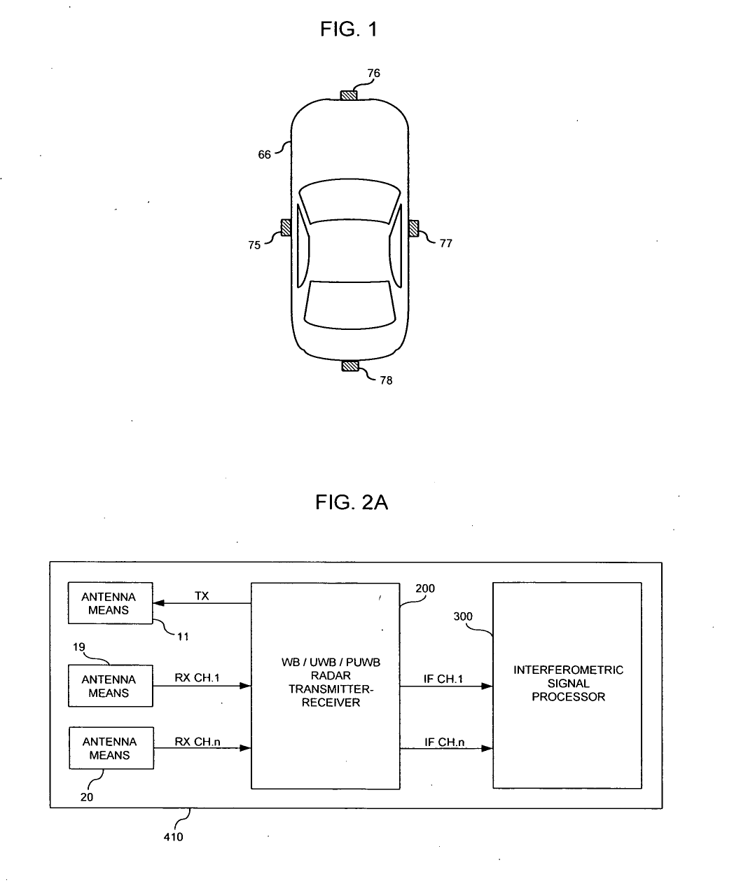

### DETAILED DESCRIPTION

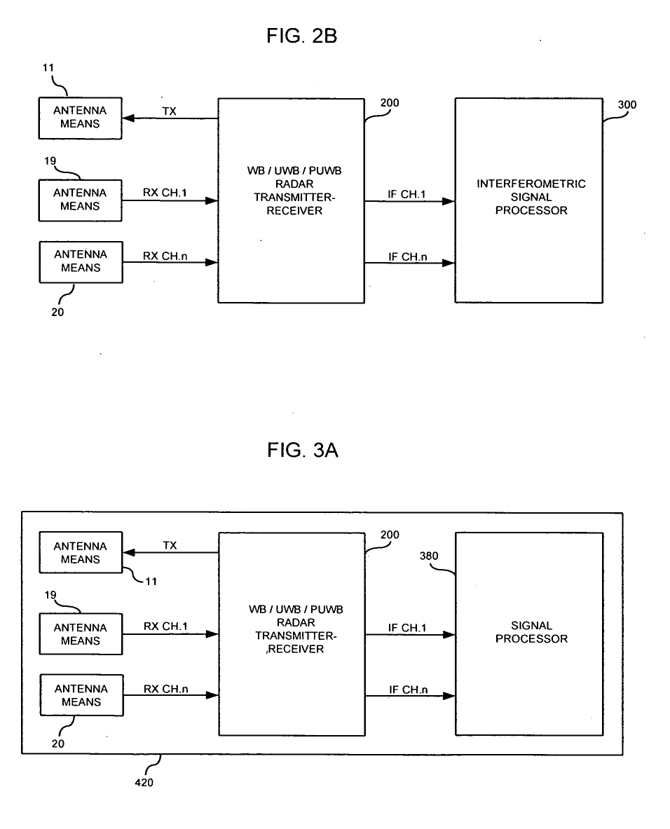

One embodiment of the generalized diagram shown in FIG. 2A illustrates the features of an integrated radar sensor unit 410 capable of determining the range, velocity, and direction of a target in a low-cost, mass-production capable unit, in accordance with aspects of the present invention. A wideband (WB)/ultra-wideband (UWB)/precision-ultra-wideband (PUWB) radar transmitter-receiver 200 is coupled to a transmit antenna means 11, a plurality of receiver antenna means 19, 20, and an interferometric signal processor 300. The WB/UWB/PUWB radar transmitter-receiver unit 200 is connected to transmit antenna means 11, and transmits an electromagnetic signal towards a target. The reflected signal from the target is received by n spatially separated receiver antennas 19, 20, where n is a number greater than or equal to 3, and down-converted to a plurality of intermediate frequency (IF) signals, then processed in an interferometric signal processor 300. Detected target signals in the signal processor 300 have their phases measured and compared across the plurality of receiver channels to determine the target direction through a multiple-baseline interferometry calculation process.

This configuration does not preclude the use of an additional processor exterior to the sensor unit 410 for the purpose of data processing, processing or fusion of data from multiple sensor units 410, processing or data fusion with additional dissimilar sensor technologies, or coordination across multiple sensor units. Furthermore, if interferometric signal processor 300 utilizes a plurality of individual processors, one or more of the individual processors may be mounted remotely from the sensor unit 410 without departing from the spirit of the present invention. A feature of this sensor arrangement is the use of multi-channel phase comparison of the down-converted IF signals using a multiple-baseline interferometry direction-finding technique to determine the target angular location, which will be described in more detail below. Using this technique the separation distances between the antenna means are on the order of λ/2 to several λ long, and thus short enough to be integrated into a practical single sensor unit. The transmit bandwidth required by the radar transmitter-receiver 200 is determined by the range resolution requirements of the application. Depending on the automotive application, this can be achieved with either a wideband radar transmitter-receiver defined by 100 MHz or greater transmit bandwidth, an ultra-wideband radar transmitter-receiver defined by 500 MHz or greater transmit bandwidth, or a precision-ultra-wideband radar transmitter-receiver defined by greater than 1000 MHz transmit bandwidth.

One embodiment of the generalized diagram shown in FIG. 2B illustrates the features of a radar sensor capable of determining the range, velocity, and direction of a target in a low-cost, mass-production capable arrangement, in accordance with aspects of the present invention. This arrangement is similar to the arrangement in FIG. 2A with the exception that one or more of the antenna means 11, 19, 20, or interferometric signal processor 300 may be mounted remotely from the sensor unit, allowing collocation of the transmit-receive electronics, but allowing longer antenna baselines to be achieved than is practical in a single sensor unit size, or allowing signal processing to be performed outside of the sensor unit. Furthermore, for the case where signal processing may be performed remotely, the analog to digital (A/D) converter portion of the interferometric signal processor block 300 may be located within the sensor unit, and a portion or the entirety of the processing located remotely.

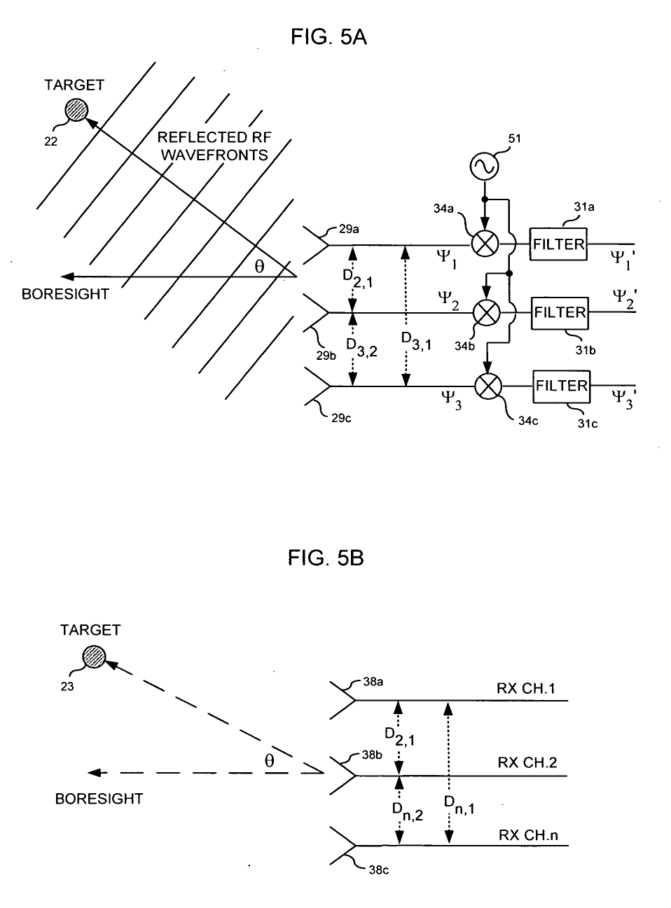

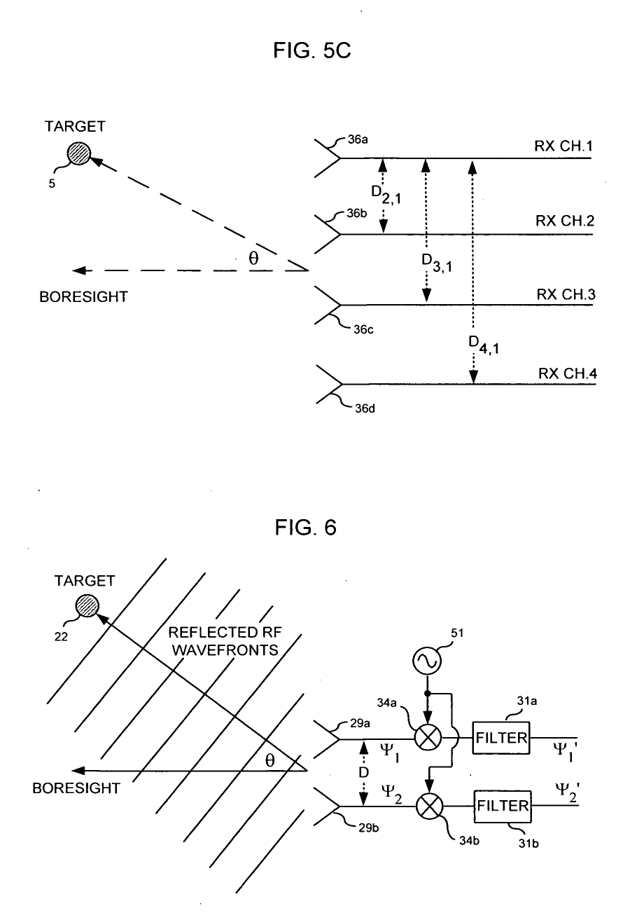

FIG. 5A illustrates the multiple baseline interferometry direction-finding technique. An electromagnetic signal is reflected from a target 22 with a wavelength λ, and the signal is received by 3 antenna means 29a, 29b, 29c. It is assumed that the reflected electromagnetic wavefronts are generally planar. The antenna elements 29a, 29b, 29c are separated by baseline distances D_{2,1}, D_{3,2}, D_{3,1} and the target direction angle from boresight is θ. While FIG. 5A illustrates a receiver with 3 spatially separated antenna means, the technique described can be applied to a receiver with n spatially separated antenna means, where n is an integer greater than or equal to 3. The received electromagnetic signal must travel a longer distance to reach antenna means 29b and 29c than to reach antenna means 29a for a positive value of θ. This difference in travel distance causes a phase difference for the D_{2,1} baseline of ΔΨ_{2,1}=Ψ₂−Ψ₁ between antenna means 29a and 29b. The phase can be measured and compared between the two receiver channels at the input frequency, or more conveniently can be measured and compared after down-conversion at the IF frequency, since phase is preserved after down-conversion. A simple down-conversion circuit is illustrated in which a local oscillator 51 feeds mixers 34a, 34b, 34c which mix down the received RF signals. Filters 31a, 31b, 31c then pass the down-converted IF signals. The phase difference between the IF signals for baseline D_{2,1} is ΔΨ_{2,1}′=Ψ₂′−Ψ₁′ and is equivalent to the phase difference ΔΨ_{2,1}. Let u be an integer with a value in the range from 2 to n. Let v be an integer with a value in the range from 1 to n−1. The equation relating the calculated target direction angle estimate θ_{u,v} to the measured phase difference ΔΨ_{u,v}, ambiguity number K_{u,v}, wavelength λ, and antenna separation distance D_{u,v} is:

$${θ}_{u , v} = arcsin [ ( \frac{Δ {Ψ}_{u , v}}{2 π} + {K}_{u , v} ) \cdot \frac{λ}{{D}_{u , v}} ] \qquad ( 1 )$$

where λ is the average received wavelength of the modulated radar signal during a coherent measurement interval, and K_{u,v} is an integer within the integer set 0, 1, 2, . . . whose maximum allowed value is the highest integer less than or equal to the value M_{u,v} defined by the inequality:

$$( \frac{Δ {Ψ}_{u , v}}{2 π} + {M}_{u , v} ) \cdot \frac{λ}{{D}_{u , v}} \leq 1 \qquad ( 2 )$$

A coherent measurement interval is a period of time during which a signal such as an IF signal is measured, processed, or time-sampled and stored as a signal segment. One example of this is when during a coherent measurement interval, an IF signal is time-sampled, and the time-samples are associated as part of a signal segment which is then processed or measured as a unified, discrete-time signal segment.

From the above equations it can be seen that antenna baseline distances D_{u,v} above a certain length will create multiple possible values of K_{u,v} in (1), and thus multiple solutions of target direction angle estimate θ_{u,v} in (1) are possible, presenting ambiguity. The RMS error of the calculated target direction angle estimate θ_{u,v} is:
Δθ_{u,v}=λ/[D_{u,v}·π·cos θ·\sqrt{SNR}] (3)
where SNR is the value of the signal to noise ratio of the measured target signals. From the above equation (3) it can be seen that the RMS error Δθ_{u,v} of the calculated target angle estimate θ_{u,v} is decreased for an increased baseline distance D_{u,v}. However, as described above, there is a maximum value for D_{u,v} that maintains an unambiguous calculated target angle estimate θ_{u,v}. Since many automotive applications can benefit from high angular accuracy, generally 1 degree or better, over a wide angle field of view, preferably as close to 180 degrees as possible for reduction of number of sensors required, it is beneficial to utilize a multiple-baseline interferometry method which increases angular accuracy while overcoming the angular ambiguity.

FIG. 5B illustrates one embodiment of the present invention in which a multiple-baseline interferometry direction-finding technique is used by the interferometric signal processor 300, or the signal processor 380. This technique provides increased angular accuracy when compared with the phase monopulse technique, as well as angular ambiguity resolution. Antenna means elements 38a, 38b, 38c form a receiver array of n antenna means elements with n receiver channels, where n is an integer of value 3 or greater. Thus, the multiple-baseline interferometry technique is applicable to receiver arrays comprising 3 elements, 4 elements, 5 elements, 6 elements, etc. The n element array has element center-to-center spacing of D_{2,1}, D_{n,2}, D_{n,1}.

The basic principle of multiple-baseline interferometry is that target direction angular accuracy is improved by comparing the phase of antenna elements with longer separation distances, while target direction angle ambiguities are resolved by comparing the phase of antenna elements with shorter separation distances. As an example, not meant in any way to limit the scope of the technique, let n=3 and let the antenna means elements 38a, 38b, 38c be arrayed in the azimuth axis, and let each have a 170-degree azimuth field of view centered around boresight. Let the separation distance D_{2,1} be set to λ/2 and phase difference ΔΨ_{2,1} be compared between elements 38a and 38b for an unambiguous calculation of target direction angle estimate θ_{2,1} over the entire field of view. Let the separation distance D_{3,2} be set to λ/2 such that the total separation distance D_{3,1} between elements 38a and 38c is λ, and let the phase difference ΔΨ_{3,1} be compared between elements 38a and 38c. The calculated target direction angle estimate θ_{3,1} will be more accurate using the phase comparison ΔΨ_{3,1} of elements 38a and 38c due to the longer baseline distance D_{3,1}, but it will be ambiguous due to multiple possible values of K_{3,1} in (1), producing multiple values of θ_{3,1}. The ambiguity can be resolved by using the less accurate but unambiguous target direction angle estimate θ_{2,1} from the shorter baseline phase comparison ΔΨ_{2,1} of elements 38a and 38b to determine correct value of K_{3,1} in (1) by selecting the higher precision target direction angle estimate θ_{3,1} from the ambiguous set as the value closest to the target direction angle estimate θ_{2,1}. This technique of using shorter baseline measurement pairs to resolve ambiguities in longer baseline measurement pairs is a feature of multiple-baseline interferometry, and can be extended to an n element array with n−1 independent baseline measurement pairs.

One technique for selection of the separation distances of the receive antenna element array in accordance with one embodiment of the present invention is to create a binary distance relationship between antenna element phase measurement baselines. In this technique, the shortest measurement baseline distance is selected such that it provides an unambiguous target angle calculation result over the entire field of view of the antenna elements. The next longer measurement baseline distance is set to be twice that of the previous measurement baseline distance. This is continued for all the measurement baseline distances of the array. FIG. 5C shows an example of this binary baseline technique, not meant in any way to limit its scope or extension. Let the antenna means elements 36a, 36b, 36c, 36d be arrayed in the azimuth axis, and let each have a 170-degree azimuth field of view centered around boresight. Let the separation distance D_{2,1} be set to λ/2 and phase be compared between elements 36a and 36b for an unambiguous calculation of target direction angle estimate θ_{2,1} over the entire field of view. Let the separation distance D_{3,1} be set to λ such that the total separation distance between elements 36a and 36c is λ, and let the phase be compared between elements 36a and 36c. Let the separation distance D_{4,1} be set to 2λ such that the total separation distance between elements 36a and 36d is 2λ, and let the phase be compared between elements 36a and 36d. In this example, the unambiguous calculation of target direction angle estimate θ_{2,1} by the shortest baseline pair 36a, 36b is used to resolve the ambiguity in the calculation of target direction angle estimate θ_{3,1} by the next longer baseline pair 36a, 36c. The resolved calculation of target direction angle estimate θ_{3,1} by baseline pair 36a, 36c is more accurate than the previous calculation of target direction angle estimate θ_{2,1} by baseline pair 36a, 36b. The resolved calculation of target direction angle estimate θ_{3,1} by baseline pair 36a, 36c is now used to resolve the ambiguity in the calculation of target direction angle estimate θ_{4,1} by the next longer baseline pair 36a, 36d. The resolved calculation of target direction angle estimate θ_{4,1} by baseline pair 36a, 36d is more accurate than the previous calculation of target direction angle estimate θ_{3,1} by baseline pair 36a, 36c. Thus, using this technique, successively more accurate estimates of target angle θ are achieved for each successively longer binary baseline pair, with the measurement of the previous pair used to resolve target angle ambiguity.

In general, the multiple-baseline interferometry technique can be used with non-binary related baseline distances, in accordance with another embodiment of the present invention. For example, the baseline distances could be λ/2 and 3λ/4. This technique can be used to enhance the target signal wavelength range over which the array resolves target direction angle ambiguity, or to meet space constraints for the sensor array.

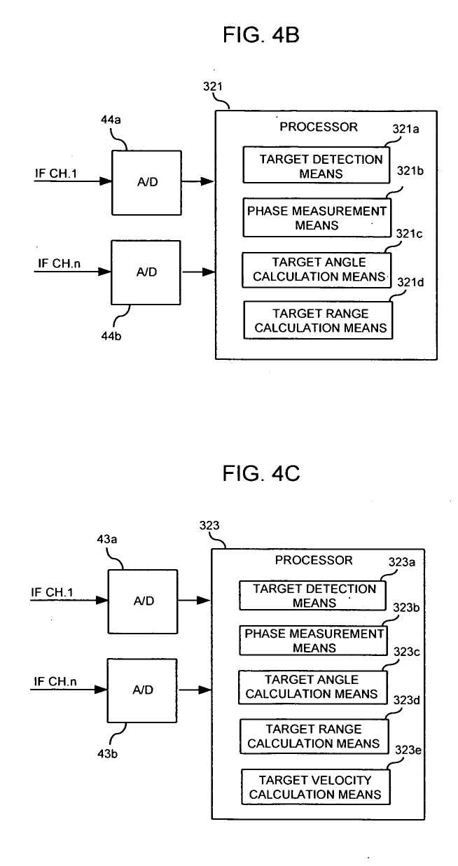

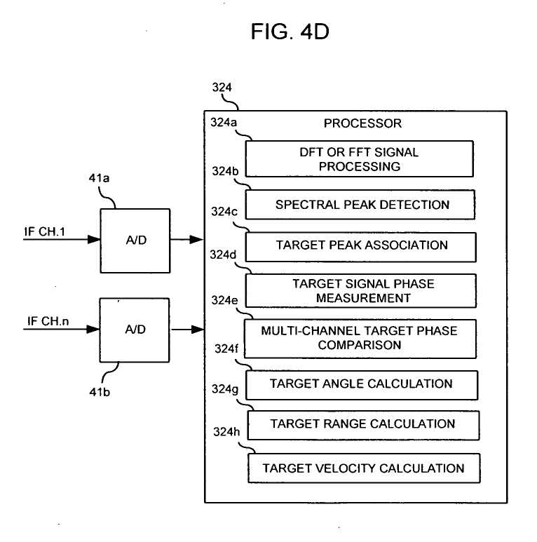

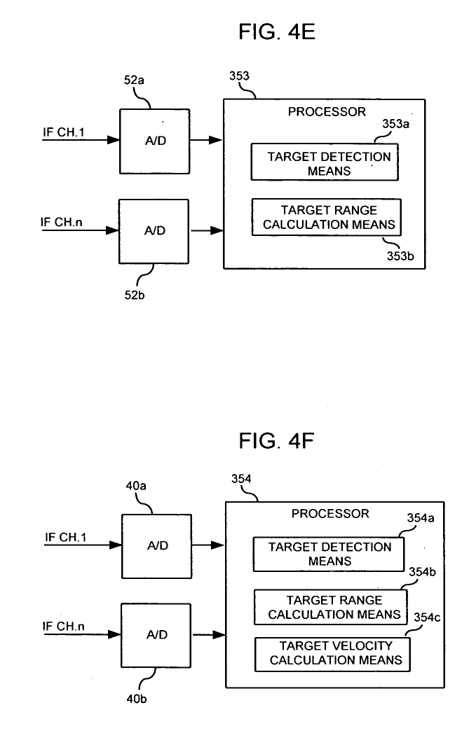

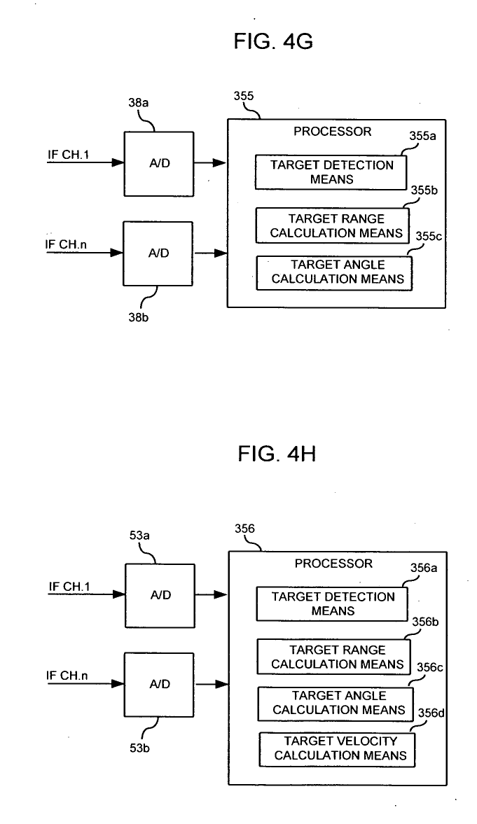

One embodiment of the interferometric signal processor 300 is illustrated in FIG. 4A. Analog to digital converter means 46a, 46b digitize n analog IF channels, where n is an integer greater than or equal to 3. The digitized IF signals are then input to processor means 325. Processor means 325 may comprise a single or plurality of individual processors. Processor means 325 measures the phases of the digitized IF signals using a phase measurement means 325a, then compares the phases and uses the multiple baseline interferometry direction-finding technique to calculate the target direction angle through angle calculation means 325c. Target angle processing and ambiguity resolution can be enhanced through the measurement of signal amplitudes in addition to their phases. Furthermore, the multiple baseline interferometry technique can be combined with other techniques such as amplitude-comparison monopulse or multilateration in the processor 300 for the purpose of improving angle calculation performance, reduction in false alarms, improvement in multiple target discrimination, or reduction in processor load. The processing techniques used by signal processor 325 may include, but are not limited to, a real or complex discrete Fourier transform (DFT) or fast Fourier transform (FFT), windowing, digital filtering, or Hilbert transform. The processor means 325 may include, but is not limited to, a digital signal processor (DSP), microprocessor, microcontroller, electrical control unit, or other suitable processor block.

Another embodiment of the interferometric signal processor 300 is shown in FIG. 4B. In this arrangement, analog to digital converter means 44a, 44b digitize n analog IF channels, where n is an integer greater than or equal to 3. The digitized IF signals are then input to processor means 321. Processor means 321 may comprise a single or plurality of individual processors. Processor means 321 performs target detection through target detection means 321a, phase measurement of all digitized IF channels through phase measurement means 321b, calculates the target direction angle by phase comparison using multiple baseline interferometry direction-finding techniques through target angle calculation means 321c, and determines the target range through target range calculation means 321d. Target angle processing and ambiguity resolution can be enhanced through the measurement of signal amplitudes in addition to their phases. Furthermore, the multiple-baseline interferometry technique can be combined with other techniques such as amplitude-comparison monopulse or multilateration in the processor 300 for the purpose of improving angle calculation performance, reduction in false alarms, improvement in multiple target discrimination, or reduction in processor load. The processing techniques used by processor means 321 may include, but are not limited to, windowing, a real or complex DFT or FFT, digital filtering, Hilbert transform, constant false alarm rate (CFAR) threshold detection, spectral peak detection, digital beam-forming, least squares algorithms, non-linear least squares algorithms, or super-resolution algorithms such as the multiple signal classification (MUSIC) algorithm. The processor means 321 may include, but is not limited to, a digital signal processor (DSP), microprocessor, microcontroller, electrical control unit, or other suitable processor block.

A further embodiment of the interferometric signal processor 300 is shown in FIG. 4C. This arrangement is similar to the arrangement in FIG. 4B, with the exception that within processor 323, the additional function of determining the target velocity through the use of target velocity calculation means 323e is included. Functions 323a, 323b, 323c, 323d are similar to functions 321a, 321b, 321c, 321d respectively, previously described. In this arrangement, analog to digital converter means 43a, 43b digitize n analog IF channels, where n is an integer greater than or equal to 3. The digitized IF signals are then input to processor means 323. Processor means 323 may comprise a single or plurality of individual processors. Target velocity calculation means 323e may include, but is not limited to, Doppler processing or derivation through successive time target measured positions. Target velocity derived from Doppler processing can also be used as a target discrimination means to aid in target separation and processing, especially in the situation where multiple target returns are from the same range or within the same range bin of the radar. Furthermore, target velocity can be determined externally from the radar sensor unit, such as in an external processor or on the radar system level, without departing from the spirit of the present invention.

A yet further embodiment of the interferometric signal processor 300 is shown in FIG. 4D. In this arrangement, analog to digital converter means 41a, 41b digitize n analog IF channels, where n is an integer greater than or equal to 3. The digitized IF signals are then input to processor means 324. Processor means 324 may comprise a single or plurality of individual processors. Processor means 324 performs, but is not limited to, the functions of real or complex DFT or FFT signal processing 324a, spectral peak detection 324b, target peak association 324c, target signal phase measurement 324d, multi-channel target signal phase comparison 324e, target angle calculation 324f, target range calculation 324g, and target velocity calculation 324h. Target angle calculation processing may include, but is not limited to, multiple-baseline interferometry direction-finding techniques. Target angle processing and ambiguity resolution can be enhanced through the measurement of signal amplitudes in addition to their phases. Furthermore, the multiple-baseline interferometry technique can be combined with other techniques such as amplitude-comparison monopulse, multilateration, or switched-beam detection zone discrimination in the processor 300 for the purpose of improving angle calculation performance, reduction in false alarms, improvement in multiple target discrimination, or reduction in processor load. Target angle processing may include, but is not limited to, spectral peak phase measurement, spectral peak amplitude measurement, or spectral peak frequency measurement. Target range calculation processing may include, but is not limited to, spectral peak frequency measurement, spectral peak phase measurement, or signal envelope amplitude measurement. Target velocity calculation processing may include, but is not limited to, Doppler processing or derivation through successive time target measured positions. Target velocity derived from Doppler processing can also be used as a target discrimination means to aid in target separation and processing, especially in the situation where multiple target returns are from the same range or within the same range bin of the radar. Additional processing techniques used in the abovementioned functions may include, but are not limited to, windowing, digital filtering, Hilbert transform, CFAR threshold detection, least squares algorithms, non-linear least squares algorithms, digital beam-forming, or super-resolution algorithms such as multiple signal classification (MUSIC). The processor means 324 may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

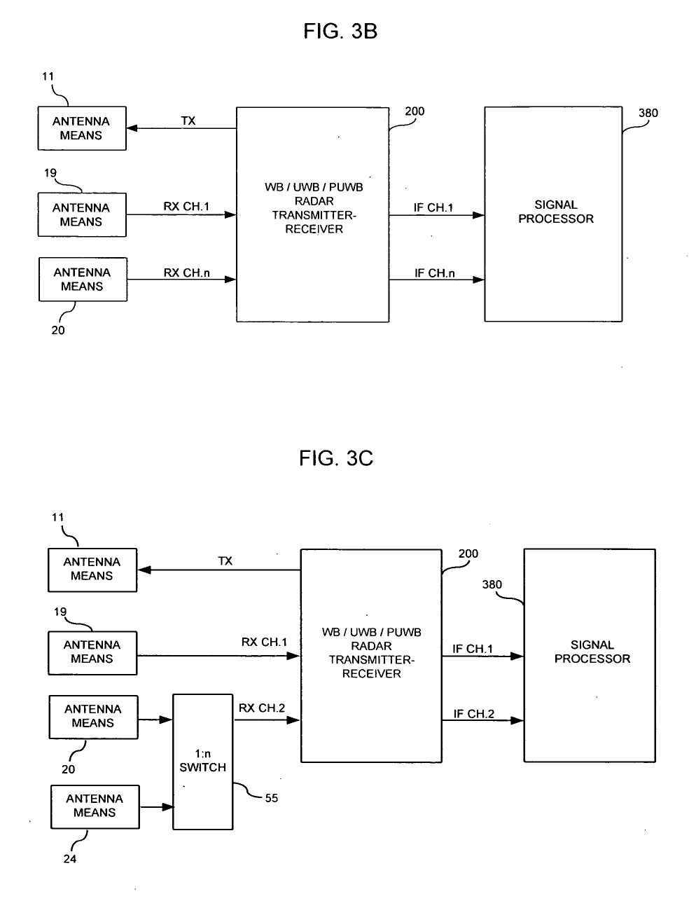

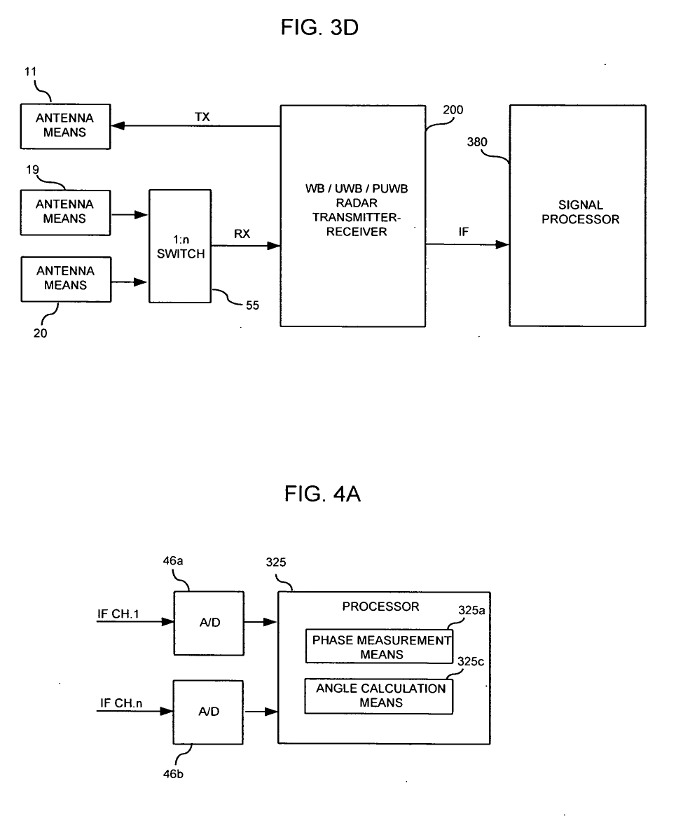

One embodiment of the present invention shown in FIG. 3A illustrates an integrated radar sensor unit 420 capable of determining the range, velocity, and direction of a target in a low-cost unit suitable for mass production. A WB/UWB/PUWB radar transmitter-receiver unit 200 is connected to transmit antenna means 11 and transmits an electromagnetic signal towards a target. The reflected signal from the target is received by n spatially separated receiver antennas 19, 20, where n is a number greater than or equal to 2, and down-converted to a plurality of IF signals, then processed in a signal processor 380. In this arrangement, the target direction-finding techniques used may include, but are not limited to, phase-comparison monopulse, amplitude-comparison monopulse, multilateration, multiple-baseline interferometry, or any combination of these methods. This configuration does not preclude the use of an additional processor exterior to the sensor unit 420 for the purpose of further data processing, processing or fusion of data from multiple sensor units 420, processing or data fusion with additional dissimilar sensor technologies, or coordination across multiple sensor units. Furthermore, if signal processor 380 utilizes a plurality of individual processors, one or more of the individual processors may be mounted remotely from the sensor unit 420 without departing from the spirit of the present invention. Depending on the automotive application, either a wideband radar transmitter-receiver defined by 100 MHz or greater transmit bandwidth, an ultra-wideband radar transmitter-receiver defined by 500 MHz or greater transmit bandwidth, or a precision-ultra-wideband radar transmitter-receiver defined by greater than 1000 MHz transmit bandwidth can be used.

FIG. 3B shows a radar sensor arrangement in accordance with another embodiment of the present invention. This arrangement is similar to the arrangement in FIG. 3A, with the exception that one or more of the antenna means 11, 19, 20, or signal processor 380 may be mounted remotely from the sensor unit, allowing collocation of the transmit-receive electronics and signal processing, but allowing longer antenna baselines to be achieved than is practical in a single-sensor unit size, or allowing signal processing to be performed outside of the sensor unit. Furthermore, for the case where signal processing may be performed remotely, the A/D converter portion of the signal processor block 380 may be located within the sensor unit, and a portion or the entirety of the processing located remotely.

FIG. 3C illustrates a radar sensor arrangement in accordance with a further embodiment of the present invention. This arrangement is similar to the arrangement in FIG. 3A, with the exception that n receiver antenna means 20, 24, where n is an integer greater than or equal to 2, share a common receiver in a time-division manner through the use of switching element 55. Another receiver antenna means 19 is connected to a dedicated receiver channel. The components illustrated in FIG. 3C may be collocated in a single sensor unit such as shown in FIG. 3A, or one or more antenna means or processing means may be remotely mounted from the sensor unit such as shown in FIG. 3B.

FIG. 3D illustrates a radar sensor arrangement in accordance with a yet further embodiment of the present invention. This arrangement is similar to the arrangement in FIG. 3A, with the exception that n receiver antenna means 19, 20, where n is an integer greater than or equal to 2, share a common receiver in a time-division manner through the use of switching element 55. A single IF signal is input to signal processor 380. With the knowledge of the switching period for each receiver antenna channel, the time-division measured signals of the IF can be measured and used in target direction determination methods. The components illustrated in FIG. 3D may be collocated in a single sensor unit such as shown in FIG. 3A, or one or more antenna means or processing means may be remotely mounted from the sensor unit such as described in FIG. 3B.

Another embodiment of the present invention is the use of a plurality of transmit channels which transmit a plurality of simultaneous transmit signals toward a target. The diagrams shown in FIGS. 2A, 2B, 3A, 3B, 3C, and 3D can be modified to accommodate multiple transmit channels in accordance with aspects of the present invention. One benefit of the use of a plurality of transmit signals is the reduction of the measurement time necessary for data collection for range-velocity ambiguity resolution, and an increased update rate or decreased response time for the radar system, which can be beneficial for short range automotive collision avoidance applications. For example, not meant in any way to limit the scope or extension of the present invention, let the radar sensor described in FIG. 3A have two TX channels, and let the transmitter-receiver 200 use a linear frequency modulated continuous wave (FMCW) radar technique. Let one of the two TX channels transmit an up-chirp linearly frequency modulated radar wave, while the other TX channel simultaneously transmits a down-chirp linearly frequency modulated radar wave of the same or different center frequency. After down-conversion, the processor 380 samples the IF signals using A/D conversion and collects this data during one coherent measurement period, and signal processes this data to resolve the range-velocity ambiguity. When compared to a similar radar which uses only one TX channel and transmits the up-chirp and down-chirp FMCW radar waveform sequentially over two consecutive coherent measurement periods, the data used for range-velocity ambiguity resolution can be collected in only one coherent measurement period, or half the time.

One embodiment of the signal processor 380 is illustrated in FIG. 4E. Analog-to-digital (A/D) converter means 52a, 52b digitize n analog IF channels, where n is an integer greater than or equal to 2. The digitized IF signals are then input to processor means 353. Processor means 353 may comprise a single or plurality of individual processors. Processor means 353 performs target detection through target detection means 353a, and target range determination through target range calculation means 353b. The processing techniques used by the processor 353 may include, but are not limited to, a real or complex DFT or FFT, digital filtering, Hilbert transform, spectral peak detection, CFAR threshold detection, spectral peak frequency measurement, spectral peak phase measurement, signal phase measurement, signal frequency measurement, or signal envelope amplitude measurement. The processor means 353 may include, but is not limited to, a digital signal processor (DSP), microprocessor, microcontroller, electrical control unit, or other suitable processor block.

Another embodiment of the signal processor 380 is illustrated in FIG. 4F. Analog-to-digital (A/D) converter means 40a, 40b digitize n analog IF channels, where n is an integer greater than or equal to 2. The digitized IF signals are then input to processor means 354. Processor means 354 may comprise a single or plurality of individual processors. Processor means 354 performs target detection through target detection means 354a, target range determination through target range calculation means 354b, and target velocity determination through target velocity calculation means 354c. The processing techniques used by the processor 354 may include, but are not limited to, windowing, a real or complex DFT or FFT, digital filtering, Hilbert transform, spectral peak detection, CFAR threshold detection, spectral peak frequency measurement, spectral peak phase measurement, signal phase measurement, signal frequency measurement, signal envelope amplitude measurement, Doppler processing, or velocity derivation through successive time target measured positions. Target velocity derived from Doppler processing can also be used as a target discrimination means to aid in target separation and processing, especially in the situation where multiple target returns are from the same range, or within the same range bin of the radar. The processor means 354 may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

A further embodiment of the signal processor 380 is shown in FIG. 4G. In this arrangement, analog to digital converter means 38a, 38b digitize n analog IF channels, where n is an integer greater than or equal to 2. The digitized IF signals are then input to processor means 355. Processor means 355 may comprise a single or plurality of individual processors. Processor means 355 performs target detection through target detection means 355a, target range determination through target range calculation means 355b, and target angle determination through target angle calculation means 355c. The processing techniques used by processor 355 may include, but are not limited to, windowing, a real or complex DFT or FFT, digital filtering, Hilbert transform, spectral peak detection, CFAR threshold detection, spectral peak frequency measurement, spectral peak phase measurement, signal phase measurement, signal frequency measurement, signal envelope amplitude measurement, least squares algorithms, non-linear least squares algorithms, digital beam-forming, or super-resolution algorithms such as multiple signal classification (MUSIC). The target angle determination methods utilized by the target angle calculation means 355c may include, but are not limited to, phase-comparison monopulse direction-finding method, amplitude-comparison monopulse direction-finding method, multilateration direction-finding method, multiple-baseline interferometry direction-finding method, amplitude comparison, or a combination of any of these methods. The processor means 355 may include, but is not limited to, a digital signal processor (DSP), microprocessor, microcontroller, electrical control unit, or other suitable processor block.

A yet further embodiment of the signal processor 380 is shown in FIG. 4H. In this arrangement, analog-to-digital (A/D) converter means 53a, 53b digitize n analog IF channels, where n is an integer greater than or equal to 2. The digitized IF signals are then input to processor means 356. Processor means 356 may comprise a single or plurality of individual processors. Processor means 356 performs target detection through target detection means 356a, target range determination through target range calculation means 356b, target angle determination through target angle calculation means 356c and target velocity determination through target velocity calculation means 356d. The processing techniques used by processor 356 may include, but are not limited to, a real or complex DFT or FFT, windowing, digital filtering, Hilbert transform, spectral peak detection, CFAR threshold detection, spectral peak frequency measurement, spectral peak phase measurement, signal phase measurement, signal frequency measurement, signal envelope amplitude measurement, least squares algorithms, non-linear least squares algorithms, digital beam-forming, super-resolution algorithms such as multiple signal classification (MUSIC), Doppler processing, or velocity derivation through successive time target measured positions. Target velocity derived from Doppler processing can also be used as a target discrimination means to aid in target separation and processing, especially in the situation where multiple target returns are from the same range or within the same range bin of the radar. The target angle determination methods utilized by the target angle calculation means 356c may include, but are not limited to, phase-comparison monopulse direction-finding method, amplitude-comparison monopulse direction-finding method, multilateration direction-finding method, multiple-baseline interferometry direction-finding method, amplitude comparison, or a combination of any of these methods. The processor means 356 may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

FIG. 6 illustrates the phase-monopulse direction-finding technique as one embodiment of the angle calculation means within signal processor 380. An electromagnetic signal is reflected from a target 22 with a wavelength λ, and the signal is received by two antenna means 29a and 29b. It is assumed that the reflected electromagnetic wavefronts are generally planar. The antenna elements 29a, 29b are separated by a distance D, and the target direction angle from boresight is θ. The received electromagnetic signal must travel a longer distance to reach antenna means 29b than to reach antenna means 29a for a positive value of θ. This difference in travel distance causes a measured phase difference ΔΨ=Ψ₂−Ψ₁ between antenna means 29a and 29b. The phase can be measured and compared between the two receiver channels at the RF frequency, or more conveniently can be measured and compared after down-conversion at the IF frequency, since phase is preserved after down-conversion. A simple down-conversion circuit is illustrated in which a local oscillator 51 feeds mixers 34a, 34b which mix down the received RF signals. Filters 31a, 31b then pass the down-converted IF signals. The phase difference between the IF signals ΔΨ′=Ψ₂′−Ψ₁′ is equivalent to the phase difference ΔΨ. The equation relating the calculated target angle θ to the measured phase difference ΔΨ, wavelength λ, and antenna separation distance D is:

$$θ = arcsin [ \frac{Δ Ψ \cdot λ}{2 π \cdot D} ] \qquad ( 4 )$$

where λ is the average received wavelength of the modulated radar signal during a coherent measurement interval. The phase-monopulse equation (4) is only valid for antenna separation distances D that are short enough not to allow any target return received within the sensor angular field of view to cause the absolute value of quantity |ΔΨ| to be greater than or equal to 180 degrees.

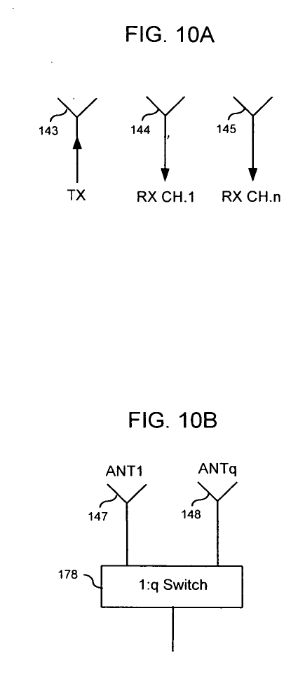

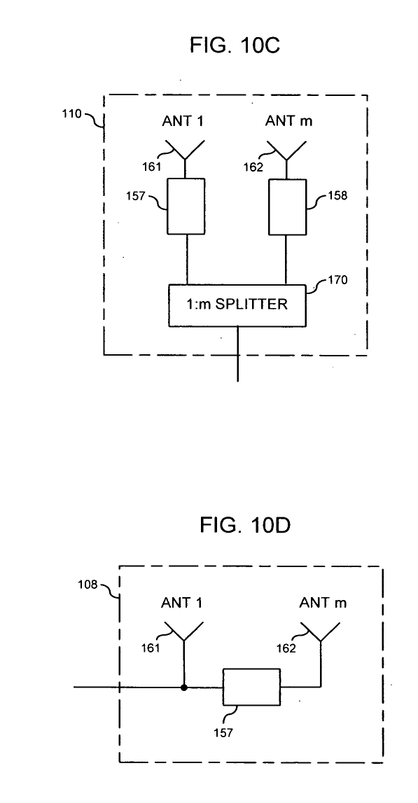

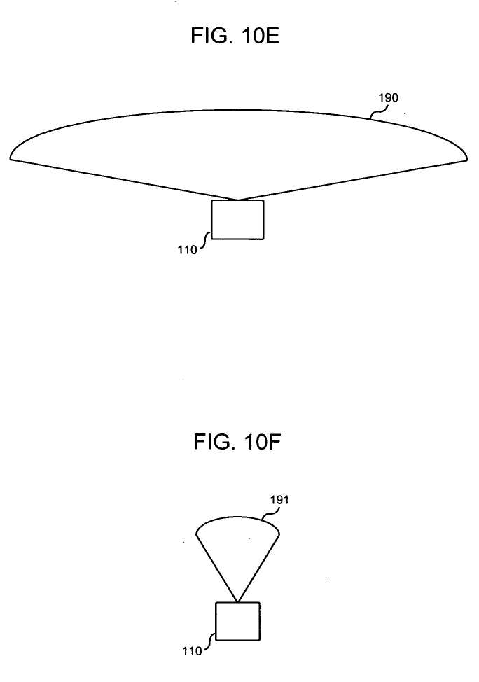

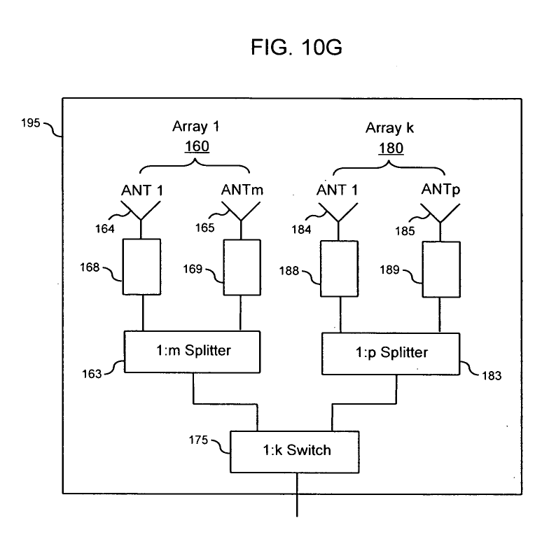

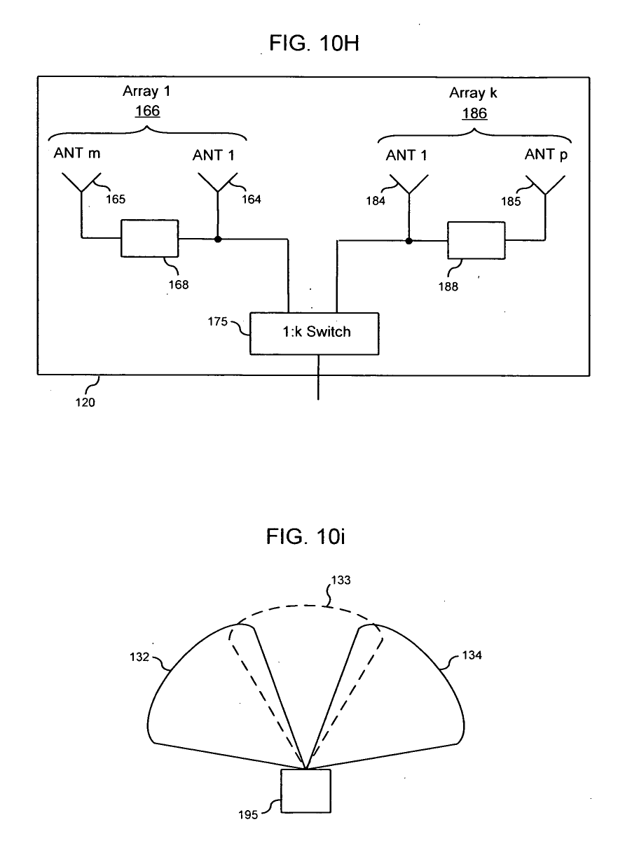

For the case where a phase-monopulse antenna separation distance D is large enough such that a target return received within the sensor field of view causes the absolute value of quantity |ΔΨ| to be greater than or equal to 180 degrees, the calculated target direction angle θ will have ambiguous results. This ambiguity can be resolved by combining the phase-monopulse direction-finding method with an additional direction-finding method such as amplitude-comparison monopulse, multilateration using range data or difference-of-time-of-arrival (DTOA) data, or by combining with the additional switched-beam detection zone method as illustrated in FIGS. 10G-i. The additional direction-finding method in this combination will allow a coarse estimate of the target direction angle such that a higher precision target direction angle θ can be chosen from the ambiguous calculated set as the value closest to the value of the coarse estimate, while the longer phase-monopulse separation distance D will provide higher target angle estimate accuracy than for an unambiguous separation distance.

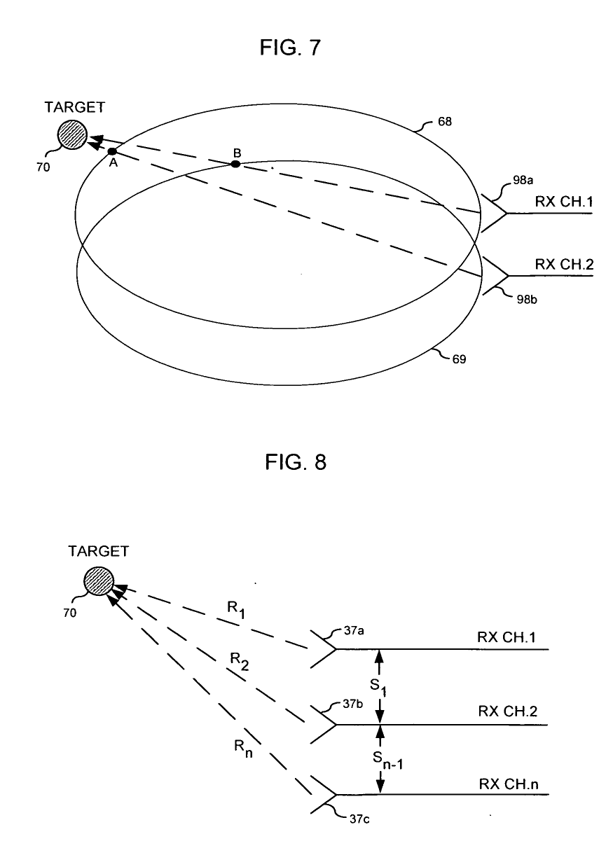

FIG. 7 shows the amplitude-comparison monopulse direction-finding technique as another embodiment of the angle calculation means within signal processor 380. Two antenna means 98a, 98b are spatially separated such that their corresponding antenna gain patterns 68, 69 are offset from each other. When a target 70 is detected, the amplitudes of the signals detected in receiver channels 1 and 2 will be different, since the antenna gain patterns will be different corresponding to where the target is located, shown by antenna gain intercept points A and B. The resulting IF signal amplitudes are measured, and compared to determine the target direction angle. One way to determine the target angle is to use a 180-degree hybrid coupler to create sum and difference signals from the signals received in the two channels. The target angle is calculated by taking the ratio of the difference/sum. Another way to determine the target angle is to pass the signals from receiver channels 1 and 2 through logarithmic amplifiers then subtract one from the other. This output can be used to determine the target angle. A third method compares the amplitudes of received signals across a plurality of receiver channels to determine the target angle.

FIG. 8 illustrates the multilateration direction-finding technique as another embodiment of the angle calculation means within signal processor 380. A plurality of antenna means 37a, 37b, 37c are spatially separated by a distances S₁, Sₙ₋₁. The target ranges R₁, R₂, Rₙ to the target 70 are independently determined at each receiver antenna means locations. The differences in target ranges determined at each spatially separated receiver antenna means 37a, 37b, 37c locations are used to calculate the target direction angle θ. This can be accomplished using, but not limited to, a least squares method, a non-linear least squares method, or a super-resolution algorithm such as multiple signal classification (MUSIC). A variety of other methods or algorithms known to those skilled in the art can be used to determine a target direction angle using the technique described in the abovementioned arrangement without changing the basic form or spirit of the invention. While FIG. 8 illustrates this technique for a 3-receive antenna means arrangement, this method is applicable to an arrangement containing n receive antenna means, where n is an integer greater than or equal to 2. Furthermore, the multilateration technique can use difference-of-time-of-arrival (DTOA) measurements of signals across a plurality of receiver channels in pulsed radar arrangements instead of target range measurements to calculate a target's direction, since the time-of-arrival of signals in pulsed radar arrangements is used to determine target range.

A yet further embodiment of the angle calculation means within signal processor 380 is the multiple-baseline interferometric direction-finding technique aforementioned, and illustrated in FIGS. 5A-C. To use this method, the number n of IF channels must be an integer greater than or equal to 3.

The aforementioned angle direction-finding techniques may be used individually or in combination within a single sensor, or within signal processors 380 or 300, in order to improve performance. The performance improvements may include, but are not limited to, an increase in range or angle calculation accuracy, an improvement in multiple target determination or discrimination, a reduction of false alarm rate, or a reduction of processing load.

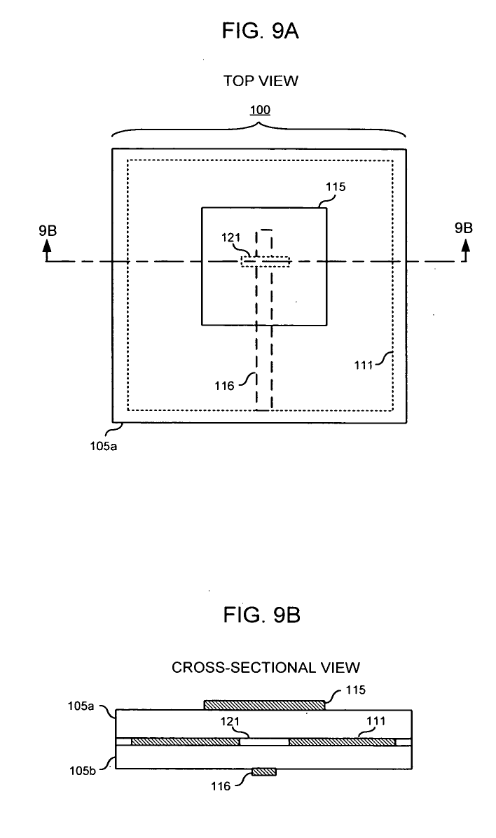

One embodiment of the present invention is the antenna means arrangement 100 shown in FIGS. 9A-B. This antenna means arrangement 100 can be used as an embodiment of one, all, or any combination of antenna means II, 19, 20, and 24. The antenna means arrangement 100 is composed of a microstrip transmission line 116, RF ground plane 111, aperture cutout 121 in RF ground plane 111, dielectric layer 105a, dielectric layer 105b, and metal patch element 115. The RF input signal is input to the microstrip line 116 where it couples through the aperture cutout 121 in the RF ground plane 111 to the metal patch element 115 from which it is radiated. This configuration of antenna means can achieve a wide useable fractional bandwidth, typically on the order of 10-20%, which supports the wideband and ultra-wideband radar sensor requirements for automotive applications.

FIG. 10A illustrates one embodiment of antenna means 11, 19, and 20. In this arrangement, antenna means 11, 19, and 20 can be composed of single antenna elements 143, 144, and 145 respectively. These antenna elements may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

Another embodiment of the present invention is the antenna means arrangement shown in FIG. 10B. This antenna means arrangement can be used as an embodiment of one, all, or any combination of antenna means 11, 19, 20, and 24. The antenna means arrangement is composed of a switching element 178 that connects to q antenna elements 147, 148, where q is an integer greater than or equal to 2. Antenna elements 147, 148 may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

A further embodiment of the present invention is the antenna means arrangement 110 shown in FIG. 10C. This antenna means arrangement 110 can be used as an embodiment of one, all, or any combination of antenna means 11, 19, 20, and 24. The antenna means arrangement 110 is composed of a splitter or combiner element 170 that connects to m phase shift elements 157, 158, which then connect to m antenna elements 161, 162, where m is an integer greater than or equal to 2. One implementation of the phase shift elements 157, 158 is the use of transmission line delays. The use of phase shift elements 157, 158 allows the overall beam width and beam shape of the arrangement 110 to be controlled. Antenna elements 161, 162 may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

A yet further embodiment of the present invention is the antenna means arrangement 108 shown in FIG. 10D. This antenna means arrangement 108 can be used as an embodiment of one, all, or any combination of antenna means 11, 19, 20, and 24. An RF input feeds antenna element 161 and also inputs to the phase shift element 157 which then connects to the next antenna element 162. For an arrangement of m antenna elements, there will be m−1 phase shift elements in this series feed configuration, where m is an integer greater than or equal to 2. One implementation of the phase shift element 157 is the use of a transmission line delay. The use of phase shift elements in this series feed configuration allows the overall beam width and beam shape of the arrangement 108 to be controlled. Antenna elements 161, 162 may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

In FIG. 10E, antenna arrangement 110 is used to create a wide beam pattern 190. The wide beam pattern shown is approximate, with side lobes omitted, and is used to illustrate that through the proper selection of the phase shift of phase shift elements 157, 158, a wide beam pattern is attainable. The term “wide” with respect to the beam pattern refers to a main-lobe with a −3 dB beam width greater than or equal to 90 degrees, 100 degrees, 110 degrees, 120 degrees, 130 degrees, 140 degrees, 150 degrees, 160 degrees, or 170 degrees. The more antenna elements and phase shift elements used in the arrangement 110, the more ideal the beam pattern shape can be made. Similarly, the antenna arrangement 110 can be substituted with antenna arrangement 108 to attain similar results. The generation of a wide beam pattern for near-distance sensing can be desirable to reduce sensor count for cost reduction.

In FIG. 10F, antenna arrangement 110 is used to create a narrow beam pattern 191. The narrow beam pattern shown is approximate, with side lobes omitted, and is used to illustrate that through the proper selection of the phase shift of phase shift element 157, a narrow beam pattern is attainable. The term “narrow” with respect to the beam pattern refers to a main-lobe with a −3 dB beam width less than or equal to 90 degrees, 80 degrees, 70 degrees, 60 degrees, 50 degrees, 40 degrees, 30 degrees, 20 degrees, or 10 degrees. The more antenna elements and phase shift elements used in the arrangement 110, the more ideal the beam pattern shape can be made. Similarly, the antenna arrangement 110 can be substituted with antenna arrangement 108 to attain similar results.

Another embodiment of the present invention is the antenna means arrangement 195 shown in FIG. 10G. This antenna means arrangement 195 can be used as an embodiment of one, all, or any combination of antenna means 11, 19, 20, and 24. The antenna means arrangement 195 is composed of a switch 175 which switches between k antenna array configurations 160, 180, where k is an integer greater then or equal to 2. Array configuration 160 is composed of a splitter 163 which connects to m phase shift elements 168, 169 which then connect to m antenna elements 164, 165, where m is an integer greater than or equal to 2. Array configuration 180 is composed of a splitter 183 which connects to p phase shift elements 188, 189 which then connect to p antenna elements 184, 185, where p is an integer greater than or equal to 2. Integers k, m, and p do not need to be equal. One implementation of the phase shift elements 168, 169, 188, 189 is the use of transmission line delays. The use of phase shift elements 168, 169, 188, 189 allows the overall beam width, beam shape, and beam direction of each array 160, 180 to be controlled. For example, the arrays 160, 180 could use fixed transmission delay elements for the phase shift elements, and each array could have a fixed beam pattern pointing in a different direction. By switching between the different fixed beam patterns, a scanning beam array can be realized. Furthermore, using this method, fixed beam detection zones can be established and selectively enabled, disabled, or switched between. Antenna elements 164, 165, 184, 185 may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

A further embodiment of the present invention is the antenna means arrangement 120 shown in FIG. 10H. This antenna means arrangement 120 can be used as an embodiment of one, all, or any combination of antenna means 11, 19, 20, and 24. The antenna means arrangement 120 is composed of a switch 175 which switches between k antenna array configurations 166, 186, where k is an integer greater then or equal to 2. Array configuration 166 is composed of m antenna elements 164, 165 with m−1 phase shift elements 168 connected in a series feed configuration, where m is an integer greater than or equal to 2. Array configuration 186 is composed of p antenna elements 184, 185 with p−1 phase shift elements 188 connected in a series feed configuration, where p is an integer greater than or equal to 2. Integers k, m, and p do not need to be equal. One implementation of the phase shift elements 168, 188 is the use of transmission line delays. The use of phase shift elements 168, 188 allows the overall beam width, beam shape, and beam direction of each array 166, 186 to be controlled. For example, the arrays 166, 186 could use fixed transmission delay elements for the phase shift elements, and each array could have a fixed beam pattern pointing in a different direction. By switching between the different fixed beam patterns, a scanning beam array can be realized. Furthermore, using this method, fixed beam detection zones can be established and selectively enabled, disabled, or switched between. Antenna elements 164, 165, 184, 185 may include, but are not limited to, the antenna arrangement 100, a microstrip patch antenna or array, an aperture-coupled patch antenna or array, a stacked patch antenna or array, a quasi-yagi antenna or array, a slot antenna or array, a spiral antenna or array, a reflector antenna or array, a twist-reflector antenna or array, or a discrete antenna element or array.

In FIG. 10i, antenna arrangement 195 with k=3 is used to create a switched beam pattern consisting of individual beam patterns 132, 133, 134. This arrangement is used for illustration purposes and is not meant as a restriction. The beam patterns shown are approximate, with side lobes omitted, and are used to illustrate the beam switching concept. The beams shown can be scanned in order to cover the entire detection zone, or individually selectively enabled or disabled to switch between individual detection zones. The more antenna elements and phase shift elements used in the arrays 160, 180, the more the beam pattern shape can be tailored. Similarly, the antenna arrangement 195 can be substituted with antenna arrangement 120 to attain similar results.

One antenna arrangement methodology for automotive short-range sensor applications is the use of a wide beam pattern for the transmit antenna means and the use of a switched, narrower beam pattern for the receive antenna means. In this configuration, either of the arrangements shown in FIG. 10C or FIG. 10D can be used for transmit antenna means 11, while either of the arrangements shown in FIG. 10G or FIG. 10H can be used for receive antenna means 19, 20, 24. Advantages of this configuration are an increased receiver antenna gain which improves receiver signal to noise ratio, as well as an establishment of receiver zones which can aid in the discrimination of multiple radar returns that are at the same range, or within the same range bin of the radar, but at different angles within the overall field of view. For automotive short-range applications, the transmit power is typically legislated to very low values, as in the case of the FCC UWB automotive radar legislation in the 22-29 GHz band, and is thus easily generated by the transmitter even with a wide beam having low antenna gain.

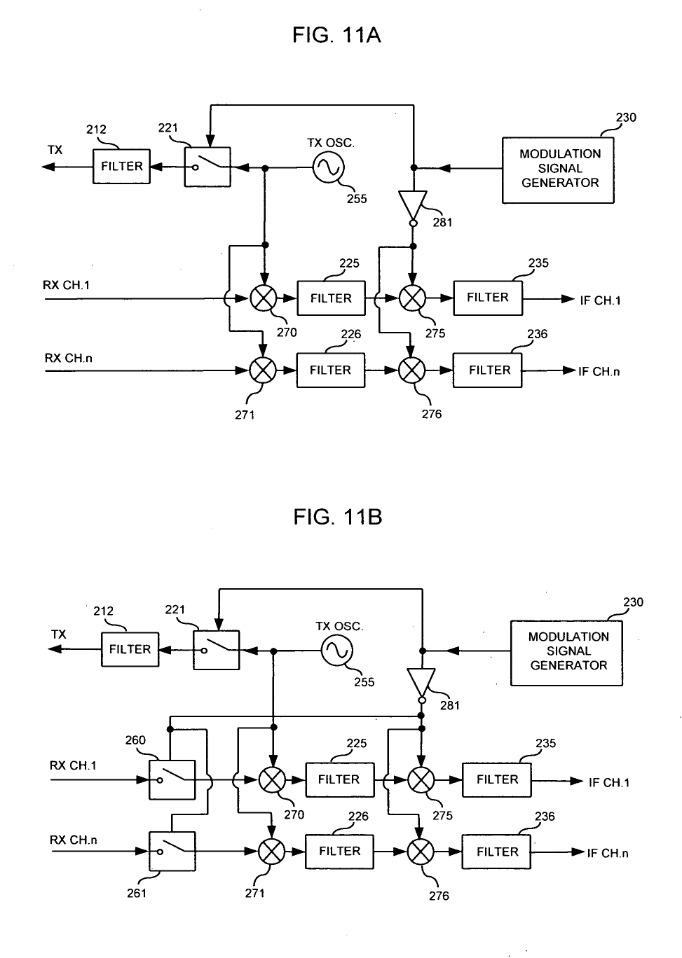

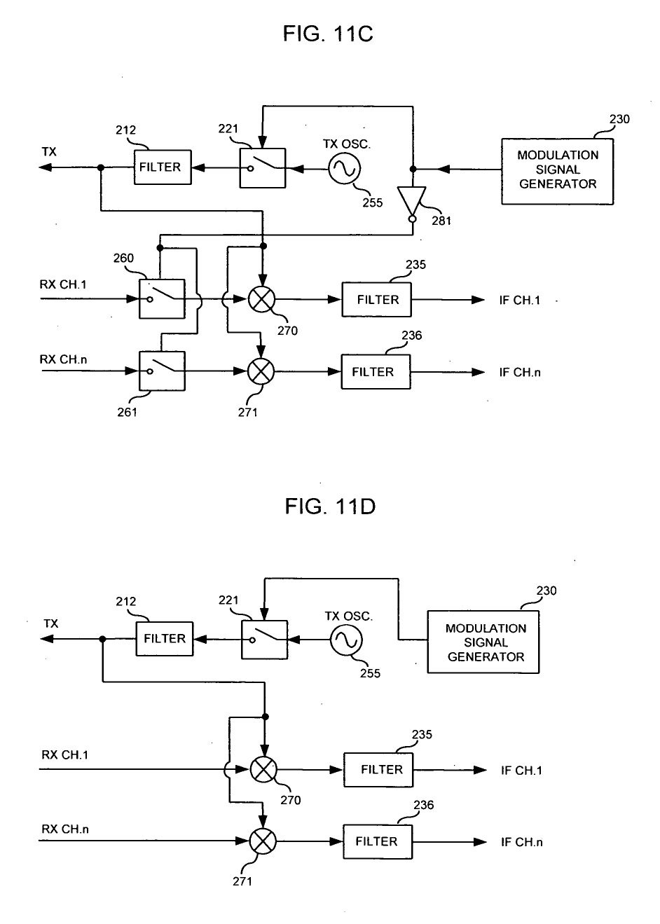

FIG. 11A presents a pulsed radar WB/UWB/PUWB transmitter-receiver arrangement as one embodiment of the present invention. This arrangement can be used as an embodiment of WB/UWB/PUWB radar transmitter-receiver 200. In this arrangement, modulation signal generator 230 outputs a modulation signal which is connected to the control input of the modulator 221. In one arrangement of modulation signal generator 230, the modulation signal is a pulse train where the pulse repetition interval (PRI) is continuously linearly increased or decreased over a predetermined time interval. The modulator 221 can be implemented by, but is not limited to, a pulse modulator, amplitude modulator, bi-phase shift keyed modulator, phase modulator, switch, mixer, or AND gate. The output of transmit oscillator 255 is connected to the modulator 221 where it is modulated by the modulation signal from 230. An output filter 212 selects one of the modulation sidebands, either the upper or lower sideband, to pass for transmission. The output signal from filter 212 then proceeds to an antenna means for transmission of the signal towards a target. The reflected signal from a target will be received by antenna means and distributed to n receiver channels, RX CH.1, RX CH.n, where n is an integer greater than or equal to 2. The n receiver channels are connected to down-converting mixers 270, 271 where the signals are mixed with the output of transmit oscillator 255, and the resulting signals are filtered by filters 225, 226. After filtering by 225, 226, the signals are then connected to mixers 275, 276 where they are mixed with the inverted output of modulation signal generator 230, and the resulting signals are filtered by filters 235, 236. The inverter 281 can be removed so that the output of modulation signal generator 230 is connected directly to the mixers 275, 276 without departing from the spirit of the present invention. Furthermore, signal feeding mixers 275, 276 can be additionally filtered prior to being connected to mixers 275, 276 without departing from the spirit of the present invention. Mixers 270, 271, 275, 276 can be implemented by, but are not limited to, mixers, multipliers, or switches without changing the basic functionality of the arrangement. Filter 212 can be implemented by, but is not limited to, a band-pass filter. Filters 225, 226 can be implemented by, but are not limited to, band-pass filters. Filters 235, 236 can be implemented by, but are not limited to, low-pass filters. After filtering by 235, 236 the resulting signals are intermediate frequency (IF) signals containing target information. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

The pulsed radar WB/UWB/PUWB transmitter-receiver arrangement described in FIG. 11B is presented as another embodiment of the present invention. This arrangement can be used as an embodiment of WB/UWB/PUWB radar transmitter-receiver 200. The arrangement in FIG. 11B is similar to the arrangement in FIG. 11A except for the addition of modulators 260, 261. The same components are denoted by the same reference numerals, and will not be explained again. The modulators 260, 261 modulate the received signals prior to the down-converter mixers 270, 271. The signal feeding mixers 275, 276 can be additionally re-inverted or filtered prior to being connected to mixers 275, 276 without departing from the spirit of the present invention. Modulators 260, 261 can be implemented by, but are not limited to, switches which gate the receiver channels, effectively blanking the receiver when the transmit signal pulse is on, and passing energy to the receiver when the transmit signal pulse is off. This can help to reduce transmit signal leakage to the receiver and increase the dynamic range of the receiver.

The pulsed radar WB/UWB/PUWB transmitter-receiver arrangement described in FIG. 11C is presented as a further embodiment of the present invention. This arrangement can be used as an embodiment of WB/UWB/PUWB radar transmitter-receiver 200. The arrangement in FIG. 11C is similar to the arrangement in FIG. 11B, except for removal of filters 225, 226 and mixers 275, 276, and that the signal feeding mixers 270, 271 is taken from the output of filter 212. The same components are denoted by the same reference numerals, and will not be explained again. This arrangement is essentially a receiver-gated homodyne architecture, with simplified structure as compared to the arrangement in 11B.

FIG. 11D illustrates a pulsed WB/UWB/PUWB transmitter-receiver arrangement in accordance with a yet further embodiment of the present invention. This arrangement can be used as an embodiment of WB/UWB/PUWB radar transmitter-receiver 200. The arrangement in FIG. 11D is similar to the arrangement in FIG. 11C except for removal of modulators 260, 261. The same components are denoted by the same reference numerals, and will not be explained again. This arrangement is a simpler structure compared to that of FIG. 11C. The removal of receiver gating makes the arrangement more compact and potentially lower cost.

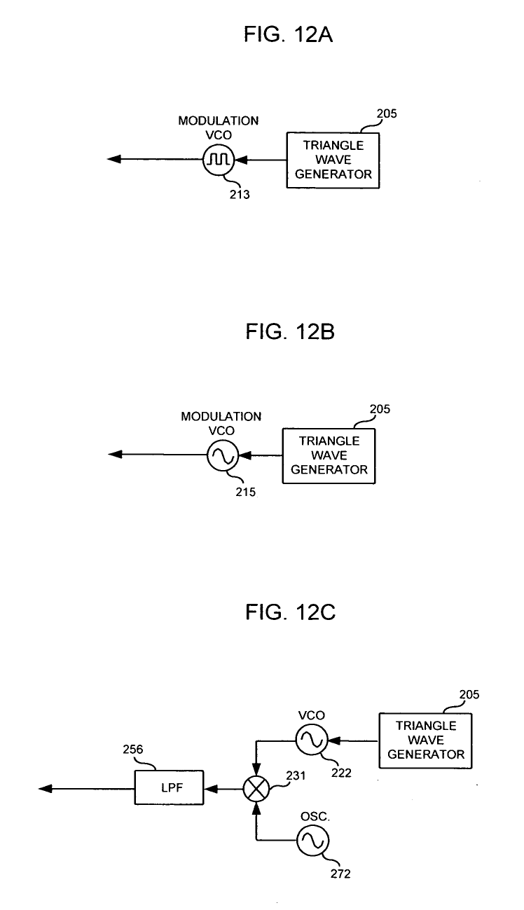

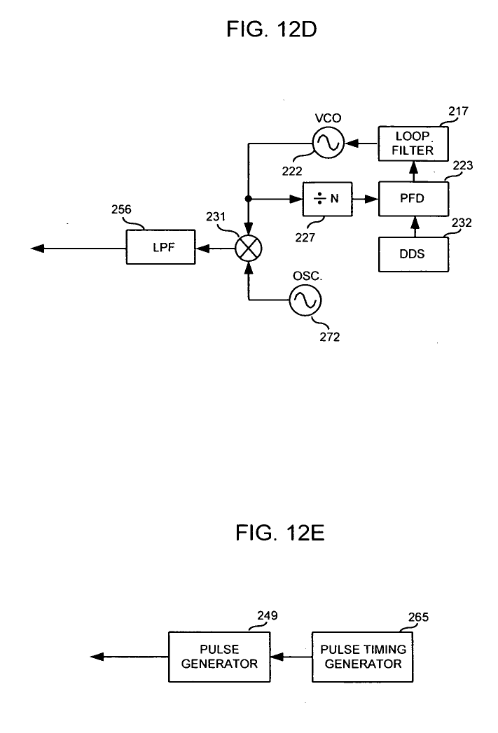

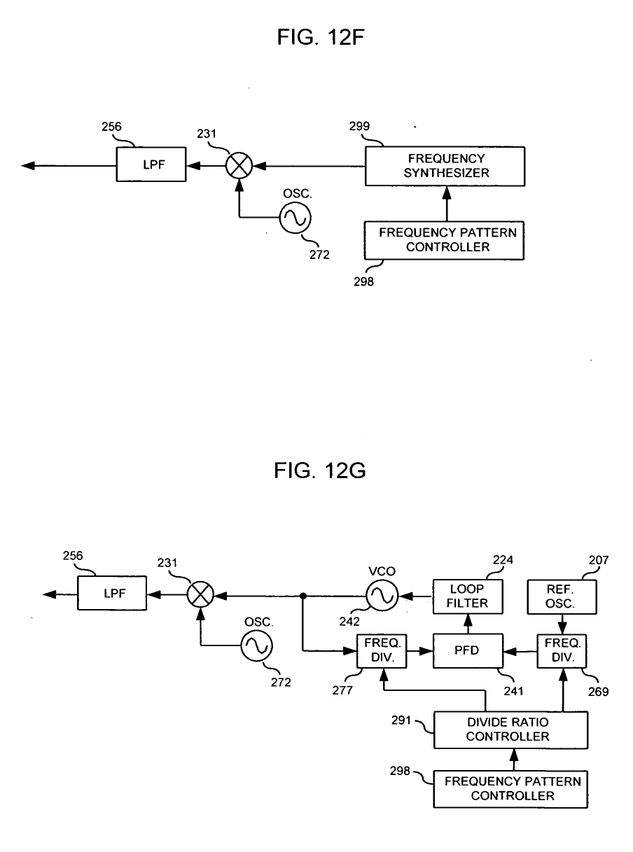

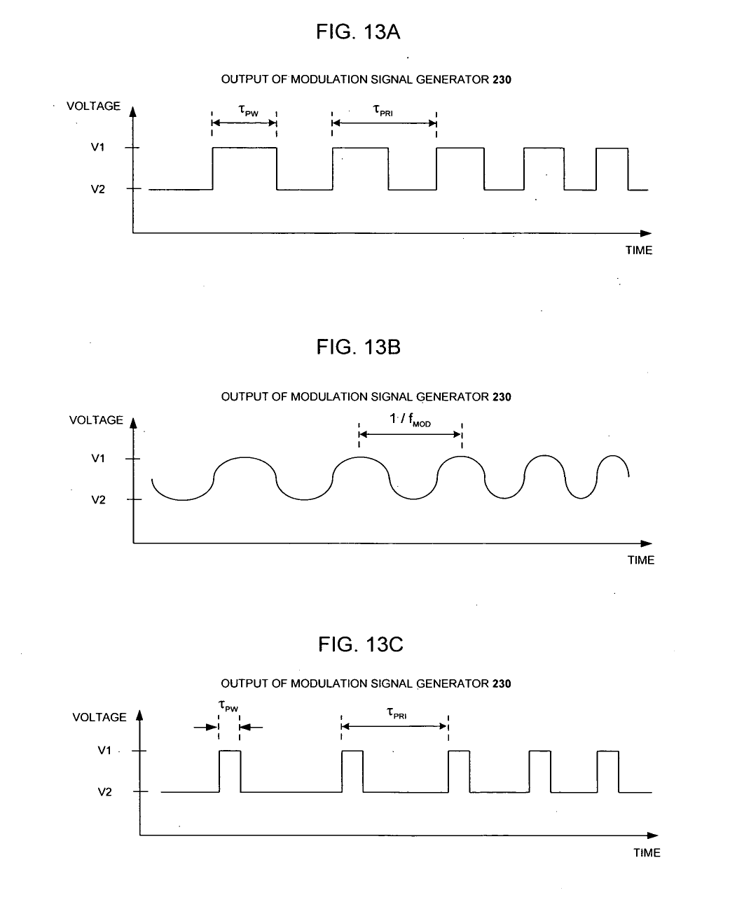

One embodiment of modulation signal generator 230 is shown in FIG. 12A. A triangle wave generator 205 outputs a triangle wave signal with linear or monotonic up, down, or up-and-down slope regions. The output of triangle wave generator 205 modulates the frequency of square wave modulation VCO 213. The output signal of square wave VCO 213 is a pulse train with a constant duty cycle and a pulse repetition interval (PRI) that is linearly or monotonically changed with respect to time, from one PRI value to another PRI value over a pre-determined time interval. The output waveform of this embodiment of modulation signal generator 230 is shown in FIG. 13A. As can be seen, the output signal is a pulse train with the pulse repetition interval τ_{PRI} changed with respect to time. The pulse width τ_{PW} does not remain constant during the PRI modulation, but the duty cycle of the pulse train remains constant.

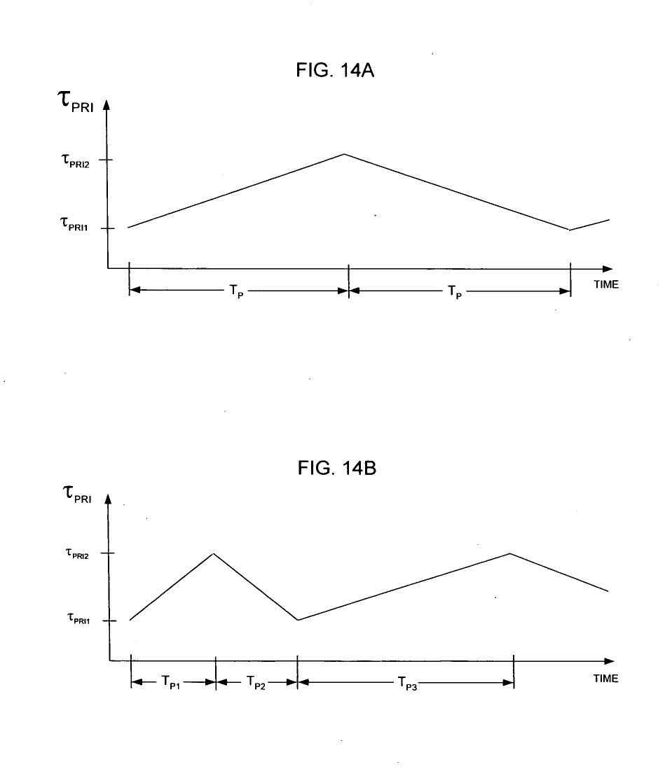

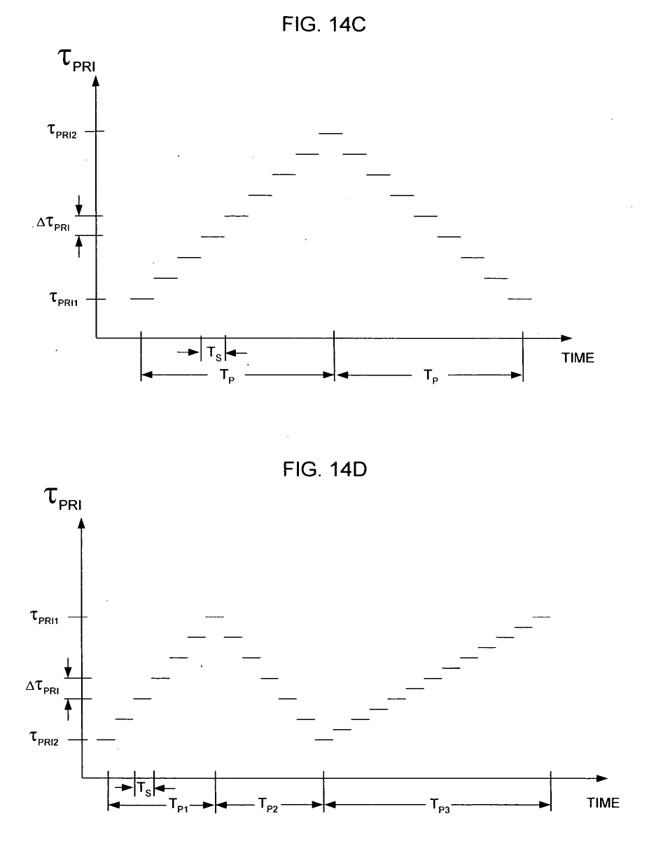

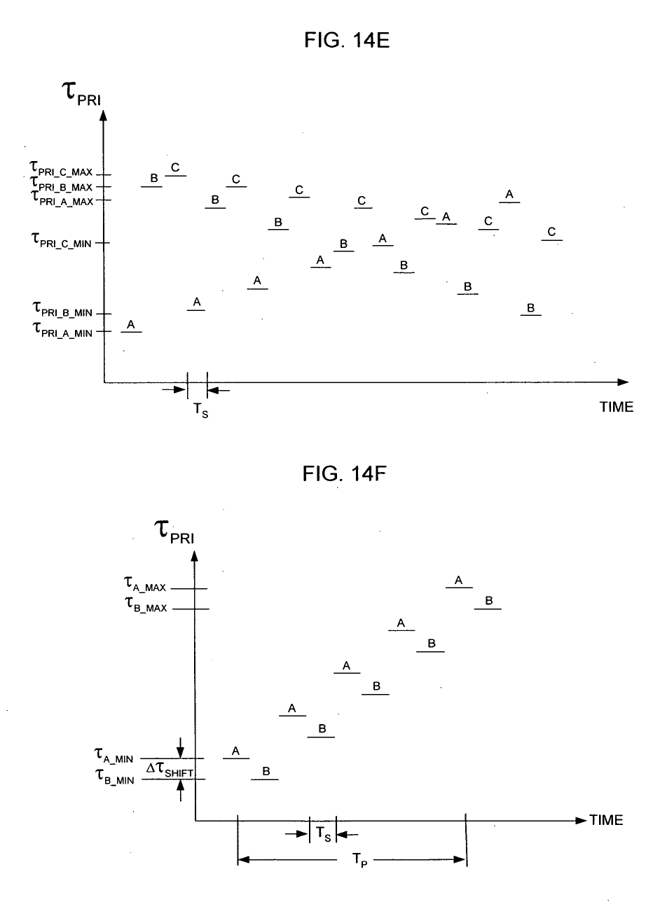

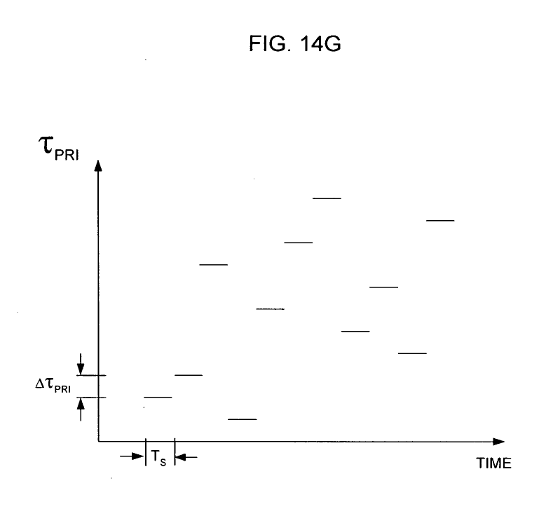

Another embodiment of modulation signal generator 230 is shown in FIG. 12B. A triangle wave generator 205 outputs a triangle wave signal with linear or monotonic up, down, or up-and-down slope regions. The output of triangle wave generator 205 modulates the frequency of sine wave modulation VCO 215 creating a linear or monotonic up, down, or up-and-down frequency modulated signal, whose frequency is linearly or monotonically changed with respect to time. The output waveform of this embodiment of modulation signal generator 230 is shown in FIG. 13B. As can be seen, the output signal is a sine wave with its frequency f_{MOD} changed with respect to time. In another embodiment of the present invention, let f_{MOD}=1/τ_{PRI} for use with the PRI modulation waveforms as described in FIGS. 14A-G.

A further embodiment of modulation signal generator 230 is shown in FIG. 12C. A triangle wave generator 205 outputs a triangle wave signal with linear or monotonic up, down, or up-and-down slope regions. The output of triangle wave generator modulates the frequency of sine wave modulation VCO 222 creating a linear or monotonic up, down, or up-and-down chirp signal, whose frequency is linearly or monotonically changed with respect to time. The output signal of VCO 222 is mixed with the output signal of oscillator 272 by mixer 231. The down-converted signal output of mixer 231 is filtered by low-pass filter 256 and output. The advantage of this arrangement is that using a higher frequency VCO for modulation can achieve a wider absolute modulation bandwidth as a smaller fractional bandwidth of the VCO center frequency, which can be easier to realize in a practical VCO. After down-conversion, the absolute modulation bandwidth is preserved in the output signal.

A yet further embodiment of modulation signal generator 230 is shown in FIG. 12D. In this arrangement, a direct digital synthesizer (DDS) 232 is used as a reference signal to create the up/down linear or monotonic frequency modulation signal. This signal is then up-converted to a higher frequency range through the use of VCO 222, phase-frequency detector (PFD) 223, loop filter 217, and frequency divider 227. The output of VCO 222 will be a frequency-multiplied version of the output of the direct digital synthesizer 232. The remaining components have the same function and reference numerals as in FIG. 12C, and will not be described again.

FIG. 12E illustrates an alternate embodiment of modulation signal generator 230. In this arrangement, a pulse timing generator 265 is output to a pulse generator 249. The pulse generator 249 creates fixed pulse width pulses, with the pulse to pulse timing controlled by the pulse timing generator 265. The output waveform of this embodiment of modulation signal generator 230 is shown in FIG. 13C. As can be seen, the output signal is a pulse train with the pulse repetition interval τ_{PRI} changed linearly or monotonically with respect to time. The pulse width τ_{PW} remains constant during the PRI modulation.

Another embodiment of modulation signal generator 230 is shown in FIG. 12F. In this arrangement, a frequency pattern controller 298 controls a frequency synthesizer 299. The output of frequency synthesizer 299 will be a signal whose frequency hops or steps according to the pattern and timing dictated by the frequency pattern controller 298. The output of frequency synthesizer 299 is input to mixer 231 where it is mixed with an oscillator 272. The output of mixer 231 is filtered by low pass filter 256. The result is a modulation signal output that can be used to create PRI stepped or hopped waveforms, such as those illustrated by FIGS. 14C-G.

A further embodiment of modulation signal generator 230 is shown in FIG. 12G. In this arrangement, a frequency pattern controller 298 is input to a divide ratio controller 291 which controls the divide ratios of frequency dividers 277, 269. The frequency dividers 277, 269 can be implemented by counters without departing from the scope or spirit of the present invention. A reference oscillator 207 provides a reference signal of a predetermined frequency to the input of frequency divider 269. The output of VCO 242 is split and one of the split signals is input to frequency divider 277. The output of frequency divider 277 and the output of frequency divider 269 are both input to phase-frequency detector 241. The output of phase frequency detector 241 is filtered by loop filter 224 and is input to the frequency control port of VCO 242. The output of VCO 242 will be a signal whose frequency hops or steps according to the pattern and timing dictated by the frequency pattern controller 298. The output of VCO 242 is input to mixer 231 where it is mixed with an oscillator 272. The output of mixer 231 is filtered by low pass filter 256. The result is a modulation signal output that can be used to create PRI stepped or hopped waveforms, such as those illustrated by FIGS. 14C-G.

FIG. 14A illustrates one PRI modulation waveform for use in the modulation signal generator 230 according to aspects of the present invention. This waveform shows a linear up slope PRI modulation during a first time period T_{P}, and a linear down slope PRI modulation during a second time period T_{P}. This waveform shown is an example of PRI modulation, and is not meant as a restriction. The PRI modulation can also consist of, but is not limited to, a repeating pattern of linear up slope modulation, a repeating pattern of linear down slope modulation, an alternating pattern of up and down slope modulation, a monotonically increasing PRI over a time period, a monotonically decreasing PRI over a time period, an alternating pattern of monotonically increasing and decreasing PRI modulation. Furthermore, one or more blanking periods where the PRI is constant may be inserted within or between the up or down slope periods.

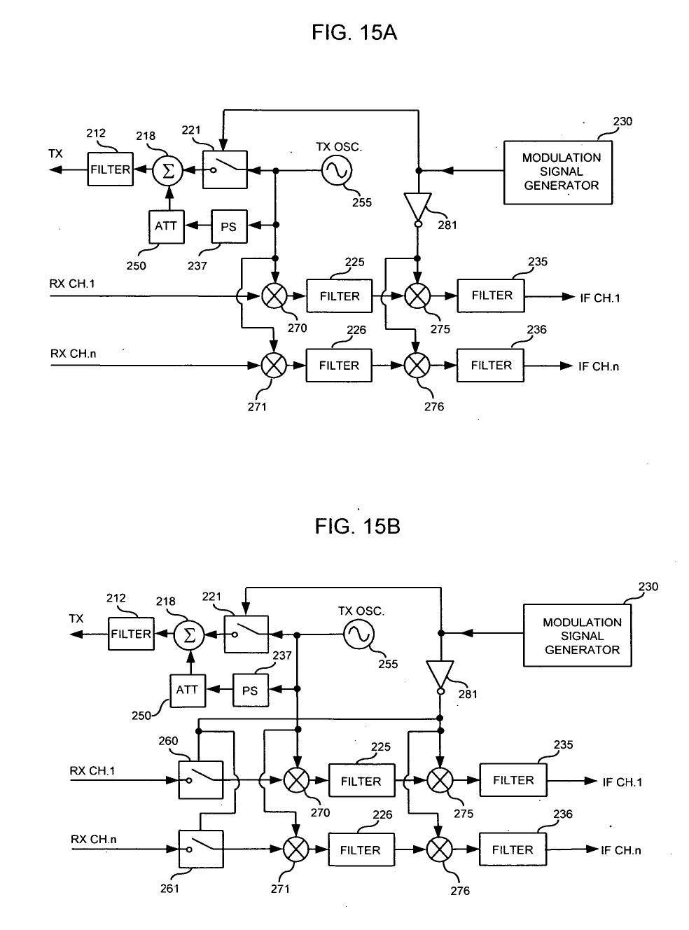

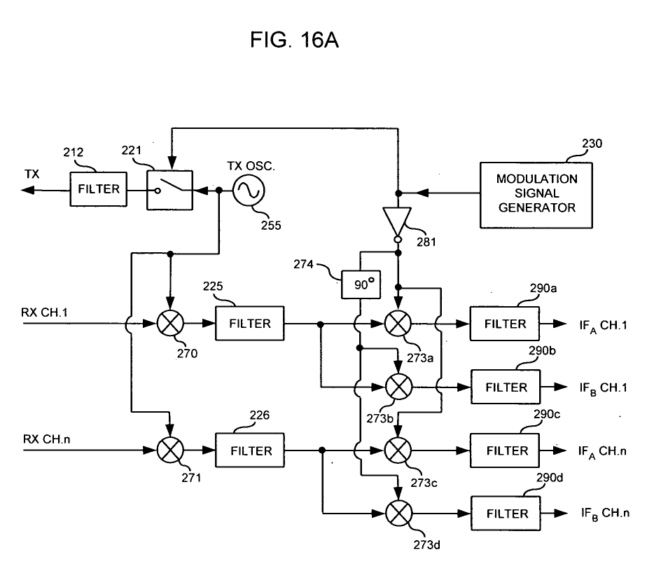

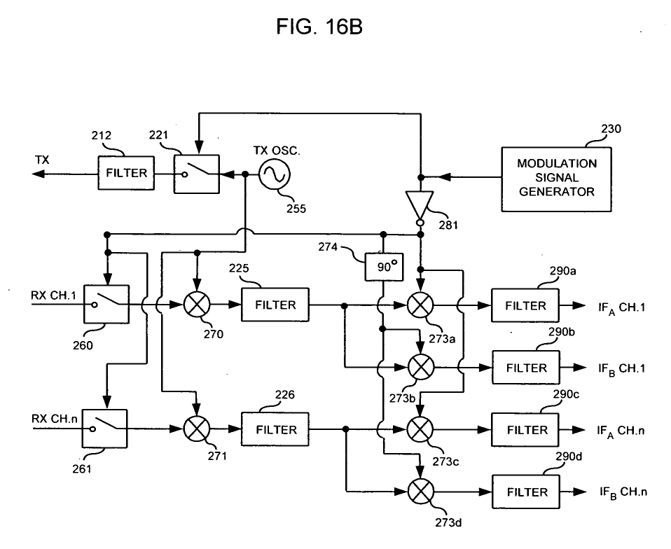

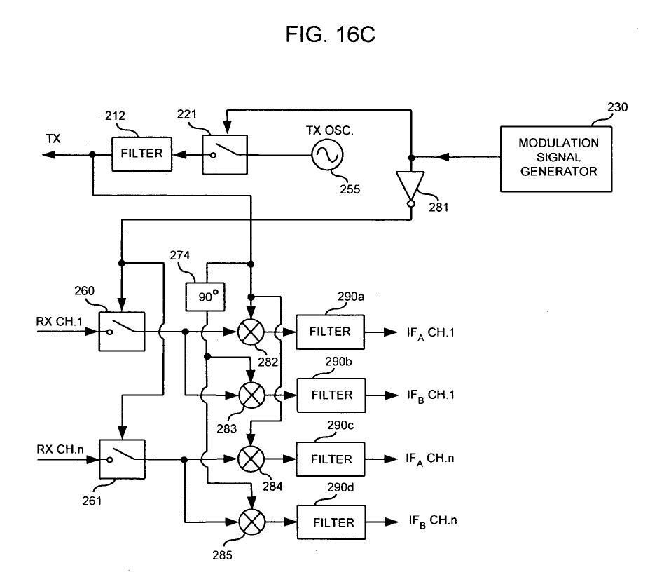

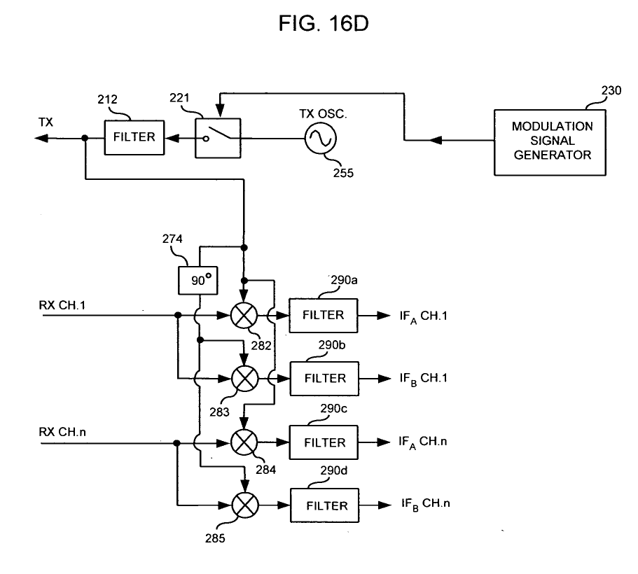

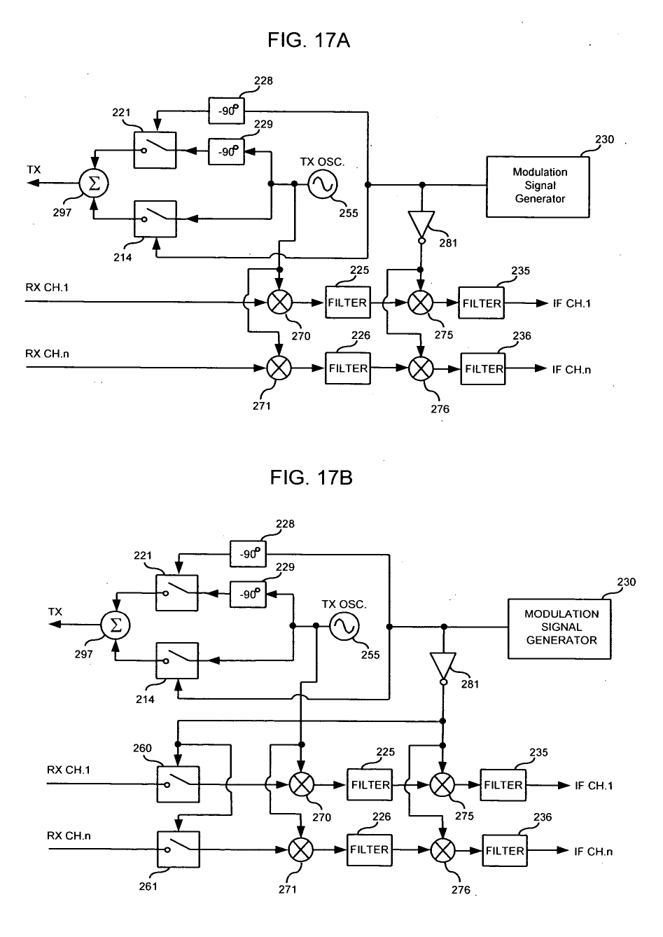

Using the PRI timing modulation waveform described in FIG. 14A, target information may be calculated from the IF signals shown in FIGS. 11A-D, FIGS. 15A-B, FIGS. 16A-D, and FIGS. 17A-B, in the following way. Peaks in the IF signal spectrum represent target returns. The frequency of the target peaks is proportional to target range, and is used to calculate target range. As an example, not meant in any way as a limitation, let the radar arrangement of FIG. 11A transmit a single-sideband, upper-sideband radar signal and utilize a PRI modulation according to FIG. 14A. Let the IF signals be measured during each coherent measurement interval T_{P}, which also corresponds in this example to the PRI up ramp and down ramp periods. Under these conditions, target range can be calculated by the following equation:

$$R = \frac{c \cdot {T}_{P}}{4 \cdot ( 1 / {τ}_{PR11} - 1 / {τ}_{PR12} )} \cdot ( {f}_{PU} + {f}_{PD} ) \qquad ( 5 )$$

where R is the calculated target range, c is the speed of light in a vacuum, T_{P} is the period of the up ramp or down ramp of the PRI modulation, τ_{PRI1} and τ_{PRI2} are the minimum and maximum PRI values respectively during the coherent measurement interval T_{P}, and f_{PU} and f_{PD} are the beat frequencies in the IF signal corresponding to measurements during the PRI up ramp and PRI down ramp periods T_{P} respectively.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target relative velocity. As an example, not meant in any way as a limitation, let the radar arrangement of FIG. 11A transmit a single-sideband, upper-sideband radar signal and utilize a PRI modulation according to FIG. 14A. Let the IF signals be measured during each coherent measurement interval T_{P}, which also corresponds in this example to the PRI up ramp and down ramp periods. Under these conditions, target relative velocity can be calculated by the following equation:

$$V = \frac{c}{4 {f}_{C} + 2 / {τ}_{PR11} + 2 / {τ}_{PR12}} \cdot ( {f}_{PU} - {f}_{PD} ) \qquad ( 6 )$$

where V is the calculated target relative velocity defined as positive for an approaching target, c is the speed of light in a vacuum, f_{PU} and f_{PD} are the beat frequencies in the IF signal corresponding to measurements during the PRI up ramp and PRI down ramp modulation intervals T_{P} respectively, f_{C} is the frequency of the transmit oscillator 255, and τ_{PRI1} and τ_{PRI2} are the minimum and maximum PRI values during the coherent measurement interval T_{P}.

FIG. 14B illustrates a multiple slope PRI modulation waveform for use in the modulation signal generator 230 according to aspects of the present invention. This waveform shows a linear up slope PRI modulation during a time period T_{P1}, a linear down slope PRI modulation during another period of time T_{P2}, and another linear PRI modulation with a different slope during a period of time T_{P3}. This waveform shown is an example of PRI modulation, and is not meant as a restriction. The PRI modulation can also consist of, but is not limited to, a plurality of linearly increasing and decreasing PRI modulations of various slopes with each modulation occurring over a predetermined period of time, or a plurality of monotonically increasing and decreasing PRI modulations of various slopes with each modulation occurring over a predetermined period of time. Furthermore, one or more blanking periods where the PRI is constant may be inserted within or between the up or down slope periods.

Using the type of frequency-hopping pattern described in FIG. 14B, target information may be calculated from the IF signals shown in FIGS. 11A-D, FIGS. 15A-B, FIGS. 16A-D, and FIGS. 17A-B in a way similar to that described for use with the waveform of FIG. 14A. Peaks in the IF signal spectrum represent target returns. The frequency of the target peaks is proportional to target range and is used to calculate target range. The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target relative velocity. One benefit of the use of multiple slopes of PRI waveforms is that this assists in the removal of false or ghost targets in the processing, and aids in the resolution of the range-velocity ambiguity.

FIG. 14C illustrates a stepped PRI modulation waveform for use in the modulation signal generator 230 according to aspects of the present invention. This waveform shows a linearly stepped PRI pattern during a time period T_{P}. This waveform shown is an example of linearly stepped PRI modulation, and is not meant as a restriction. The waveform can also comprise, but is not limited to, a repeating pattern of linearly increasing PRI steps, a repeating pattern of linearly decreasing PRI steps, alternating periods of linearly increasing and decreasing PRI step patterns, a repeating pattern of monotonically increasing PRI steps, a repeating pattern of monotonically decreasing PRI steps, or alternating periods of monotonically increasing and decreasing PRI step patterns. Also, periods where the stepped PRI modulation pattern is stopped may be inserted into the abovementioned patterns.

Using the type of PRI modulation waveform described in FIG. 14C, target information may be calculated from the IF signals shown in FIGS. 11A-D, FIGS. 15A-B, FIGS. 16A-D, and FIGS. 17A-B, in the following way. Peaks in the IF signal spectrum represent target returns. The frequency of the target peaks is proportional to target range and is used to calculate target range. As an example, not meant in any way as a limitation, let the radar arrangement of FIG. 11A transmit a single sideband, upper sideband radar signal and utilize a linearly increasing PRI step sequence and linearly decreasing PRI step sequence as shown in FIG. 14C. Let the IF signals be measured during each coherent measurement interval T_{P}, which for this example also corresponds to the PRI increasing step sequence period and decreasing step sequence period. Under these conditions, target range can be calculated by the following equation:

$$R = \frac{c \cdot {T}_{S} \cdot Δ {τ}_{PR1}}{4} \cdot ( {f}_{PU} + {f}_{PD} ) \qquad ( 7 )$$

where R is the calculated target range, c is the speed of light in a vacuum, T_{S} is dwell time of each PRI step, Δτ_{PRI} is the difference between adjacent PRI step values in the linear step sequence, and f_{PU} and f_{PD} are the beat frequencies in the IF signal corresponding to measurements during the PRI increasing sequence and PRI decreasing sequence periods T_{P} respectively.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target velocity. As an example, not meant in any way as a limitation, let the radar arrangement of FIG. 11A transmit a single sideband, upper sideband radar signal and utilize a linearly increasing PRI step sequence and linearly decreasing PRI step sequence as shown in FIG. 14C. Let the IF signals be measured during each coherent measurement interval T_{P}, which for this example also corresponds to the PRI increasing step sequence period and decreasing step sequence period. Under these conditions, target relative velocity can be calculated by the following equation:

$$V = \frac{c}{4 {f}_{C} + 2 / {τ}_{PR11} + 2 / {τ}_{PR12}} \cdot ( {f}_{PU} - {f}_{PD} ) \qquad ( 8 )$$

where V is the calculated target relative velocity defined as positive for an approaching target, c is the speed of light in a vacuum, f_{C} is the frequency of the transmit oscillator 255, τ_{PRI1} and τ_{PRI2} are the minimum and maximum PRI values in the linear sequence during a coherent measurement period T_{P}, and f_{PU} and f_{PD} are the beat frequencies in the IF signal corresponding to the measurements during the PRI up step sequence and down step sequence periods T_{P} respectively.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 14D illustrates a stepped PRI modulation waveform for use in the modulation signal generator 230 according to aspects of the present invention. This waveform comprises multiple linearly stepped PRI patterns of varying slopes Δτ_{PRI}/T_{S}. The waveform shown is an example of linearly stepped PRI modulation, and is not meant as a restriction. The waveform can also consist of, but is not limited to, a repeating combination of multiple monotonically increasing or decreasing PRI step sequences of various slopes. Also, periods where the stepped PRI modulation pattern is stopped may be inserted into the abovementioned patterns.

Using the type of PRI modulation waveform described in FIG. 14D, target information may be calculated from the IF signals shown in FIGS. 11A-D, FIGS. 15A-B, FIGS. 16A-D, and FIGS. 17A-B in a way similar to that described for use with the waveform of FIG. 14C. Peaks in the IF signal spectrum represent target returns. The frequency of the target peaks is proportional to target range and is used to calculate target range. The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target relative velocity. One benefit of the use of multiple slopes of stepped PRI waveforms is that this assists in the removal of false or ghost targets in the processing, and aids in the resolution of the range-velocity ambiguity.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 14E illustrates a stepped PRI modulation waveform for use in the modulation signal generator 230 according to aspects of the present invention. This waveform is comprised of multiple linearly stepped PRI patterns intertwined. The individual stepped PRI patterns can have multiple slopes Δτ_{PRI}/T_{S} as described in FIG. 14D, be increasing, or decreasing. The intertwined waveform can also comprise, but is not limited to, an intertwined pattern of monotonically increasing or decreasing PRI stepped patterns of various slopes Δτ_{PRI}/T_{S}. Also, periods where the stepped PRI modulation pattern is stopped may be inserted into the abovementioned patterns. Furthermore, the intertwined waveform may consist of one or a plurality of linearly stepped PRI patterns where the order of each pattern's PRI steps is randomized according to a predetermined order. Then after reception, the A/D samples of the IF signals are correctly associated with their corresponding transmit pattern and re-ordered to be linear prior to being subjected to a Fourier transform or inverse Fourier transform processing, such as an FFT, DFT, IFFT, or IDFT.

Using the type of stepped PRI pattern described in FIG. 14E, target information may be calculated from the IF signals shown in FIGS. 11A-D, FIGS. 15A-B, FIGS. 16A-D, and FIGS. 17A-B in a manner similar to that as described for the frequency-hopping pattern of FIG. 14C, with the exception that A/D samples of the IF signals must be correctly associated with their corresponding pattern A, B, or C and de-intertwined before spectral processing such as, but not limited to, a Fourier transform or inverse Fourier transform. Techniques for accomplishing this are well known to persons skilled in the art.

FIG. 14F illustrates a stepped PRI modulation waveform for use in the modulation signal generator 230 according to aspects of the present invention. This waveform comprises two linearly stepped PRI patterns A and B, in which both patterns have an equal number of PRI steps and the same slope Δτ_{PRI}/T_{S}, but pattern B has a fixed PRI shift with respect to pattern A. That PRI shift is shown as Δτ_{SHIFT}. This waveform may repeat after a pre-determined number of steps in patterns A and B have been completed. Also, periods where the stepped PRI pattern is stopped may be inserted into the abovementioned patterns. Furthermore, the waveform shown in FIG. 14F is meant as an example, and is not meant as a restriction. One skilled in the art can modify the abovementioned waveform in a way such as using non-equal PRI step sizes, using more than two patterns, or using patterns that have different step sizes from each other, in order to obtain advantageous results for an application.

Using the type of stepped PRI pattern described in FIG. 14F, target information may be calculated from the IF signals shown in FIGS. 11A-D, FIGS. 15A-B, FIGS. 16A-D, and FIGS. 17A-B in the following manner. As an example, not meant in any way as a limitation, let the IF signal be sampled once per each PRI step dwell time T_{S} for each sequence A and B separately, and let the IF samples be associated with each sequence A and B separately for processing. Peaks in the IF signal spectrum represent target returns. The frequency of the target peaks is ambiguous in target range and velocity, as shown in the following equation:

$$K = \frac{2 \cdot V \cdot {T}_{P}}{λ} - \frac{2 \cdot R \cdot ( 1 / {τ}_{A MIN} - 1 / {τ}_{A MAX} )}{c} \qquad ( 9 )$$

where K is the frequency bin index integer of the Fourier Transform spectrum normalized with respect to frequency, V is the target relative velocity, λ is the wavelength, T_{P} is the coherent measurement period during which the IF signal is sampled for one Fourier Transform, R is the target range, c is the speed of light in a vacuum, and τ_{A}_{_{—}}_{MIN} and τ_{A}_{_{—}}_{MAX} are the minimum and maximum values of PRI of pattern A during a coherent measurement period T_{P}. The phase of the target frequency peaks in the complex spectrum of the IF signals for sequence A and sequence B, denoted by Ψ_{A} and Ψ_{B} respectively, can be measured and this phase difference ΔΨ=Ψ_{B}−Ψ_{A} can be used to resolve the range and velocity ambiguity, using in the following equation in combination with equation (9):

$$Δ Ψ = \frac{2 π \cdot V \cdot {T}_{P}}{λ \cdot ( N - 1 )} - \frac{4 π \cdot R}{c \cdot Δ {τ}_{SHIFT}} \qquad ( 10 )$$

where K is the frequency bin index integer of the Fourier Transform spectrum normalized with respect to frequency, V is the target relative velocity, λ is the wavelength, T_{P} is the measurement period over which the IF is sampled for one Fourier Transform, R is the target range, c is the speed of light in a vacuum, N is the number of frequency steps in each pattern A and B, and Δτ_{SHIFT} is the PRI shift between sequence A and B. The above equations (9) and (10) can be used together to resolve the range-velocity ambiguity.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals used to calculate target direction angle using the phase-comparison monopulse or multiple-baseline interferometry direction-finding methods.

FIG. 14G illustrates a stepped PRI modulation waveform for use in the modulation signal generator 230 according to aspects of the present invention. This waveform comprises a randomized, pseudo-random, or pseudo-noise pattern containing a plurality of PRI value steps. In one embodiment, the phase of the down-converted IF signals is used for range calculation. The phase of the target frequency peaks in the complex spectrum of the IF signals for adjacent PRI steps can be compared and this phase difference ΔΨ=τ_{FIRST}−Ψ_{SECOND} can be calculated, where Ψ_{SECOND} refers to the phase measurement of the second or later of the two PRI steps and Ψ_{FIRST} refers to the phase measurement of the first of the two PRI steps. Under these conditions, the target range can be determined as shown by the following equation:

$$R = \frac{c \cdot Δ Ψ \cdot Δ {τ}_{PR1}}{4 π} \qquad ( 11 )$$

where R is the target range, c is the speed of light in a vacuum, ΔΨ is the measured phase difference of the target spectral peaks of the IF signal sampled and Fourier Transformed during each frequency step dwell time T_{S}, and Δτ_{PRI} is the PRI time difference between adjacent PRI steps used for the range measurement. In another embodiment, the waveform of FIG. 14G consists of one or more linearly or monotonically stepped PRI patterns where the order of the PRI steps of each pattern is randomized according to a predetermined order. Then after reception, the A/D samples of the IF signal are correctly associated with each pattern and re-ordered to be in the original linear or monotonic sequence prior to the application of at least one signal processing function such as, but not limited to, a Fourier Transform or inverse Fourier Transform. Under these conditions, the range and relative velocity can be calculated using equations (7) and (8), with T_{S}, Δτ_{PRI}, f_{PU}, f_{PD}, τ_{PRI1}, τ_{PRI2} relating to the re-ordered sequence and measurements made on the re-ordered sequence.

FIG. 15A illustrates a pulsed WB/UWB/PUWB transmitter-receiver arrangement in accordance with one embodiment of the present invention. This arrangement can be used as an embodiment of WB/UWB/PUWB radar transmitter-receiver 200. The arrangement in FIG. 15A is similar to the arrangement in FIG. 11A except for the addition of phase shifter 237, attenuator 250, and summing block 218. The same components are denoted by the same reference numerals, and will not be explained again. The output of transmit oscillator 255 is input to phase shifter 237, which then feeds attenuator 250, and then sums the resulting signal with the modulated signal to be transmitted. One purpose of this arrangement is to reduce or suppress the residual CW carrier that can be present after modulation by modulator 221. As an alternate embodiment of the present invention, the quadrature down-conversion receiver method shown in FIG. 16A can be applied to this arrangement to create quadrature IF signals.

FIG. 15B illustrates a pulsed WB/UWB/PUWB transmitter-receiver arrangement in accordance with another embodiment of the present invention. This arrangement can be used as an embodiment of WB/UWB/PUWB radar transmitter-receiver 200. The arrangement in FIG. 15B is similar to the arrangement in FIG. 11B, except for the addition of phase shifter 237, attenuator 250, and summing block 218. The same components are denoted by the same reference numerals, and will not be explained again. The output of transmit oscillator 255 is input to phase shifter 237, which then feeds attenuator 250, and then sums the resulting signal with the modulated signal to be transmitted. One purpose of this arrangement is to reduce or suppress the residual CW carrier that can be present after modulation by modulator 221. As an alternate embodiment of the present invention, the quadrature down-conversion receiver method shown in FIG. 16B can be applied to this arrangement to create quadrature IF signals.

FIG. 16A illustrates a pulsed WB/UWB/PUWB transmitter-receiver arrangement in accordance with one embodiment of the present invention. This arrangement can be used as an embodiment of WB/UWB/PUWB radar transmitter-receiver 200. The arrangement in FIG. 16A is similar to the arrangement in FIG. 11A except that the n receiver channels use quadrature down-conversion to create quadrature IF signals. The same components are denoted by the same reference numerals, and will not be explained again. The output signal of filters 225, 226 are each split and feed mixers 273a, 273b, 273c, and 273d. The output signal of inverter 281 feeds mixers 273a and 273c, and also feeds the 90 degree phase shifter 274. The output of the 90 degree phase shifter 274 feeds mixers 273b and 273d. The outputs of mixers 273a, 273b, 273c, 273d feed filters 290a, 290b, 290c, 290d, and the resulting signals are intermediate frequency (IF) quadrature signals containing target range, velocity, and phase information. Mixers 273a-d can be implemented by, but are not limited to, mixers, multipliers, or switches. Filters 290a-d may be implemented by, but are not limited to, low pass filters. Filter 212 can be used to pass only an upper or lower sideband signal for transmission, or filter 212 can be removed resulting in a double sideband transmitted signal. The inverter 281 can be removed, resulting in a direct connection from modulation signal generator 230 to the inputs of the 90 degree phase shifter 274, and mixers 273a, 273c without departing from the present invention. Furthermore, the signal feeding the input of the 90 degree phase shifter 274 and mixers 273a, 273c can be filtered prior to those input connections without departing from the present invention.

FIG. 16B illustrates a pulsed WB/UWB/PUWB transmitter-receiver arrangement in accordance with another embodiment of the present invention. This arrangement can be used as an embodiment of WB/UWB/PUWB radar transmitter-receiver 200. The arrangement in FIG. 16B is similar to the arrangement in FIG. 16A except for the addition of modulators 260, 261. The same components are denoted by the same reference numerals, and will not be explained again. The modulators 260, 261 modulate the received signals prior to the down-converter mixers 270, 271. Modulators 260, 261 can be implemented by, but are not limited to, switches which gate the receiver channels, effectively blanking the receiver when the transmit signal pulse is on, and passing energy to the receiver when the transmit signal pulse is off. This can help to reduce transmit signal leakage to the receiver and increase the dynamic range of the receiver.

FIG. 16C shows a pulsed WB/UWB/PUWB transmitter-receiver arrangement in accordance with a further embodiment of the present invention. This arrangement can be used as an embodiment of WB/UWB/PUWB radar transmitter-receiver 200. The arrangement in FIG. 16C is similar to the arrangement in FIG. 11C except for use of quadrature down-conversion mixers 282, 283, 284, 285, the 90 degree phase shifter 274, and filters 290a, 290b, 290c, 290d. The same components are denoted by the same reference numerals, and will not be explained again. This arrangement outputs quadrature IF signals from the output of the filters 290a, 290b, 290c, 290d. Filters 290a, 290b, 290c, 290d can be implemented by, but are not limited to, low pass filters or band pass filters. Mixers 282, 283, 284, 285 can be implemented by, but are not limited to, mixers or multipliers. The transmitted output signal is double sideband. Filter 212 can be used to pass only an upper or lower sideband signal for transmission, or filter 212 can be removed resulting in a double sideband transmitted signal. The inverter 281 can be removed, resulting in a direct connection from modulation signal generator 230 to the inputs of the 90 degree phase shifter 274, mixers 282, 284, and modulators 260, 261 without departing from the present invention. Furthermore, the signal feeding the input of the 90 degree phase shifter 274 and mixers 282, 284 can be filtered prior to those input connections without departing from the present invention.

FIG. 16D illustrates a pulsed WB/UWB/PUWB transmitter-receiver arrangement in accordance with a yet further embodiment of the present invention. This arrangement can be used as an embodiment of WB/UWB/PUWB radar transmitter-receiver 200. The arrangement in FIG. 16D is similar to the arrangement in FIG. 16C except for the removal of modulators 260, 261. The same components are denoted by the same reference numerals, and will not be explained again. This arrangement is a simpler structure compared to that of FIG. 16C. The removal of receiver gating makes the arrangement more compact and potentially lower cost.

A pulsed WB/UWB/PUWB transmitter-receiver arrangement is illustrated in FIG. 17A in accordance with another embodiment of the present invention. This arrangement can be used as an embodiment of WB/UWB/PUWB radar transmitter-receiver 200. The arrangement in FIG. 17A is similar to the arrangement in FIG. 11A except for the removal of filter 212, and the addition of 90-degree phase shifters 228, 229, modulator 214, and summation block 297. The same components are denoted by the same reference numerals, and will not be explained again. The output signal of transmit oscillator 255 is fed to 90-degree phase shifter 229 and modulator 214. The output of 90-degree phase shifter 229 is fed to modulator 221. The output of modulation signal generator 230 is fed to the input of 90-degree phase shifter 228 and to the modulator 214 control port. The output of 90-degree phase shifter 228 feeds the control port of modulator 221. The outputs of modulators 221 and 214 are fed into the summation block 297, which then outputs the single sideband signal for transmission. The circuit modifications noted above constitute a methodology to transmit a single-sideband, lower-sideband signal. The circuitry can easily be modified by one skilled in the art to transmit single-sideband, upper-sideband, but remains still within the scope of this invention. Also, a filter can be added to the output of this arrangement without departing from the spirit of the present invention. Furthermore, the quadrature down-conversion receiver method shown in FIG. 16A can be applied to this arrangement to create quadrature IF signals as an alternate embodiment of the present invention.

FIG. 17B shows a pulsed WB/UWB/PUWB transmitter-receiver arrangement in accordance with a further embodiment of the present invention. This arrangement can be used as an embodiment of WB/UWB/PUWB radar transmitter-receiver 200. The arrangement in FIG. 17B is similar to the arrangement in FIG. 17A except for the addition of modulators 260, 261. The same components are denoted by the same reference numerals and will not be explained again. The modulators 260, 261 modulate the received signals prior to the down-converter mixers 270, 271. Modulators 260, 261 may be implemented by, but are not limited to, switches which gate the receiver channels, effectively blanking the receiver when the transmit signal pulse is on, and passing energy to the receiver when the transmit signal pulse is off. This can help to reduce transmit signal leakage to the receiver and increase the dynamic range of the receiver. As an alternate embodiment of the present invention, the quadrature down-conversion receiver method shown in FIG. 16B can be applied to this arrangement to create quadrature IF signals.

In a further embodiment of the present invention, the radar transmit-receive arrangements illustrated in FIGS. 11A-D, 15A-B, 16A-D, and 17A-B are modified to have only one RX channel. As one example, in the arrangement in FIG. 11A, the only receiver channel would be RX CH.1, and the components 271, 226, 276, and 236 would be removed. As another example, in the arrangement in FIG. 16B, the only receiver channel would be RX CH.1 which gets down-converted to quadrature IF signals, while components 261, 271, 226, 273c-d, and 290c-d would be removed. Under these conditions, the radar transmitter-receiver described could be used to determine target range, velocity, or range and velocity. A sensor unit utilizing one of these transmitter-receiver arrangements could be realized by using one of these arrangements as the WB/UWB/PUWB transmitter-receiver described in FIGS. 3A-D with the exception that the radar sensor illustrated in FIGS. 3A-D would be modified to have only one receiver channel, RX CH.1. In addition, plurality of sensor units utilizing this radar transmitter-receiver arrangement could be used to determine a target direction angle through the use of a multilateration or amplitude comparison direction finding technique.

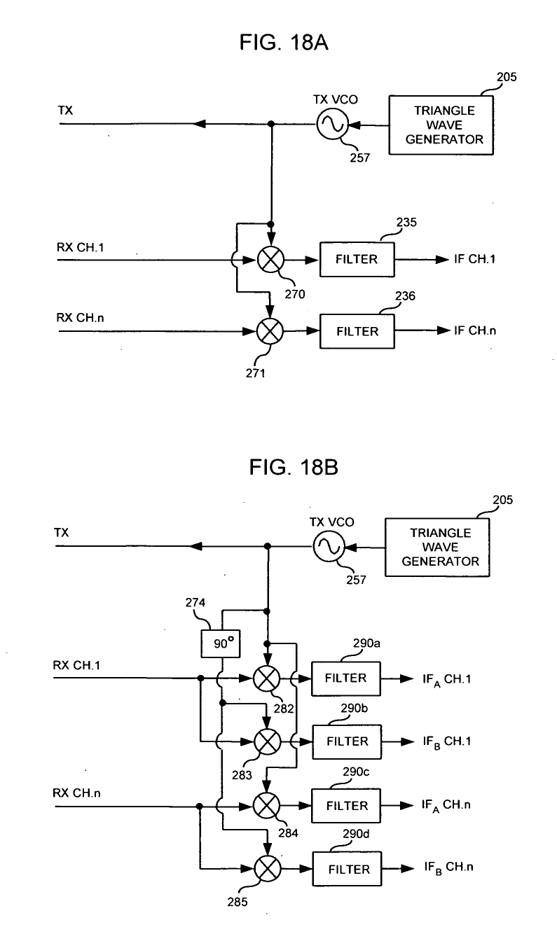

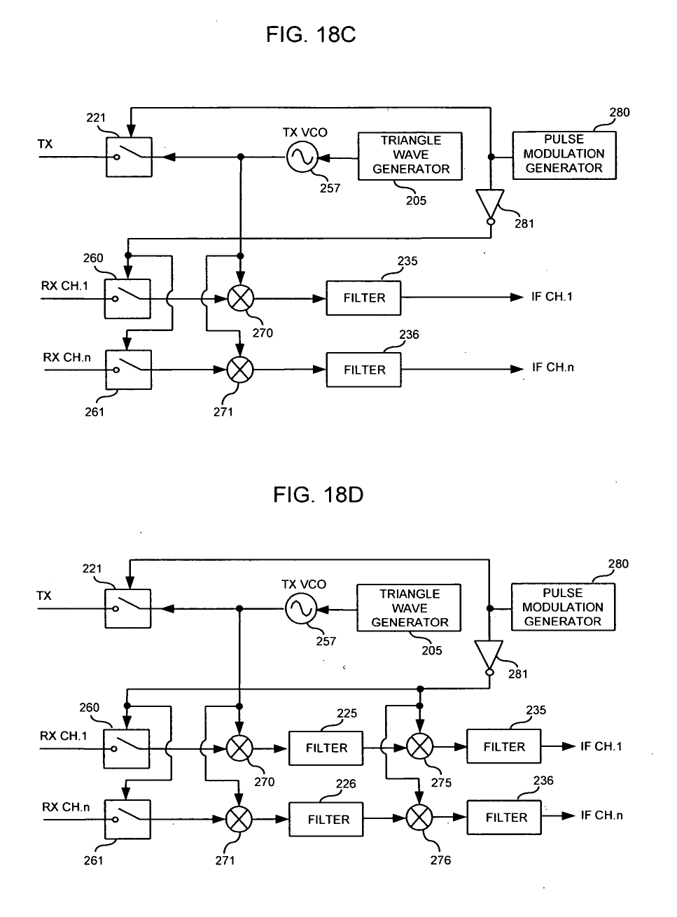

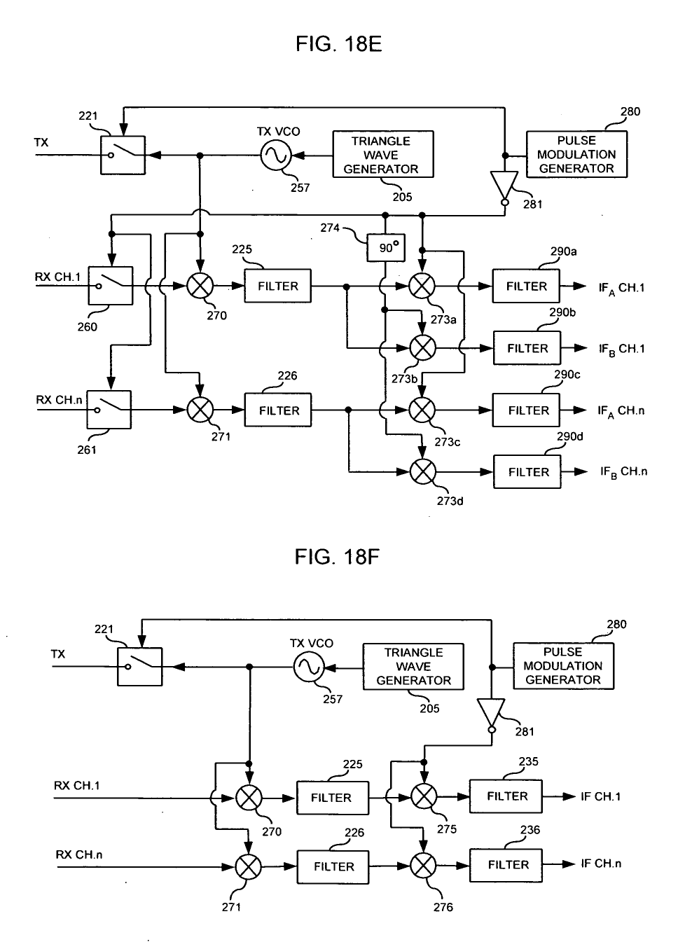

An FMCW WB/UWB/PUWB transmitter-receiver arrangement is illustrated in FIG. 18A as one embodiment of WB/UWB/PUWB radar transmitter-receiver 200. In this arrangement, triangle wave generator 205 outputs a modulation signal modulates the frequency of transmit VCO 257. The modulation signal output from triangle wave generator 205 is such that the frequency output of transmit VCO 257 is continuously linearly or monotonically increased or decreased over predetermined time intervals, can contain multiple slopes of Δfrequency versus Δtime, and can contain blanking periods where the frequency modulation is stopped. The triangle wave generator may contain circuitry such as a phase-locked loop, phase-frequency locked loop, direct digital synthesizer, linearization circuitry, frequency dividers, or frequency multipliers. Furthermore, the output of VCO 257 can additionally be split, and one of the split signals can be fed back to the triangle wave generator block for the purposes of linearizing or increasing the modulation accuracy of the frequency output of VCO 257. The output signal from the transmit VCO 257 is then sent for transmission. The received signals for n receiver channels, where n is an integer greater than or equal to 2, are fed to down-converting mixers 270, 271, where the signals are mixed with the output of transmit VCO 257. The output signals from mixers 270, 271 are then filtered by filters 235, 236 and the resulting signals are intermediate frequency (IF) signals containing target information. Filters 235, 236 can be implemented by, but are not limited to, low-pass filters or band-pass filters. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

Peaks in the IF signal spectrum represent target returns. The frequency of the target peaks is proportional to target range, and is used to calculate target range. As an example, not meant in any way as a limitation, let the radar arrangement of FIG. 18A utilize a linear up chirp and down chirp frequency modulation waveform with the frequency up ramp time equal to the down ramp time equal to the IF signal coherent measurement period T_{P}. Under these conditions, the target range can be calculated by the following equation:

$$R = \frac{c \cdot {T}_{P}}{4 \cdot Δ {f}_{B W}} \cdot ( {f}_{U} + {f}_{D} ) \qquad ( 12 )$$

where R is the calculated target range, c is the speed of light in a vacuum, Δf_{BW} is the total frequency modulation excursion of the chirp waveform during the ramp time T_{P}, and f_{U} and f_{D} are the beat frequencies in the IF signal corresponding to the measurements during the up chirp period T_{P} and down chirp period T_{P} respectively.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple baseline interferometry direction-finding methods. The Doppler frequency shift of the target frequency peaks is used to calculate target velocity. As an example, not meant in any way as a limitation, let the radar arrangement of FIG. 18A utilize a linear up chirp and down chirp frequency modulation with the frequency up ramp time equal to the down ramp time equal to the IF signal coherent measurement period T_{P}. Under these conditions, the target relative velocity can be calculated by the following equation:

$$V = \frac{c \cdot ( {f}_{D} - {f}_{U} )}{4 \cdot {f}_{0}} \qquad ( 13 )$$

where V is the calculated target relative velocity defined as positive for an approaching target, c is the speed of light in a vacuum, f₀ is the average frequency of the transmitted modulated radar wave during a coherent measurement period T_{P}, and f_{U} and f_{D} are the beat frequencies in the IF signal corresponding to the measurements during the up chirp period T_{P} and down chirp period T_{P} respectively.

FIG. 18B shows a pulsed FMCW WB/UWB/PUWB transmitter-receiver arrangement as another embodiment of WB/UWB/PUWB radar transmitter-receiver 200. The arrangement in FIG. 18B is similar to the arrangement in FIG. 18A except for the implementation of a quadrature receiver down-converter by replacing mixers 270, 271 and filters 225, 226 with mixers 282, 283, 284, 285 and filters 290a, 290b, 290c, 290d, as well as the addition of a 90 degree phase shifter 274. The same components are denoted by the same reference numerals, and will not be explained again. In this arrangement, the output of transmit VCO 257 feeds the 90 degree phase shifter 274 as well as mixers 282 and 284. The output of the 90 degree phase shifter 274 feeds mixers 283, 285. The receiver channels 1 and n are each split. Receiver channel 1 feeds mixers 282 and 283, while receiver channel n feeds mixers 284 and 285 as shown. The output signals from mixers 282, 283, 284, 285 are then filtered by filters 290a, 290b, 290c, 290d and the resulting signals are quadrature intermediate frequency (IF) signals containing target information. Target information may be calculated from the IF signals in a manner similar to that as described for the FMCW arrangement of FIG. 18A.

FIG. 18C shows a pulsed FMCW WB/UWB/PUWB transmitter-receiver arrangement as a further embodiment of WB/UWB/PUWB radar transmitter-receiver 200. The arrangement in FIG. 18C is similar to the arrangement in FIG. 18A except for the addition of pulse modulation generator 280, modulators 221, 260, 261, and inverter 281. The same components are denoted by the same reference numerals and will not be explained again. In this arrangement, pulse modulation generator 280 outputs a modulation signal which is fed to the modulation port of modulator 221 and to the input of inverter 281. The modulator 221 modulates the signal from the transmit oscillator 257 according to the modulation pattern from pulse modulation generator 280. The output signal from the modulator 221 is then sent for transmission. The received signals for n receiver channels, where n is an integer greater than or equal to 2, are fed to modulators 260, 261. The output signals from modulators 260, 261 are fed to down-converting mixers 270, 271, where the signals are mixed with the output of transmit VCO 257. The output signals from mixers 270, 271 are then filtered by filters 235, 236 and the resulting signals are intermediate frequency (IF) signals containing target information. The inverter 281 can be removed and replaced with a direct connection as an option. The modulator 221 can be implemented by, but is not limited to, a pulse modulator, amplitude modulator, bi-phase shift keyed modulator, phase modulator, switch, mixer, or AND gate. Modulators 260, 261 may be implemented by, but not limited to, switches which gate the receiver channels, effectively blanking the receiver when the transmit signal pulse is on, and passing energy to the receiver when the transmit signal pulse is off. This can help to reduce transmit signal leakage to the receiver and increase the dynamic range of the receiver. Target information may be calculated from the IF signals in a manner similar to that as described for the FMCW arrangement of FIG. 18A.

FIG. 18D shows an alternate pulsed FMCW WB/UWB/PUWB transmitter-receiver arrangement as a yet further embodiment of WB/UWB/PUWB radar transmitter-receiver 200. The arrangement in FIG. 18D is similar to the arrangement in FIG. 18C except for the addition of filters 225, 226 and mixers 275, 276. The same components are denoted by the same reference numerals and will not be explained again. In this arrangement, the output signals from mixers 270, 271 are fed to filters 225, 226, and the resulting signals are fed to mixers 275, 276, where they are mixed with the output signal from inverter 281. The signal feeding mixers 275, 276 can be additionally filtered or re-inverted prior to being connected to mixers 275, 276 without departing from the spirit of the present invention. Target information may be calculated from the IF signals in a manner similar to that as described for the FMCW arrangement of FIG. 18A.

FIG. 18E shows a pulsed FMCW WB/UWB/PUWB transmitter-receiver arrangement as another embodiment of WB/UWB/PUWB radar transmitter-receiver 200. The arrangement in FIG. 18E is similar to the arrangement in FIG. 18D except for the implementation of a quadrature receiver down-converter by replacing mixers 275, 276 and filters 235, 236 with mixers 273a, 273b, 273c, 273d and filters 290a, 290b, 290c, 290d, as well as the addition of a 90 degree phase shifter 274. The same components are denoted by the same reference numerals and will not be explained again. In this arrangement, the output of inverter 281 feeds the 90 degree phase shifter 274 as well as mixers 273a and 273c. The output of the 90 degree phase shifter 274 feeds mixers 273b, 273d. The outputs from filters 225, 226 are each split. The output from filter 225 feeds mixers 273a and 273b, while the output from filter 226 feeds mixers 273c and 273d as shown. The output signals from mixers 273a, 273b, 273c, 273d are then filtered by filters 290a, 290b, 290c, 290d and the resulting signals are quadrature intermediate frequency (IF) signals containing target information. The signal from inverter 281 feeding mixers 273a, 273c, and 90 degree phase shifter 274 can be additionally filtered or re-inverted prior to being connected to those inputs without departing from the spirit of the present invention. Target information may be calculated from the IF signals in a manner similar to that as described for the FMCW arrangement of FIG. 18A.

FIG. 18F shows an alternate pulsed FMCW WB/UWB/PUWB transmitter-receiver arrangement as a further embodiment of WB/UWB/PUWB radar transmitter-receiver 200. The arrangement in FIG. 18F is similar to the arrangement in FIG. 18D except for the removal of modulators 260, 261. Furthermore, the quadrature down-conversion receiver method shown in FIG. 18E can be applied to this arrangement to create quadrature IF signals as an alternate embodiment of the present invention. Target information may be calculated from the IF signals in a manner similar to that as described for the FMCW arrangement of FIG. 18A.

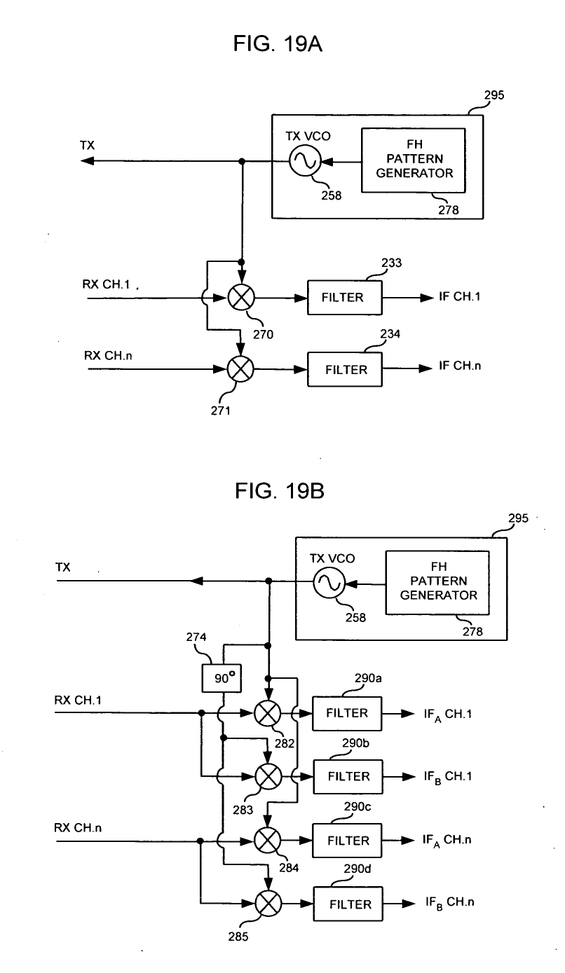

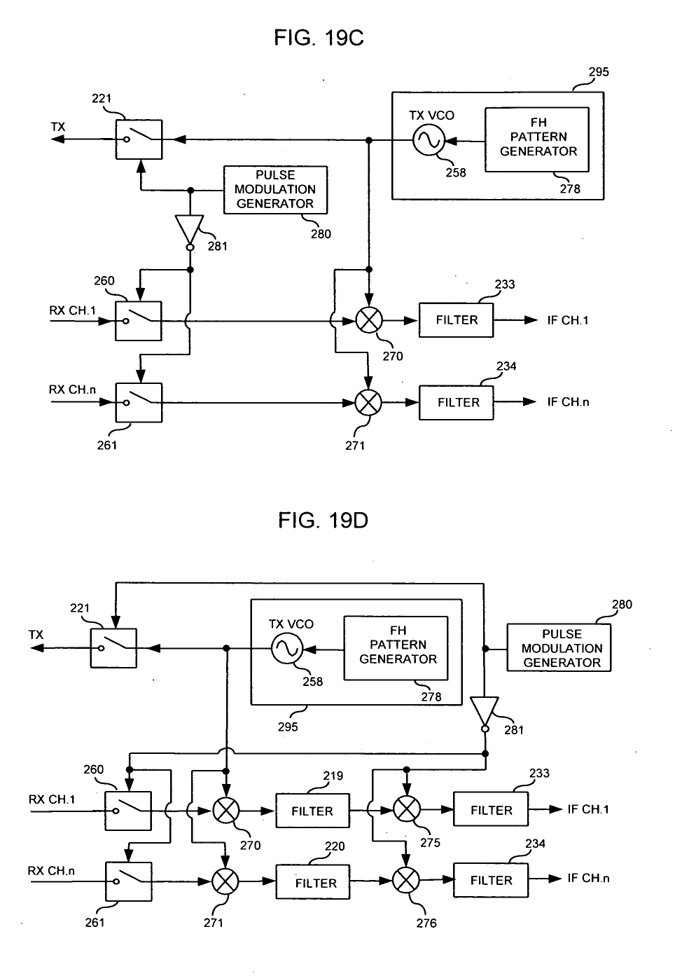

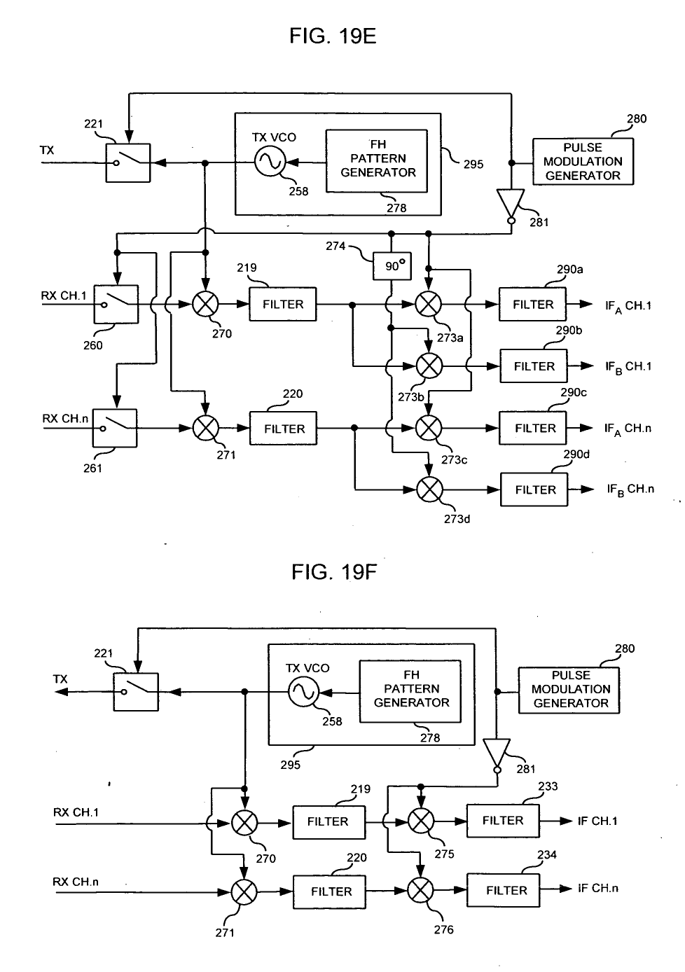

A frequency-hopping WB/UWB/PUWB transmitter-receiver arrangement is illustrated in FIG. 19A as one embodiment of WB/UWB/PUWB radar transmitter-receiver 200. In this arrangement, a frequency-hopping signal generator 295 outputs a signal for transmission. One embodiment of frequency-hopping signal generator 295 consists of a frequency-hopping pattern generator 278 which controls the output frequency of a transmit VCO 258. The output signal from the frequency-hopping signal generator 295 is such that its frequency hops or steps across a predetermined pattern of frequencies, each frequency hop or step remaining static for a predetermined period of time. The received signals for n receiver channels, where n is an integer greater than or equal to 2, are fed to down-converting mixers 270, 271, where the signals are mixed with the output signal of frequency hopping signal generator 295. The output signals from mixers 270, 271 are then filtered by filters 233, 234 and the resulting signals are intermediate frequency (IF) signals containing target information. Filters 233, 234 may be implemented by, but are not limited to, low-pass filters. The frequency-hopping pattern of frequency-hopping signal generator 295 can include, but is not limited to, a pseudo-random pattern such as with a PRBS, a pseudo-noise pattern, a randomized pattern, a linearly or monotonically stepped pattern, an intertwined pattern consisting of a plurality of linearly or monotonically stepped patterns, an intertwined pattern consisting of a plurality of the abovementioned patterns, or any combination of the abovementioned patterns. Mixers 270, 271 may be implemented by, but are not limited to, mixers, multipliers, or switches. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

FIG. 19B shows a frequency hopping WB/UWB/PUWB transmitter-receiver arrangement as another embodiment of WB/UWB/PUWB radar transmitter-receiver 200. The arrangement in FIG. 19B is similar to the arrangement in FIG. 19A except for the implementation of quadrature receiver down-converter by replacing mixers 270, 271 and filters 233, 234 with mixers 282, 283, 284, 285 and filters 290a, 290b, 290c, 290d, as well as the addition of a 90 degree phase shifter 274. The same components are denoted by the same reference numerals and will not be explained again. In this arrangement, the output of frequency hopping signal generator 295 feeds the 90 degree phase shifter 274 as well as mixers 282 and 284. The output of the 90 degree phase shifter 274 feeds mixers 283, 285. The receiver channels 1 and n are each split. Receiver channel 1 feeds mixers 282 and 283, while receiver channel n feeds mixers 284 and 285 as shown. The output signals from mixers 282, 283, 284, 285 are then filtered by filters 290a, 290b, 290c, 290d and the resulting signals are quadrature intermediate frequency (IF) signals containing target information.

FIG. 19C shows a pulsed frequency hopping WB/UWB/PUWB transmitter-receiver arrangement as another embodiment of WB/UWB/PUWB radar transmitter-receiver 200. The arrangement in FIG. 19C is similar to the arrangement in FIG. 19A except for the addition of pulse modulation generator 280, modulators 221, 260, 261, and inverter 281. The same components are denoted by the same reference numerals, and will not be explained again. In this arrangement, pulse modulation generator 280 outputs a modulation signal which is fed to the modulation port of modulator 221 and to the input of inverter 281. The modulator 221 modulates the signal from the frequency hopping signal generator 295 according to the modulation pattern from pulse modulation generator 280. The output signal from the modulator 221 is then sent for transmission. The received signals for n receiver channels, where n is an integer greater than or equal to 2, are fed to modulators 260, 261. The output signals from modulators 260, 261 are fed to down-converting mixers 270, 271, where the signals are mixed with the output of frequency hopping signal generator 295. The output signals from mixers 270, 271 are then filtered by filters 233, 234 and the resulting signals are intermediate frequency (IF) signals containing target information. The inverter 281 can be removed and replaced with a direct connection as an option. The modulator 221 can be implemented by, but is not limited to, a pulse modulator, amplitude modulator, bi-phase shift keyed modulator, phase modulator, switch, mixer, or AND gate. Modulators 260, 261 may be implemented by, but are not limited to, switches which gate the receiver channels, effectively blanking the receiver when the transmit signal pulse is on, and passing energy to the receiver when the transmit signal pulse is off. This can help to reduce transmit signal leakage to the receiver and increase the dynamic range of the receiver. As an alternate embodiment of the present invention, the modulators 260, 261 can be removed from the arrangement shown in FIG. 19C such that the received signals are input directly to mixers 270, 271.

FIG. 19D shows a pulsed frequency-hopping WB/UWB/PUWB transmitter-receiver arrangement as a yet further embodiment of WB/UWB/PUWB radar transmitter-receiver 200. The arrangement in FIG. 19D is similar to the arrangement in FIG. 19C except for the addition of filters 219, 220 and mixers 275, 276. The same components are denoted by the same reference numerals, and will not be explained again. In this arrangement, the output signals from mixers 270, 271 are fed to filters 219, 220, and the resulting signals are fed to mixers 275, 276, where they are mixed with the output signal from inverter 281. The signal feeding mixers 275, 276 can be additionally filtered or re-inverted prior to being connected to mixers 275, 276 without departing from the spirit of the present invention.

FIG. 19E shows a pulsed frequency-hopping WB/UWB/PUWB transmitter-receiver arrangement as another embodiment of WB/UWB/PUWB radar transmitter-receiver 200. The arrangement in FIG. 19E is similar to the arrangement in FIG. 19D except for the implementation of quadrature receiver down-converter by replacing mixers 275, 276 and filters 233, 234 with mixers 273a, 273b, 273c, 273d and filters 290a, 290b, 290c, 290d, as well as the addition of a 90 degree phase shifter 274. The same components are denoted by the same reference numerals and will not be explained again. In this arrangement, the output of inverter 281 feeds the 90 degree phase shifter 274 as well as mixers 273a and 273c. The output of the 90 degree phase shifter feeds mixers 273b, 273d. The outputs from filters 219, 220 are each split. The output from filter 219 feeds mixers 273a and 273b, while the output from filter 220 feeds mixers 273c and 273d as shown. The output signals from mixers 273a, 273b, 273c, 273d are then filtered by filters 290a, 290b, 290c, 290d and the resulting signals are quadrature intermediate frequency (IF) signals containing target information. The signal from inverter 281 feeding mixers 273a, 273c, and 90 degree phase shifter 274 can be additionally filtered or re-inverted prior to being connected to those inputs without departing from the spirit of the present invention.

FIG. 19F shows a pulsed frequency-hopping WB/UWB/PUWB transmitter-receiver arrangement as a further embodiment of WB/UWB/PUWB radar transmitter-receiver 200. The arrangement in FIG. 19F is similar to the arrangement in FIG. 19D except for the removal of modulators 260, 261. Furthermore, the quadrature down-conversion receiver method shown in FIG. 19E can be applied to this arrangement to create quadrature IF signals as an alternate embodiment of the present invention.

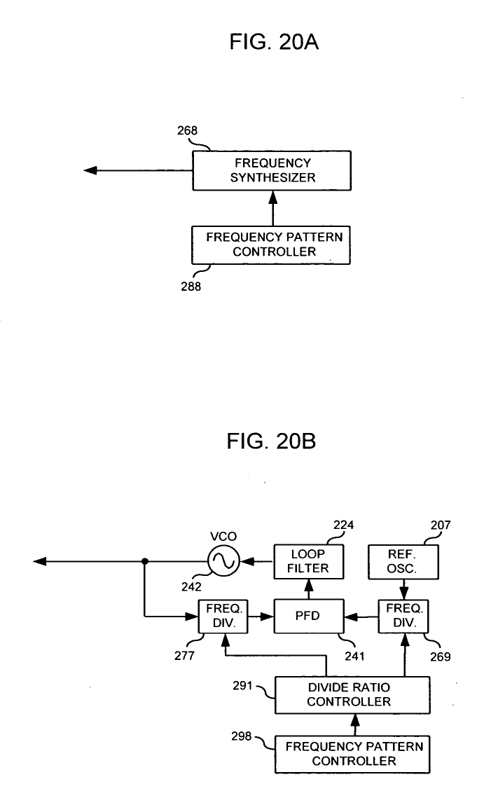

One embodiment of the frequency-hopping signal generator 295 is shown in FIG. 20A. This arrangement can also be used a one embodiment of modulation signal generator 230. A frequency pattern controller 288 controls a frequency synthesizer 268. The output of frequency synthesizer 268 will be a signal whose frequency hops or steps according to the pattern and timing dictated by the frequency pattern controller 288.

Another embodiment of the frequency hopping signal generator 295 is shown in FIG. 20B. This arrangement can also be used as another embodiment of modulation signal generator 230. A frequency pattern controller 298 is input to a divide ratio controller 291 which controls the divide ratios of frequency dividers 277, 269. The frequency dividers 277, 269 can be implemented by counters without departing from the scope or spirit of the present invention. A reference oscillator 207 provides a reference signal of a predetermined frequency to the input of frequency divider 269. The output of VCO 242 is split and one of the split signals is input to frequency divider 277. The output of frequency divider 277 and the output of frequency divider 269 are both input to phase-frequency detector 241. The output of phase frequency detector 241 is filtered by loop filter 224 and is input to the frequency control port of VCO 242. The output of VCO 242 will be a signal whose frequency hops or steps according to the pattern and timing dictated by the frequency pattern controller 298.

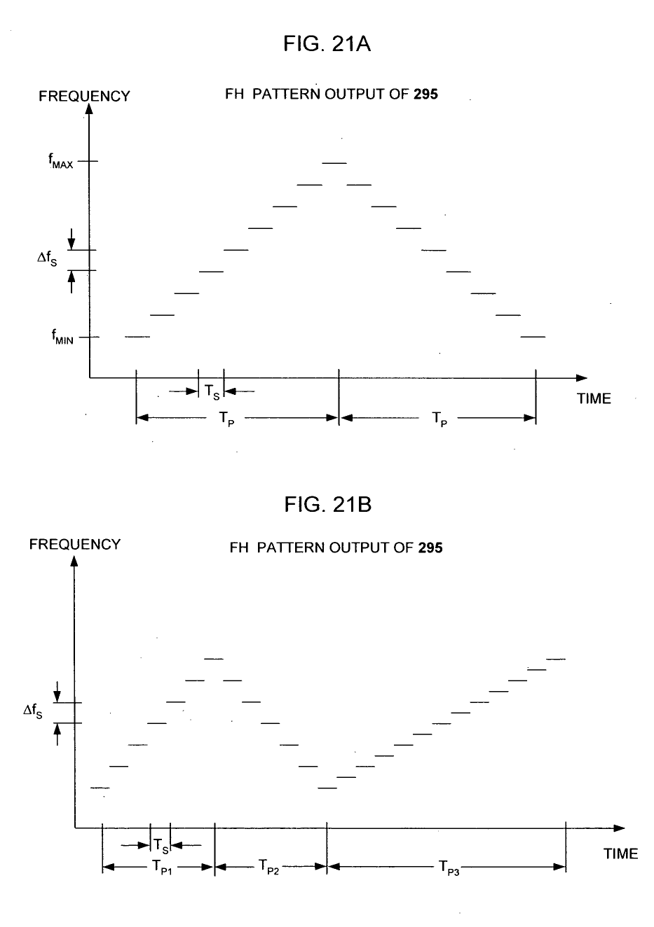

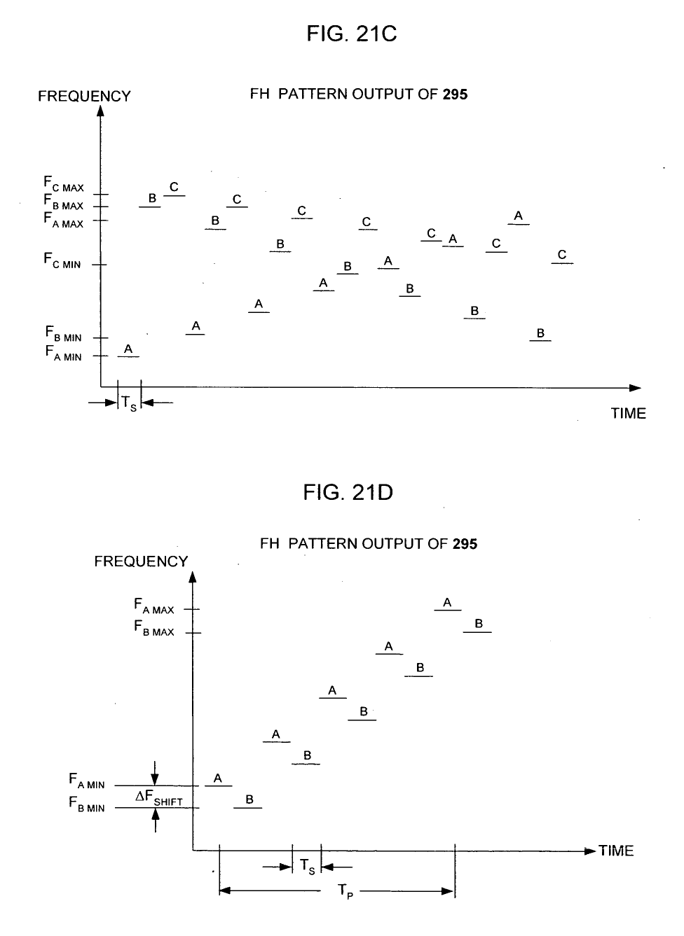

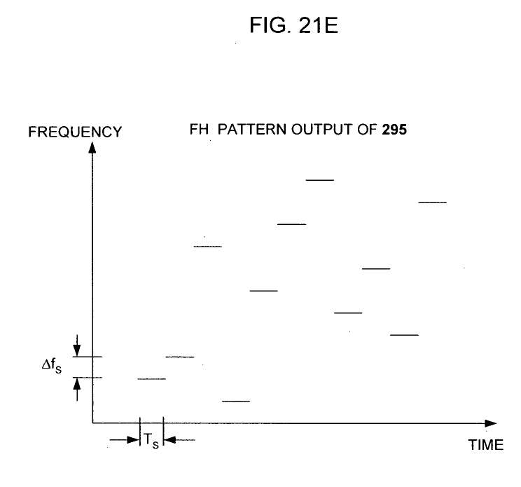

FIG. 21A illustrates one frequency-hopping pattern for use in the frequency hopping signal generator 295 according to aspects of the present invention. This waveform shows a linear frequency-stepped pattern during a time period T_{P}. This waveform shown is an example of linear frequency-stepped modulation, and is not meant as a restriction. The waveform can also comprise, but is not limited to, a repeating pattern of linearly increasing frequency steps, a repeating pattern of linearly decreasing frequency steps, alternating periods of linearly increasing and decreasing frequency step patterns, a repeating pattern of monotonically increasing frequency steps, a repeating pattern of monotonically decreasing frequency steps, or alternating periods of monotonically increasing and decreasing frequency step patterns. Also, periods where the stepped frequency modulation pattern is stopped may be inserted into the abovementioned patterns.

Using the type of frequency-hopping pattern described in FIG. 21A, target information may be calculated from the IF signals shown in FIGS. 19A-F, in the following way. Peaks in the IF signal spectrum represent target returns. The frequency of the target peaks is proportional to target range and is used to calculate target range. As an example, not meant in any way as a limitation, let the radar arrangement of FIG. 19A utilize a linear up frequency step sequence and down frequency step sequence as shown in FIG. 21A, and let the IF signal be measured during each coherent measurement period T_{P}. Under these conditions, the target range can be calculated using the following equation:

$$R = \frac{c \cdot {T}_{S}}{4 \cdot Δ {f}_{S}} \cdot ( {f}_{U} + {f}_{D} ) . \qquad ( 14 )$$

where R is the calculated target range, c is the speed of light in a vacuum, T_{S} is dwell time of each frequency step, Δf_{S} is the frequency difference between adjacent steps in the linear frequency step sequence, and f_{U} and f_{D} are the beat frequencies in the IF signal corresponding to the measurements during the up step sequence period T_{P} and down step sequence period T_{P} respectively.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target velocity. As an example, not meant in any way as a limitation, let the radar arrangement of FIG. 19A utilize a linear up frequency step sequence and down frequency step sequence as shown in FIG. 21A, and let the IF signal be measured during each coherent measurement period T_{P}. Under these conditions, the target relative velocity can be calculated by the following equation:

$$V = \frac{c}{2 \cdot ( {f}_{MIN} + {f}_{MAX} )} \cdot ( {f}_{D} - {f}_{U} ) \qquad ( 15 )$$

where V is the calculated target relative velocity defined as positive for an approaching target, c is the speed of light in a vacuum, f_{MIN} and f_{MAX} are the minimum and maximum frequency steps in the linear sequence during a coherent measurement period T_{P}, and f_{U} and f_{D} are the beat frequencies in the IF signal corresponding to the measurements during the up step sequence period T_{P} and down step sequence period T_{P} respectively.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 21B shows a frequency hopping pattern for use in the frequency hopping signal generator 295 according to aspects of the present invention. This waveform comprises multiple linear-frequency stepped patterns of varying slopes Δfrequency/Δtime. The waveform shown is an example of linear frequency-stepped modulation, and is not meant as a restriction. The waveform can also consist of, but is not limited to, a repeating combination of multiple monotonically increasing or decreasing frequency step patterns of various slopes. Also, periods where the stepped frequency modulation pattern is stopped may be inserted into the abovementioned patterns.

Using the type of frequency-hopping pattern described in FIG. 21B, target information may be calculated from the IF signals shown in FIGS. 19A-F, in a way similar to that described for use with the waveform of FIG. 21A. Peaks in the IF signal spectrum represent target returns. The frequency of the target peaks is proportional to target range and is used to calculate target range. The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals and used to calculate target direction angle using the phase-comparison monopulse or multiple-baseline interferometry direction-finding methods. The Doppler frequency shift of the target frequency peaks is used to calculate target velocity. The use of multiple slopes of stepped patterns assists in the removal of false or ghost targets in the processing, and aids in the resolution of the range-velocity ambiguity.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 21C shows a frequency-hopping pattern for use in the frequency-hopping signal generator 295 according to aspects of the present invention. This waveform is comprised of multiple linear frequency-stepped patterns intertwined. The individual frequency-stepped patterns can have multiple slopes, be increasing, or decreasing. The intertwined waveform can also comprise, but is not limited to, an intertwined pattern of monotonically increasing or decreasing frequency step patterns of various slopes. Also, periods where the stepped frequency modulation pattern is stopped may be inserted into the abovementioned patterns. Furthermore, the intertwined waveform may consist of one or a plurality of linear frequency stepped patterns where the order of each pattern's steps is randomized according to a predetermined order. Then after reception, the A/D samples of the IF signals are correctly associated with their corresponding transmit pattern and re-ordered to be linear prior to being subjected to a Fourier transform or inverse Fourier transform processing, such as an FFT, DFT, IFFT, or IDFT.

Using the type of frequency-hopping pattern described in FIG. 21C, target information may be calculated from the IF signals shown in FIGS. 19A-F, in a manner similar to that as described for the frequency-hopping pattern of FIG. 21A, with the exception that A/D samples of the IF signals must be correctly associated with their corresponding pattern A, B, or C and de-intertwined before spectral processing such as, but not limited to, a Fourier transform or inverse Fourier transform. Techniques for accomplishing this are well known to persons skilled in the art.

FIG. 21D shows a frequency-hopping pattern for use in the frequency-hopping signal generator 295 as a yet further embodiment of the present invention. This waveform comprises two linear frequency-stepped patterns A and B, in which both patterns have an equal number of frequency steps and the same slope Δf_{S}/T_{S}, but pattern B has a fixed frequency shift offset with respect to pattern A. That frequency shift offset is shown as ΔF_{SHIFT}. This waveform may repeat after a pre-determined number of steps in patterns A and B have been completed. Also, periods where the stepped frequency modulation pattern is stopped may be inserted into the abovementioned patterns. Furthermore, the waveform shown in FIG. 21D is meant as an example, and is not meant as a restriction. One skilled in the art can modify the abovementioned waveform in a way such as using non-equal frequency step sizes, using more than two patterns, or using patterns that have different step sizes from each other, in order to obtain advantageous results for an application.

Using the type of frequency-hopping pattern described in FIG. 21D, target information may be calculated from the IF signals shown in FIGS. 19A-F, in the following manner. As an example, not meant in any way as a limitation, let the IF signal be sampled once per each frequency step dwell time T_{S} for each sequence A and B separately, and let the IF samples be associated with each sequence A and B separately for processing. Peaks in the IF signal spectrum represent target returns. The frequency of the target peaks is ambiguous in target range and relative velocity, as shown in the following equation:

$$K = \frac{2 \cdot V \cdot {T}_{P}}{λ} - \frac{2 \cdot R \cdot ( {F}_{A MIN} - {F}_{A MAX} )}{c} \qquad ( 16 )$$

where K is the frequency bin index integer of the Fourier Transform spectrum normalized with respect to frequency, V is the target relative velocity, λ is the wavelength, T_{P} is the coherent measurement period during which the IF signal is sampled for one Fourier Transform, R is the target range, c is the speed of light in a vacuum, and F_{A MAX}−F_{A MIN} is the total frequency excursion of pattern A. The phase of the target frequency peaks in the complex spectrum of the IF signals for sequence A and sequence B, denoted by Ψ_{A} and Ψ_{B} respectively, can be measured and this phase difference ΔΨ=Ψ_{B}−Ψ_{A} can be used to resolve the range and velocity ambiguity, using in the following equation in combination with equation (16):

$$Δ Ψ = \frac{2 π \cdot V \cdot {T}_{P}}{λ \cdot ( N - 1 )} - \frac{4 π \cdot R \cdot Δ {F}_{SHIFT}}{c} \qquad ( 17 )$$

where K is the frequency bin index integer of the Fourier Transform spectrum normalized with respect to frequency, V is the target relative velocity, λ is the wavelength, T_{P} is the measurement period over which the IF is sampled for one Fourier Transform, R is the target range, c is the speed of light in a vacuum, N is the number of frequency steps in each pattern A and B, and ΔF_{SHIFT} is the frequency shift offset between sequence A and B. The above equations (16) and (17) can be used together to resolve the range-velocity ambiguity.

The amplitude of the target peaks can be measured across the n IF signals and used to calculate target direction angle using the amplitude-comparison monopulse direction-finding method. The frequency of the target peaks, containing fine range information, can be measured across the n IF signals and used to calculate target direction angle using the multilateration direction-finding method. The phase of the target frequency peaks in the spectrum can be compared across the n IF signals used to calculate target direction angle using the phase-comparison monopulse or multiple-baseline interferometry direction-finding methods.

FIG. 21E shows a frequency hopping pattern for use in the frequency-hopping signal generator 295 as a yet further embodiment of the present invention. This waveform comprises a randomized, pseudo-random, or pseudo-noise pattern containing a plurality of frequency value steps. In one embodiment, the phase of the down-converted IF signals is used for range calculation. The phase of the target frequency peaks in the complex spectrum of the IF signals measured and Fourier Transformed during each step dwell time T_{S} or adjacent frequency steps can be compared and this phase difference ΔΨ=Ψ_{FIRST}−Ψ_{SECOND} can be calculated, where Ψ_{SECOND} refers to the phase measurement corresponding to the second or later of the two frequency steps and Ψ_{FIRST} refers to the phase measurement corresponding to the first of the two frequency steps. Under these conditions, the target range can be determined as shown by the following equation:

$$R = \frac{c \cdot Δ Ψ}{4 \cdot π \cdot Δ f} \qquad ( 18 )$$

where R is the target range, c is the speed of light in a vacuum, and Δf is the frequency difference between adjacent frequency steps used for the range measurement, defined as Δf=f_{SECOND}−f_{FIRST} where f_{SECOND} corresponds to the second or later frequency step of the pair and f_{FIRST} corresponds to the first frequency step of the pair. In another embodiment, the waveform of FIG. 21E consists of one or more linearly or monotonically frequency stepped patterns where the order of the frequency steps of each pattern is randomized according to a predetermined order. Then after reception, the A/D samples of the IF signal are correctly associated with each pattern and re-ordered to be in a linear or monotonic sequence prior to the application of at least one signal processing function such as, but not limited to, a Fourier Transform or inverse Fourier Transform. The range and relative velocity can then be calculated using equations (14) and (15), with T_{S}, Δf_{S}, f_{U}, f_{D}, f_{MIN} and f_{MAX} relating to the re-ordered sequence and measurements made on the re-ordered sequence.

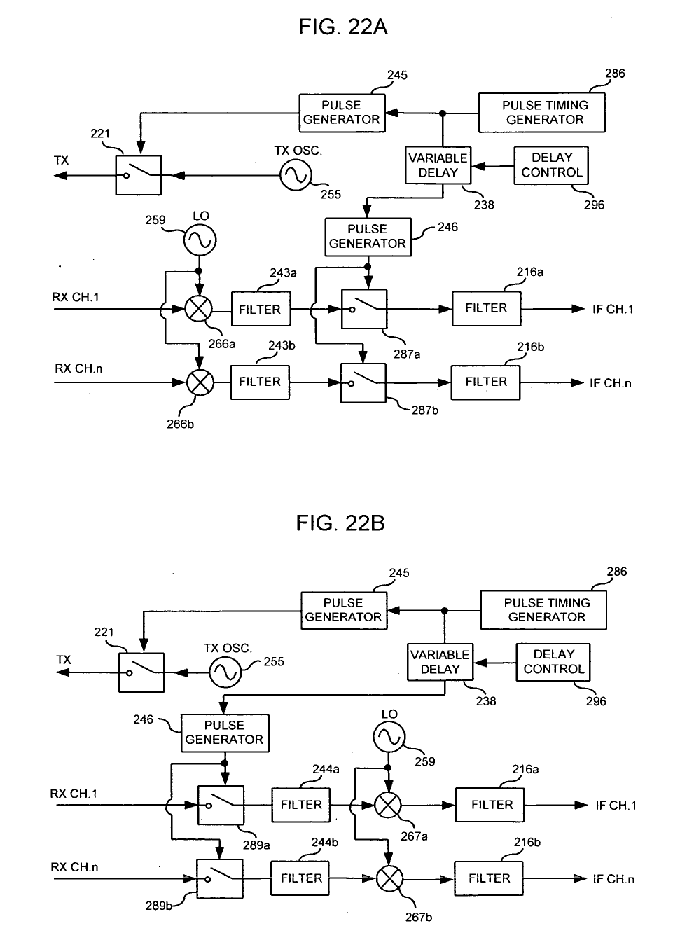

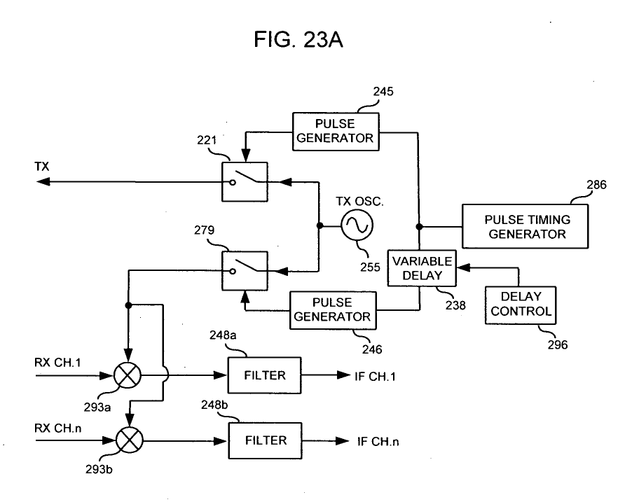

A pulsed WB/UWB/PUWB radar transmitter-receiver arrangement is illustrated in FIG. 22A as one embodiment of WB/UWB/PUWB radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. The received signals are input to n receiver channels, where n is an integer greater than or equal to 2. A local oscillator 259 inputs a CW signal to mixers 266a, 266b where it is mixed with the received signals. The outputs from mixers 266a, 266b are filtered by filters 243a, 243b then input to range gates 287a, 287b. After range gating, the signals are then filtered by filters 216a, 216b and the resulting signals are intermediate frequency (IF) signals containing target information. The modulator 221 can be implemented by, but is not limited to, a pulse modulator, amplitude modulator, bi-phase shift keyed modulator, phase modulator, switch, mixer, or AND gate. Filters 243a, 243b can be implemented by, but are not limited to, band-pass filters. Filters 216a, 216b can be implemented by, but are not limited to, low-pass filters. Mixers 266a, 266b can be implemented by, but are not limited to, mixers, multipliers, or switches without changing the basic functionality of the arrangement. Range gates 287a, 287b can be implemented by, but are not limited to, switches, samplers, detectors, mixers, or multipliers without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention. Furthermore, the arrangement shown in FIG. 22A can be modified by one skilled in the art such that the receiver channels down-convert in quadrature, outputting quadrature IF signals, without changing the basic form or spirit of the invention.

Using the radar arrangement illustrated in FIG. 22A, one method for determining target range, not meant in any way as a limitation, is to vary or sweep the time delay of variable delay 238, and to threshold detect the IF signal during this process. Peaks in the detected power or envelope of the IF signal that exceed a predetermined threshold represent target returns. When a target peak in the IF is detected, the corresponding value of the time delay of variable delay 238 is proportional to the target's range, and is used to calculate target range using the following equation:

$$R = \frac{c \cdot {T}_{D}}{2} \qquad ( 19 )$$

where R is the calculated target range, c is the speed of light in a vacuum, and T_{D} is the value of the time delay of variable delay 238 at the time a target peak in the IF is detected. One way the target's relative velocity can be determined is through calculation from successive target range measurements over predetermined time intervals. The difference in range measured over a time interval can give an estimation of the target's relative velocity.

A pulsed WB/UWB/PUWB radar transmitter-receiver arrangement is illustrated in FIG. 22B as another embodiment of WB/UWB/PUWB radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. The received signals are input to n receiver channels, where n is an integer greater than or equal to 2. The output signal from pulse generator 246 is input to range gates 289a, 289b where it gates the received signals. The outputs from range gates 289a, 289b are filtered by filters 244a, 244b then input to mixers 267a, 267b. After mixing, the signals are then filtered by filters 216a, 216b and the resulting signals are intermediate frequency (IF) signals containing target information. The modulator 221 can be implemented by, but is not limited to, a pulse modulator, amplitude modulator, bi-phase shift keyed modulator, phase modulator, switch, mixer, or AND gate. Filters 244a, 244b can be implemented by, but are not limited to, band-pass filters. Filters 216a, 216b can be implemented by, but are not limited to, low-pass filters. Mixers 267a, 267b can be implemented by, but are not limited to, mixers, multipliers, or switches without changing the basic functionality of the arrangement. Range gates 289a, 289b can be implemented by, but are not limited to, switches, samplers, detectors, mixers, or multipliers without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention. Furthermore, the arrangement shown in FIG. 22B can be modified by one skilled in the art such that the receiver channels down-convert in quadrature, outputting quadrature IF signals, without changing the basic form or spirit of the invention.

Using the radar arrangement illustrated in FIG. 22B, one method for determining target range, not meant in any way as a limitation, is to vary or sweep the time delay of variable delay 238, and to threshold detect the IF signal during this process. Peaks in the detected power or envelope of the IF signal that exceed a predetermined threshold represent target returns. When a target peak in the IF is detected, the corresponding value of the time delay of variable delay 238 is proportional to the target's range, and is used to calculate target range using equation (19). One way the target's relative velocity can be determined is through calculation from successive target range measurements over predetermined time intervals. The difference in range measured over a time interval can give an estimation of the target's relative velocity.

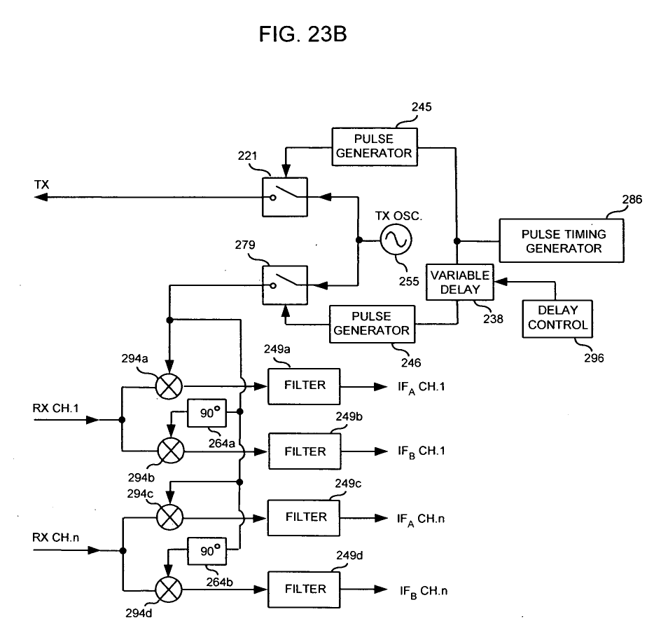

A pulsed WB/UWB/PUWB radar transmitter-receiver arrangement is illustrated in FIG. 23A as another embodiment of WB/UWB/PUWB radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. The received signals are input to n receiver channels, where n is an integer greater than or equal to 2. The output signal from pulse generator 246 is input to pulse modulator 279 where it pulse modulates the CW signal from oscillator 255. The output signal from pulse modulator 279 is input to mixers 293a, 293b where it mixes with the received signals. The outputs from mixers 293a, 293b are filtered by filters 248a, 248b and the resulting signals are intermediate frequency (IF) signals containing target information. The modulators 221, 279 can each be implemented by, but are not limited to, a pulse modulator, amplitude modulator, bi-phase shift keyed modulator, phase modulator, switch, mixer, or AND gate. Filters 248a, 248b can be implemented by, but are not limited to, low-pass filters. Mixers 293a, 293b can be implemented by, but are not limited to, mixers, multipliers, switches, samplers, detectors, or correlators without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

FIG. 23B illustrates a pulsed WB/UWB/PUWB transmitter-receiver arrangement as another embodiment of WB/UWB/PUWB radar transmitter-receiver 200. The arrangement in FIG. 23B is similar to the arrangement in FIG. 23A except for the implementation of a quadrature receiver down-converter by replacing mixers 293a, 293b and filters 248a, 248b with mixers 294a, 294b, 294c, 294d and filters 249a, 249b, 249c, 249d, as well as the addition of 90 degree phase shifters 264a, 264b. The same components are denoted by the same reference numerals, and will not be explained again. In this arrangement, the output of pulse modulator 279 feeds the 90 degree phase shifters 264a, 264b as well as mixers 294a, 294c. The receiver channels 1 and n are each split. Receiver channel 1 feeds mixers 294a, 294b, while receiver channel n feeds mixers 294c, 294d as shown. The output signals from mixers 294a, 294b, 294c, 294d are then filtered by filters 249a, 249b, 249c, 249d and the resulting signals are quadrature intermediate frequency (IF) signals containing target information.

One method for determining target range for the radar arrangements in FIG. 23A-B, not meant in any way as a limitation, is to vary or sweep the time delay of variable delay 238, and to threshold detect the IF signal during this process. Peaks in the detected power or envelope of the IF signal that exceed a predetermined threshold represent target returns. This occurs when the correlation is high between the delayed pulse pattern output of pulse generator 246 and the reflected pulse pattern from a target. When a target peak in the IF is detected, the corresponding value of the time delay of variable delay 238 is proportional to the target's range, and is used to calculate target range using equation (19), where R is the calculated target range, c is the speed of light in a vacuum, and TD is the value of the time delay of variable delay 238 at the time a target peak in the IF is detected. One way the target's relative velocity can be determined is through calculation from successive target range measurements over predetermined time intervals. The difference in range measured over a time interval can give an estimation of the target's relative velocity.

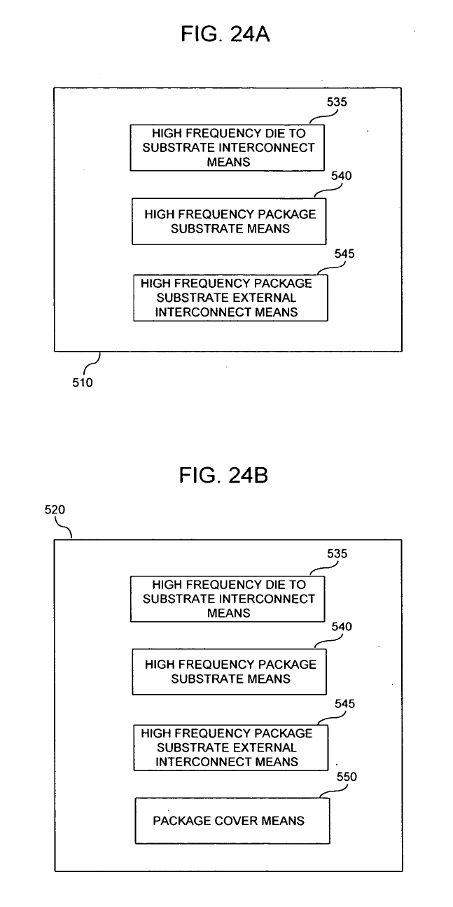

One embodiment of the generalized diagram shown in FIG. 24A illustrates the features of a surface mountable integrated circuit packaging means 510 for radar applications capable of packaging one or a plurality of integrated circuit die containing at least one high frequency signal port in a low-cost, mass-production capable unit, in accordance with aspects of the present invention. The aforementioned term “high frequency” refers to a frequency greater than or equal to 5 GHz such as, but not limited to, 24 GHz. An integrated circuit die is connected to a high frequency package substrate means 540 using a high frequency die to substrate interconnect means 535. An integrated circuit die can comprise, but is not limited to, a silicon circuit die containing a plurality of transistors, a silicon-germanium circuit die containing a plurality of transistors, a gallium-arsenide circuit die containing a plurality of transistors, an indium-phosphide circuit die containing a plurality of transistors, or an InGaP circuit die containing a plurality of transistors. The high frequency die to substrate interconnect means 535 can comprise, but is not limited to, epoxy die attach, solder die attach, flip-chip, or wire-bonding. The high frequency package substrate means 540 can comprise, but is not limited to, a ceramic single or multilayer substrate, a laminate single or multilayer substrate, a low temperature co-fired ceramic (LTCC) single or multilayer substrate, a high temperature co-fired ceramic (HTCC) single or multilayer substrate, a high thermal coefficient of expansion (HiTCE) LTCC single or multilayer substrate, or a plastic single or multilayer substrate. The substrate metallization can comprise, but is not limited to, thick-film metallization, thin-film metallization, plated metallization, electro-deposited metallization, rolled metallization, or laminated metallization. The substrate vias can comprise, but are not limited to, filled vias, plated vias, non-filled vias, through vias, partial vias, or blind vias. The high frequency package substrate means 540 is connected to an external circuit by way of a high frequency package substrate external interconnect means 545. The high frequency package substrate external interconnect means 545 can comprise, but is not limited to, surface mountable pad array interconnects, surface mountable ball grid array (BGA) interconnects, or surface mountable castellated pads.

One embodiment of the generalized diagram shown in FIG. 24B illustrates the features of a surface mountable integrated circuit packaging means 520 for radar applications capable of packaging one or a plurality of integrated circuit die containing at least one high frequency signal port in a low-cost, mass-production capable unit, in accordance with aspects of the present invention. The aforementioned term “high frequency” refers to a frequency greater than or equal to 5 GHz such as, but not limited to, 24 GHz. The arrangement illustrated in FIG. 24B is similar to the arrangement of FIG. 24A except for the addition of a package cover means 550. The same components are denoted by the same reference numerals, and will not be explained again. The package cover means 550 can be used for, but is not limited to, physical protection of the integrated circuit die, handling or marking purposes, or thermal heat extraction from the package. The package cover means 550 construction material can comprise, but is not limited to, metal or metal alloy, ceramic, laminate, thermo-plastic, or plastic.

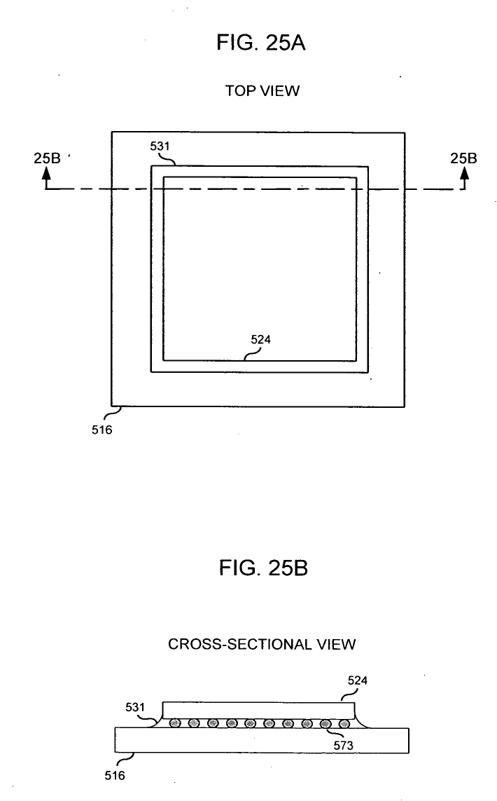

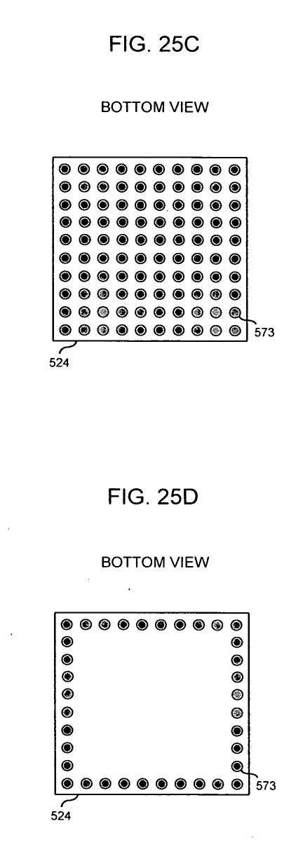

An integrated circuit die to substrate interconnection arrangement is illustrated in FIGS. 25A-B as one embodiment of the high frequency die to substrate interconnect means 535. In this arrangement, an integrated circuit die 524 is flip-chip mounted to a high frequency substrate 516. The input and output ports of the die 524 make circuit connections to the substrate through the flip-chip connection means 573. An integrated circuit die can comprise, but is not limited to, a silicon circuit die containing a plurality of transistors, a silicon-germanium circuit die containing a plurality of transistors, a gallium-arsenide circuit die containing a plurality of transistors, an indium-phosphide circuit die containing a plurality of transistors, or an InGaP circuit die containing a plurality of transistors. The flip-chip connection means 573 can comprise, but are not limited to, solder or gold balls. The flip-chip mounting method can comprise, but is not limited to, soldering techniques, reflow techniques, or thermo-compression techniques. An underfill material 531 is dispensed after the flip-chip mounting procedure, between the die and substrate, and cured. One benefit of the underfill material is the reduction of stress on the flip-chip connection means 573 through a distribution of the die to substrate connection stresses over die surface area. The flip-chip die to substrate interconnection method can support high frequency signals between the die and the substrate due to the low inductance and short length of the flip-chip connection means. As an alternate embodiment of the high frequency die to substrate interconnect means 535, the step of dispensing the underfill material 531 can be eliminated.

FIGS. 25C-D illustrate two distribution patterns for the flip-chip connection means 573 on the integrated circuit die 524 according to aspects of the present invention. An evenly distributed area array pattern in shown in FIG. 25C, and a perimeter area array pattern in shown in FIG. 25D. The patterns described are for illustration purposes only, and are not meant as a limitation. The patterns described can be modified by one skilled in the art without departing from the spirit of the present invention. For example, not in any way meant as a restriction, the pattern illustrated in FIG. 25C may contain areas where the flip-chip connection means 573 are removed, rows may be unevenly distributed or offset from each other, or the pattern shown in FIG. 25D may have a plurality of rows on the perimeter or have rows within the plurality offset from each other, or be distributed in a non-equally spaced pattern. Conditions that may influence the distribution patterns of the flip-chip connection means 573 can comprise, but are not limited to, space or location limitation on the integrated circuit die 524, underfill dispense flow considerations, or flip-chip process requirements.

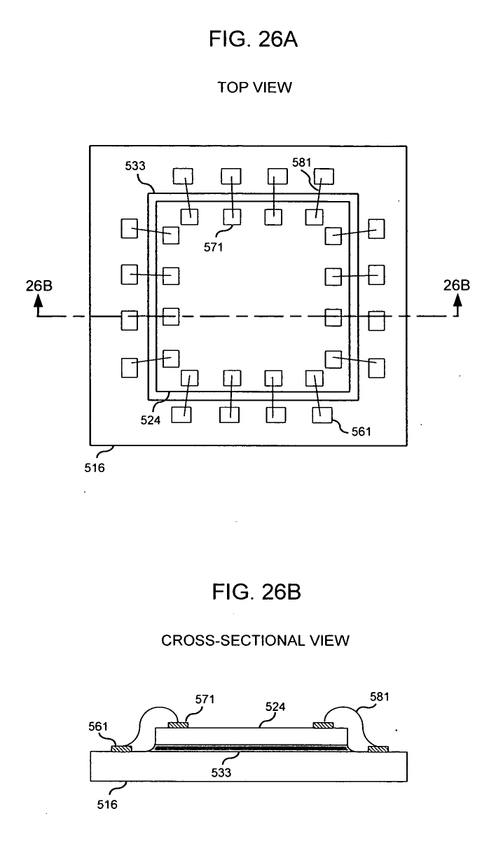

An integrated circuit die to substrate interconnection arrangement is illustrated in FIGS. 26A-B as one embodiment of the high frequency die to substrate interconnect means 535. In this arrangement, an integrated circuit die 524 is mounted to a high frequency substrate 516 using a die attach material 533. The input and output bond pads 571 of the die 524 make circuit connections to the substrate circuit connection ports 561 through wire-bond connection means 581. The die attach material 533 can comprise, but is not limited to, electrically conductive epoxy, electrically non-conductive epoxy, or solder. The wire-bond connection means 581 can comprise, but is not limited to, gold round wire, gold ribbon wire, aluminum round wire, aluminum ribbon wire, or alloy round or ribbon wire. The wire-bond die to substrate interconnection method can support high frequency signals between the die and the substrate provided that the wire lengths are designed to be short enough not to adversely affect the die performance over the frequency range required by the application, or that the wire-bond parameters are taken into account in the design of the integrated circuit die.

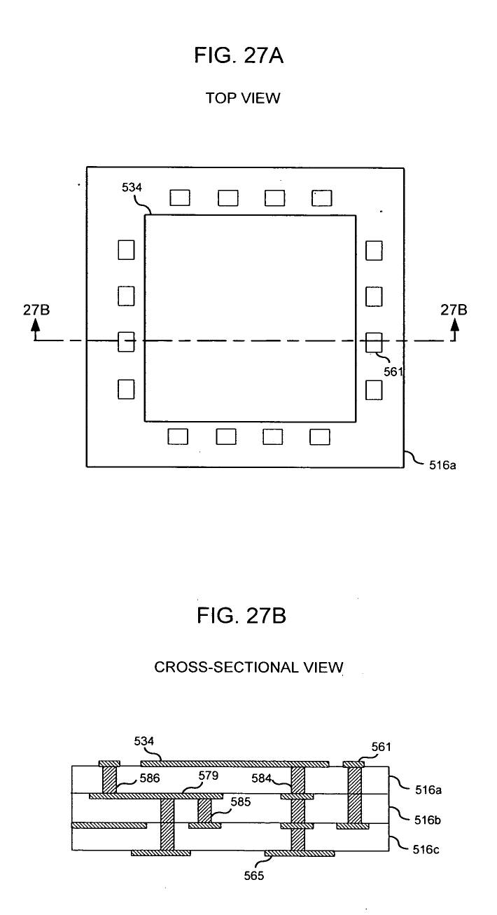

FIGS. 27A-B illustrate the top and cross-sectional views of one embodiment of the high frequency package substrate means 540, according to aspects of the present invention. In this arrangement, a substrate contains one or a plurality of dielectric layers 516a, 516b, 516c. Metallization patterns can be placed on the top surface such as illustrated by 534, 561, on the bottom surface such as illustrated by 565, or on the inner layers of the substrate between dielectric layers such as illustrated by 579. The metallization layers can be connected through the use of through via vertical interconnects such as illustrated by 584, partial via interconnects such as illustrated by 586, or blind via interconnects such as illustrated by 585. The via interconnects can be, but are not limited to, filled or plugged to be essentially solid metal, partially filled such that the via still maintains connectivity but is not completely filled with metal, or peripherally filled such that the via passage is not filled with metal but the walls of the via passage contain metal and maintain connectivity such as with a metal plating process. The substrate dielectric layers 516a, 516b, 516c can comprise, but are not limited to, a ceramic material, a laminate or PC board material, a low temperature co-fired ceramic (LTCC) material, a high temperature co-fired ceramic (HTCC) material, a high thermal coefficient of expansion (HiTCE) LTCC material, or a plastic material. The substrate metallization can comprise, but is not limited to, thick-film metallization, thin-film metallization, plated metallization, electro-deposited metallization, rolled metallization, or laminated metallization. The abovementioned substrate arrangement provides the necessary elements for a design to support high frequency signals and interconnections.

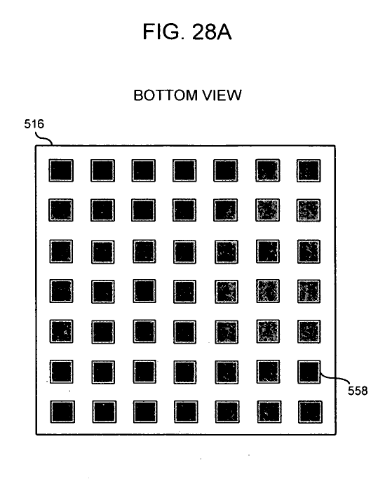

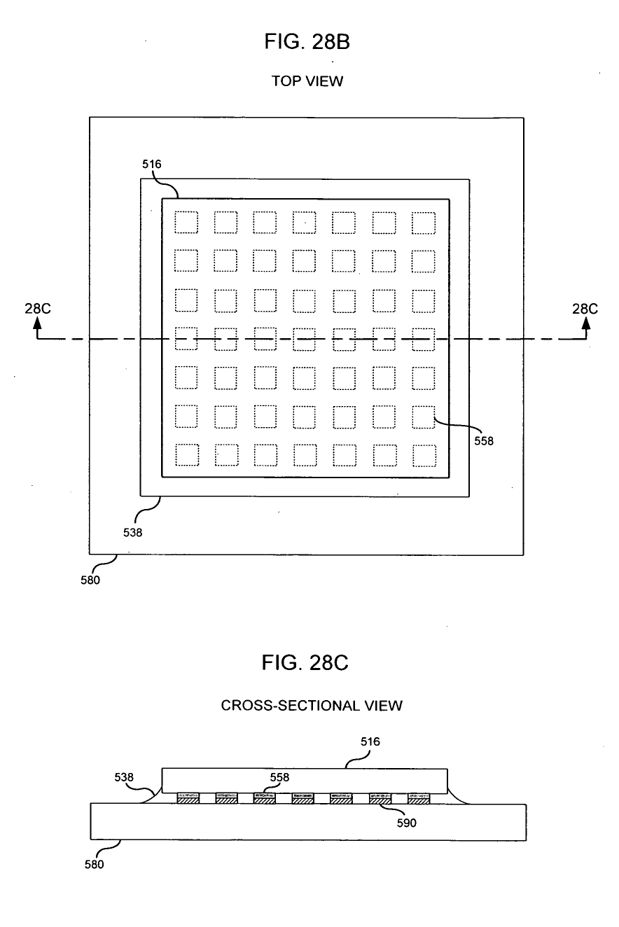

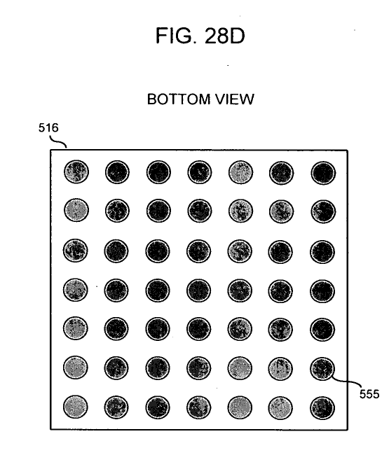

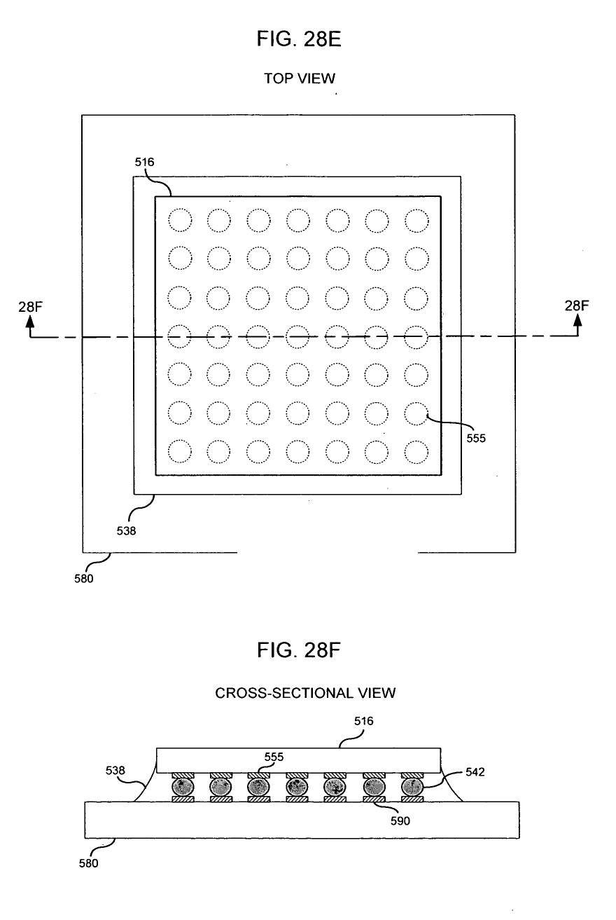

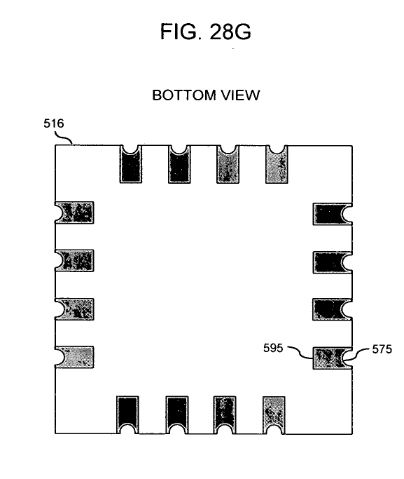

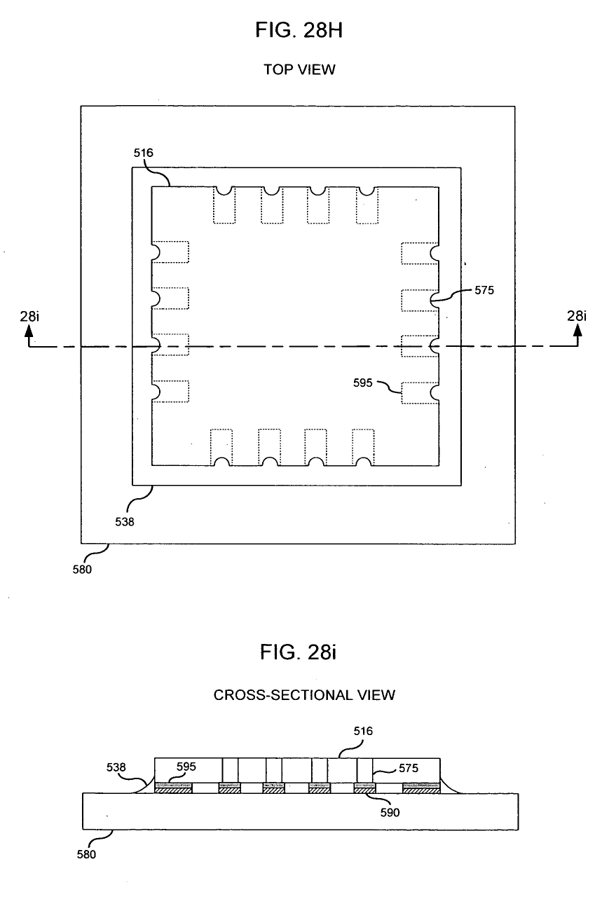

A substrate external interconnection pad arrangement and mounting method is illustrated in FIGS. 28A-C as one embodiment of the high frequency package substrate external interconnect means 545. In this arrangement, patterned metal pads 558 are arranged on the bottom surface of the package substrate 516 as shown in FIG. 28A. The purpose of the pads 558 can be, but is not limited to, providing circuit interconnection between the package substrate and an external circuit such as, but not limited to, a laminate board. The pad pattern shown is for the purpose of illustration, and is not meant as a restriction. The number of pads, pad sizes, and pad shapes can be modified without departing from the spirit of the present invention. FIG. 28B illustrates the top view of a substrate 516 utilizing the abovementioned pad interconnection arrangement, mounted on an external circuit board 580. A cross-sectional view of this mounting method is shown in FIG. 28C. The substrate 516 containing interconnection pads 558 is attached to an external circuit board 580. The interconnection pads 558 attach to patterned metal pads 590 on the external circuit board 580 using for example, but not limited to, solder for the attachment means. An optional underfill process 538 can be used after attachment for the purpose of, but not limited to, increasing the reliability of the attachment, but is not absolutely required. The attachment process may include, but is not limited to, a reflow soldering process. The external circuit board may comprise a single or plurality of dielectric and metal layers, and may include, but is not limited to, a laminate supporting high frequency circuit operation, a personal computer (PC) board material supporting high frequency circuit operation, a ceramic material supporting high frequency circuit operation, an LTCC material supporting high frequency circuit operation, an HTCC material supporting high frequency circuit operation, or a HiTCE LTCC material supporting high frequency circuit operation. The abovementioned substrate to external circuit board interconnection method can support high frequency circuit interconnection due to, but not limited to, the low inductance and short length of the pad connection means.

A substrate external interconnection arrangement and mounting method is illustrated in FIGS. 28D-F as one embodiment of the high frequency package substrate external interconnect means 545. In this arrangement, patterned metal pads 555 are arranged on the bottom surface of the package substrate 516 as shown in FIG. 28D. The purpose of the pads 555 can be, but is not limited to, providing circuit interconnection between the package substrate and an external circuit such as, but not limited to, a circuit board. The pad pattern shown is for the purpose of illustration, and is not meant as a restriction. The number of pads, pad sizes, and pad shapes can be modified without departing from the spirit of the present invention. FIG. 28E illustrates the top view of a substrate 516 utilizing the abovementioned pad interconnection arrangement, mounted on an external circuit board 580. A cross-sectional view of this mounting method is shown in FIG. 28F. The substrate 516 containing interconnection pads 555 is attached to an external circuit board 580. The interconnection pads 555 attach to patterned metal pads 590 on the external circuit board 580 using for example, but not limited to, pre-formed solder balls 542. The pre-formed solder balls 542 can be attached to the substrate pads 555 prior to the attachment process to the external circuit board 580. Under those conditions, the substrate 516 can be termed to comprise a ball grid array (BGA) interconnection arrangement. An optional underfill process 538 can be used after attachment for the purpose of, but not limited to, increasing the reliability of the attachment, but is not absolutely required. The attachment process may include, but is not limited to, a reflow soldering process. The external circuit board may comprise a single or plurality of dielectric and metal layers, and may include, but is not limited to, a laminate supporting high frequency circuit operation, a PC board material supporting high frequency circuit operation, a ceramic material supporting high frequency circuit operation, an LTCC material supporting high frequency circuit operation, an HTCC material supporting high frequency circuit operation, or a HiTCE LTCC material supporting high frequency circuit operation. The abovementioned substrate to external circuit board interconnection method can support high frequency circuit interconnection due to, but not limited to, the low inductance and short length of the pad connection means.

A substrate external interconnection arrangement and mounting method is illustrated in FIGS. 28G-i as one embodiment of the high frequency package substrate external interconnect means 545. In this arrangement, patterned metal pads 595 are arranged on the bottom surface of the package substrate 516 as shown in FIG. 28G. Vertical substrate side-wall metallizations 575 make electrical connection between the pads 595 on the substrate bottom-side and the circuitry on the substrate top-side or inner layers. The vertical substrate side-wall metallizations 575 can comprise, but are not limited to, edge wrap metallization, castellations, hemispherical or semi-hemispherical metallized vias, metallized slots on the substrate edge, or any suitable metallized vertical interconnect with at least part of the metal interconnect exposed on the substrate edge. The purpose of the pads 595 can be, but is not limited to, providing circuit interconnection between the package substrate and an external circuit such as, but not limited to, a circuit board. The pad pattern shown is for the purpose of illustration, and is not meant as a restriction. The number of pads, pad sizes, and pad shapes can be modified without departing from the spirit of the present invention. FIG. 28H illustrates the top view of a substrate 516 utilizing the abovementioned pad interconnection arrangement, mounted on an external circuit board 580. A cross-sectional view of this mounting method is shown in FIG. 28i. The substrate 516 containing interconnection pads 595 is attached to an external circuit board 580. The interconnection pads 595 attach to patterned metal pads 590 on the external circuit board 580 using for example, but not limited to, solder. An optional underfill process 538 can be used after attachment for the purpose of, but not limited to, increasing the reliability of the attachment, but is not absolutely required. The attachment process may include, but is not limited to, a reflow soldering process. The external circuit board may comprise a single or plurality of dielectric and metal layers, and may include, but is not limited to, a laminate supporting high frequency circuit operation, a PC board material supporting high frequency circuit operation, a ceramic material supporting high frequency circuit operation, an LTCC material supporting high frequency circuit operation, an HTCC material supporting high frequency circuit operation, or a HiTCE LTCC material supporting high frequency circuit operation. The abovementioned substrate to external circuit board interconnection method can support high frequency circuit interconnection due to, but not limited to, the low inductance and short length of the pad connection means.

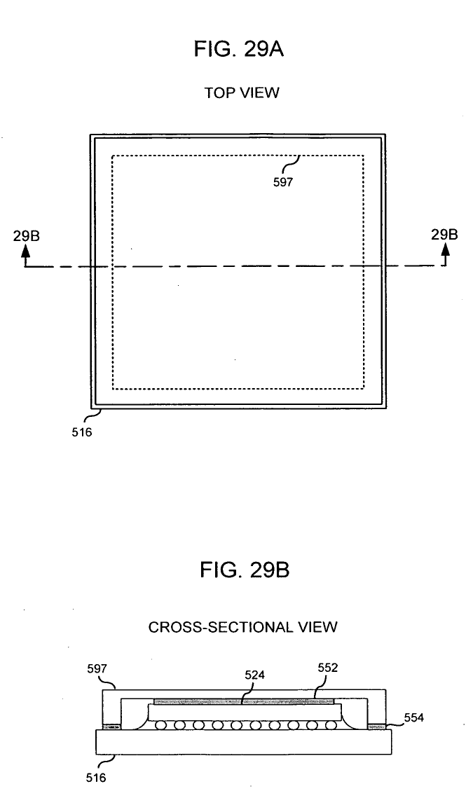

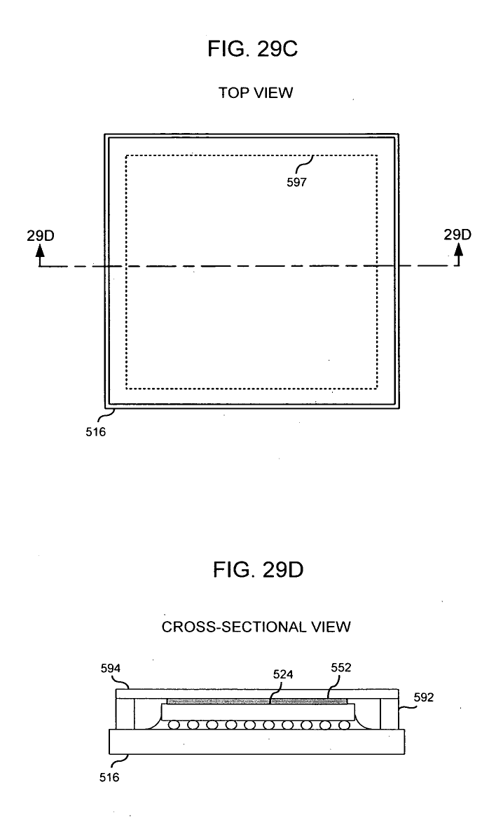

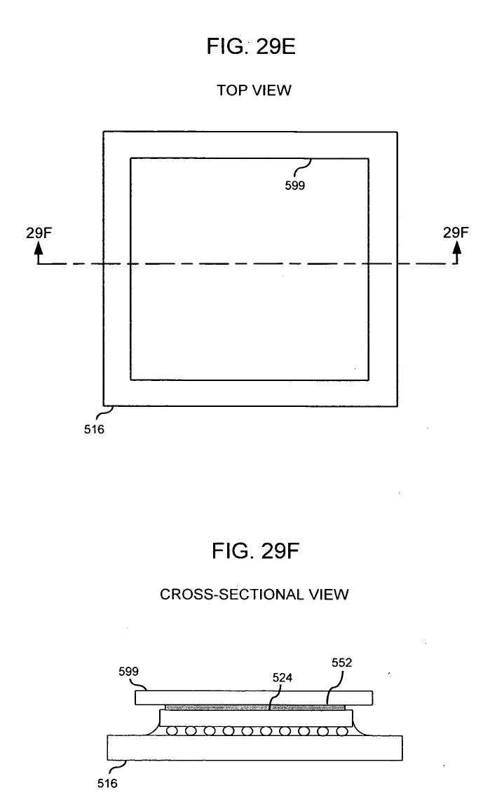

A package cover arrangement and method is illustrated in FIGS. 29A-B as one embodiment of the package cover means 550. In this arrangement, a one-piece package cover 597 is attached to the substrate 516. The cover 597 is attached to the substrate using an attachment material 554. The attachment material can comprise, but is not limited to, conductive or non-conductive epoxy, conductive or non-conductive film, or solder. The method of attaching the cover to the substrate can include, but is not limited to, dispense of epoxy and cure, attachment of film and cure, attachment of film and cure with pressure applied to cover during cure, or solder reflow. The cover material can comprise, but is not limited to, metal, metal alloy, ceramic, laminate, LTCC, HTCC, HiTCE LTCC, graphite, thermo-plastic, or plastic. The cover shape may be modified by one skilled in the art without departing from the spirit of the present invention. The cover can optionally be attached to the integrated circuit die 524 in addition, using an attachment material 552. The attachment of the cover to the integrated circuit die is optional, and is not required. One benefit to the attachment of the cover to the integrated circuit die 524 is the ability to use the cover as an electrical connection and/or package heat extraction means, under the conditions that the cover is constructed of the proper material to realize these benefits. The mounting method shown of the integrated circuit die to the substrate using a flip-chip means is only for illustration purposes only, and is not meant as a restriction. The integrated circuit die may also be attached using, but not limited to, a wire-bond method.

A package cover arrangement and method is illustrated in FIGS. 29C-D as one embodiment of the package cover means 550. In this arrangement, a two-piece package cover method comprising a lid 594 and seal ring 592 are utilized to cover the substrate 516. The seal ring feature 592 may be an integral part of the substrate 516 and be composed of the same material as the substrate 516, or may be a separate piece attached to the substrate 516. The seal ring material can comprise, but is not limited to, metal, metal alloy, ceramic, laminate, LTCC, HTCC, HiTCE LTCC, graphite, thermo-plastic, or plastic. The seal ring 592 can be attached to substrate 516 using a material comprising, but not limited to, conductive or non-conductive epoxy, conductive or non-conductive film, solder, eutectic alloy, or metal or alloy brazing material. The lid 594 may contain a feature such as, but not limited to, a thinned periphery or raised rim for the purpose of, but not limited to, aiding in lid centering, improvement in the seam or laser welding sealing process, or weight reduction without departing from the spirit of the present invention. The lid 594 can be attached to the seal ring 592 using, but not limited to, conductive or non-conductive epoxy, conductive or non-conductive film, solder, eutectic alloy, metal or alloy brazing material, seam welding process, or laser welding process. The lid material can comprise, but is not limited to, metal, metal alloy, ceramic, laminate, LTCC, HTCC, HiTCE LTCC, graphite, thermoplastic, or plastic. The lid 594 can optionally be attached to the integrated circuit die 524 in addition, using an attachment material 552. The attachment of the lid to the integrated circuit die is optional, and is not required. One benefit to the attachment of the lid to the integrated circuit die 524 is the ability to use the lid as an electrical connection and/or package heat extraction means, under the conditions that the lid is constructed of the proper material to realize these benefits. The mounting method shown of the integrated circuit die to the substrate using a flip-chip means is only for illustration purposes only, and is not meant as a restriction. The integrated circuit die may also be attached using, but not limited to, a wire-bond method.

A package cover arrangement and method is illustrated in FIGS. 29E-F as one embodiment of the package cover means 550. In this arrangement, the cover method comprises a lid 599 that is attached to the surface of a single or plurality of integrated circuit die 524 using a lid attachment means 552. The lid material can comprise, but is not limited to, metal, metal alloy, ceramic, laminate, LTCC, HTCC, HiTCE LTCC, graphite, thermo-plastic, plastic, or eutectic alloy. The lid 599 can be attached to the surface of the die 524 using a material comprising, but not limited to, conductive or non-conductive epoxy, conductive or non-conductive film, solder, or eutectic alloy. The lid 594 may contain a feature such as, but not limited to, a raised rim for the purpose of, but not limited to, aiding in lid centering without departing from the spirit of the present invention. The mounting method shown of the integrated circuit die to the substrate using a flip-chip means is only for illustration purposes only, and is not meant as a restriction.

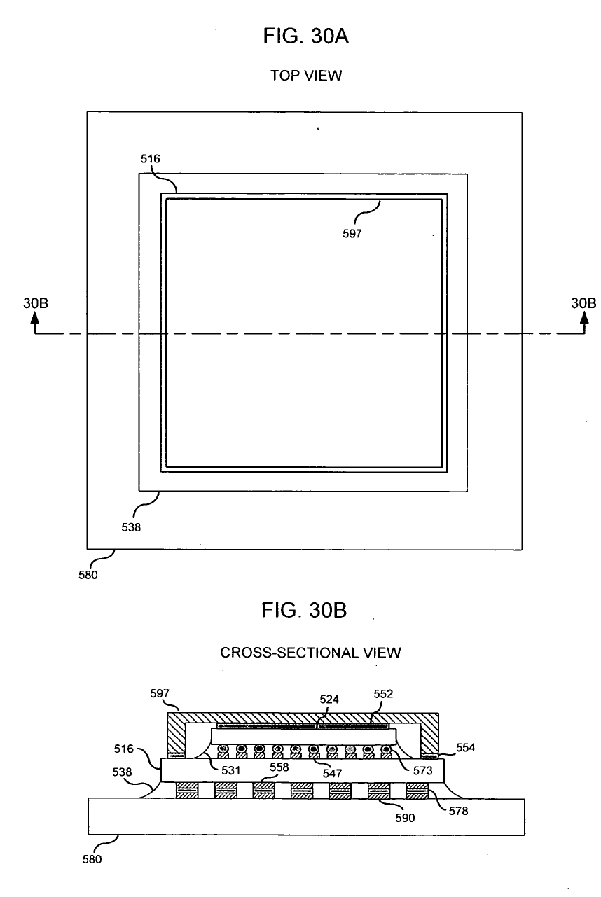

An example of an integrated circuit packaging means and external interconnection method using some of the aforementioned aspects of the present invention is illustrated in FIGS. 30A-B. The arrangement and method described is for illustration purposes and is not meant as a restriction. In this arrangement, a silicon-germanium integrated circuit die 524 is mounted to a substrate 516 using a flip-chip mounting method with solder bumps 573. On the top surface of the substrate are patterned metal pads 547 onto which the flip-chip solder bumps are attached. An underfill material 531 is dispensed between the die 524 and the substrate 516. A package cover 597 is attached to the substrate 516 using a dispensed electrically conductive epoxy attachment means 554 and is also attached to the surface of the integrated circuit die 524 using a dispensed thermally conductive epoxy attachment means 552. The lid is constructed of an electrically and thermally conductive metal or metal alloy. The substrate 516 is constructed of a plurality of dielectric and metal layers using a thick-film HiTCE LTCC process with filled, metallized vias. The bottom-side of the substrate 516 is patterned with an array of metal pads 558 for attachment to a circuit board 580. The top surface of circuit board 580 is patterned with metal pads 590 onto which the metal pads 558 on the bottom of substrate 516 will be attached using solder 578. The circuit board 580 is constructed of a plurality of dielectric and metal layers using a high frequency, low loss laminate material with copper metallization and drilled and plated via interconnects.

One example of a low cost radar sensor unit arrangement which achieves integrated target range, angle, and direction determination capability through a combination of some of the aforementioned aspects of the present invention is described below. This example is for illustration purposes only and is not meant as a restriction. The electrical block diagram of this sensor arrangement is illustrated in FIG. 2A. For this arrangement, let the number of receive channels n be equal to 4, with spatial separations according to a harmonic multiple baseline distribution as described in FIG. 5C. For the transmit antenna means 11, the antenna means embodiment described in FIG. 10D is used designed for a wide angle beam width coverage, and for receive antenna means 19, 20 the antenna means embodiment described in FIG. 10H is used designed for a switched beam coverage as shown in FIG. 10i. The planar antenna element embodiment shown in FIGS. 9A-B is used for antenna elements 161, 162, 164, 165, 184, 185. For the WB/UWB/PUWB radar transmitter-receiver 200, the embodiment described in FIG. 11B is used with the embodiment of the modulation signal generator 230 as described in FIG. 12C. Modulation patterns as described in FIG. 13A and FIG. 14B are used. For the interferometric signal processor 300, the embodiment described in FIG. 4D is used, with a DSP chosen for the processor means, and the direction-finding method used is multiple baseline interferometry. The high frequency circuitry associated with the WB/UWB/PUWB transmitter-receiver 200 is implemented in a silicon-germanium integrated circuit die, which is packaged and interconnected to a multilayer laminate circuit board as shown in FIGS. 30A-B. The planar antenna elements are integrated into the same multilayer laminate circuit board, onto which the A/D converter, DSP, low frequency circuitry components of the transmitter-receiver 200, and other support electronics are also mounted. The result is a compact, low cost, laminate board integrated radar sensor unit that is capable of mass production.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A radar method for motor vehicles for determining characteristics of a target, comprising:
modulating a pulse repetition interval of pulses to generate a transmission signal;
transmitting said transmission signal;
receiving a reflected portion of said transmitted signal from said target by a plurality of antennas to output a plurality of signals representing said reflected portion;
downconverting said plurality of signals;
generating difference signals based on said plurality of signals and said transmission signal;
determining at least one of a target range and a target relative velocity based on at least one of the frequency and phase components of said difference signals; and
determining target direction based on at least one of the amplitude and phase difference between components of at least two of said difference signals.

2. The method of claim 1, wherein determining at least one of said target range and said target relative velocity comprises performing a Fourier transformation on said difference signals and evaluating at least one of the frequency and phase of a peak above a predetermined threshold occurring in said Fourier transformation to determine at least one of said frequency and phase components of said difference signals.

3. The method of claim 2, wherein determining target direction comprises using at least one of the amplitude and phase difference between peaks occurring between said Fourier transformations of at least two difference signals.

4. The method of claim 1, wherein at least two of said antennas have spatially separated locations.

5. The method of claim 1, wherein at least two of said antennas have different directional gain patterns.

6. The method of claim 1, wherein determining target direction comprises using a phase monopulse direction-finding comparison of said difference signals.

7. The method of claim 6, wherein said plurality of antennas comprise a plurality of switched receive beams, each of said switched receive beams having a different directional gain pattern.

8. The method of claim 1, wherein determining target direction comprises using an interferometry direction-finding comparison of said difference signals.

9. The method of claim 8, wherein said plurality of antennas comprise a plurality of switched receive beams, each of said switched receive beams having a different directional gain pattern.

10. The method of claim 1, further comprising determining target direction using a super-resolution algorithm.

11. The method of claim 1, wherein determining target direction comprises using an amplitude monopulse direction-finding comparison of said difference signals.

12. The method of claim 1, wherein modulating a pulse repetition interval of pulses to generate a transmission signal comprises at least one of amplitude modulation, on-off keying, phase modulation, and bi-phase modulation.

13. The method of claim 1, wherein modulating a pulse repetition interval of pulses to generate a transmission signal comprises varying said pulse repetition interval with respect to time during a predetermined time interval.

14. The method of claim 13, wherein varying said pulse repetition interval comprises linear variation.

15. The method of claim 13, wherein varying said pulse repetition interval comprises monotonic variation.

16. The method of claim 1, wherein modulating a pulse repetition interval of pulses comprises stepping of said pulse repetition interval with respect to time during a predetermined time interval.

17. The method of claim 16, wherein said stepping comprises linear stepping.

18. The method of claim 17, further comprising rearranging the order of said stepped pulse repetition interval modulation according to a predetermined order.

19. The method of claim 16, further comprising interleaving a plurality of stepped pulse repetition interval sequences during a predetermined time interval.

20. The method of claim 1, wherein said pulses comprise pulses of a carrier signal.

21. The method of claim 1, wherein transmitting said transmission signal comprises transmitting a single sideband of said transmission signal.

22. The method of claim 1, further comprising interrupting said transmission signal, said interruption occurring at a transmission interruption frequency.

23. The method of claim 1, further comprising interrupting said plurality of signals, said interruption occurring at a reception interruption frequency.

24. The method of claim 1, further comprising interrupting said transmission signal and said plurality of signals, said transmission signal being interrupted when said plurality of signals are not interrupted, and said plurality of signals being interrupted when said transmission signal is not interrupted.

25. The method of claim 24, further comprising performing a second downconversion of said plurality of received signals.

26. The method of claim 1, further comprising performing a second downconversion of said plurality of signals.

27. The method of claim 26, wherein performing a second downconversion of said plurality of signals comprises downconverting with a signal having a frequency equal to a receive interruption frequency.

28. The method of claim 1, wherein said plurality of antennas comprise a plurality of switched receive beams, each of said plurality of switched receive beams having a different directional gain pattern.

29. The method of claim 28, further comprising performing a second downconversion of said plurality of signals.

30. The method of claim 28, further comprising interrupting said plurality of signals with a reception interruption frequency.

31. The method of claim 30, further comprising performing a second downconversion of said plurality of signals.

32. The method of claim 1, wherein a bandwidth occupied by said transmission signal during a coherent measurement time duration is at least wideband.

33. A radar method for motor vehicles for determining characteristics of a target, comprising:
modulating the frequency of a carrier signal to generate a transmission signal using a plurality of discontinuous frequency changes during a coherent measurement time duration;
transmitting said transmission signal;
receiving a reflected portion of said transmitted signal from said target by a plurality of spatially separated antennas to output a plurality of signals representing said reflected portion;
downconverting said plurality of signals;
generating difference signals based on said plurality of signals and said transmission signal;
determining at least one of a target range and a target relative velocity based on at least one of the frequency and phase components of said difference signals; and
determining target direction based on a phase difference between components of at least two of said difference signals.

34. The method of claim 33, wherein determining at least one of said target range and said target relative velocity comprises performing a Fourier transformation on said difference signals and evaluating at least one of the frequency and phase of a peak above a predetermined threshold occurring in said Fourier transformation to determine at least one of said frequency and phase components of said difference signals.

35. The method of claim 34, wherein determining target direction comprises using a phase difference between peaks occurring between said Fourier transformations of at least two difference signals.

36. The method of claim 33, wherein modulating the frequency of a carrier signal to generate a transmission signal using a plurality of discontinuous frequency changes comprises linear frequency stepping with respect to time.

37. The method of claim 36, further comprising interleaving a plurality of stepped frequency sequences.

38. The method of claim 36, further comprising re-arranging the order of said linear frequency stepping modulation according to a predetermined order.

39. The method of claim 33, wherein modulating the frequency of a carrier signal comprises frequency hopping with respect to time.

40. The method of claim 39, further comprising interleaving a plurality of frequency hopped sequences.

41. The method of claim 39, further comprising re-arranging the order of said frequency hopping modulation according to a predetermined order.

42. The method of claim 33, wherein determining target direction comprises using a phase monopulse direction-finding comparison of said difference signals.

43. The method of claim 42, wherein said plurality of spatially separated antennas comprise a plurality of switched receive beams, each of said switched receive beams having a different directional gain pattern.

44. The method of claim 33, wherein determining target direction comprises using an interferometry direction-finding comparison of said difference signals.

45. The method of claim 44, wherein said plurality of spatially separated antennas comprise a plurality of switched receive beams, each of said switched receive beams having a different directional gain pattern.

46. The method of claim 33, wherein determining target direction comprises using a super-resolution algorithm.

47. The method of claim 33, further comprising pulsing said transmission signal through at least one of amplitude modulation, on-off keying, phase modulation, and bi-phase modulation.

48. The method of claim 33, further comprising interrupting said transmission signal, said interruption occurring at an interruption transmission frequency.

49. The method of claim 48, further comprising performing a second downconversion of said difference signals.

50. The method of claim 33, further comprising interrupting said plurality of signals, said interruption occurring at a reception interruption frequency.

51. The method of claim 50, further comprising performing a second downconversion of said difference signals.

52. The method of claim 51, wherein performing a second downconversion comprises downconverting with a downconversion signal having a frequency equal to said reception interruption frequency.

53. The method of claim 33, further comprising interrupting said transmission signal and said plurality of signals, said transmission signal being interrupted during the time when said plurality of signals are not interrupted, and said plurality of signals being interrupted during the time when said transmission signal is not interrupted.

54. The method of claim 33, wherein said plurality of spatially separated antennas comprise a plurality of switched receive beams, each of said switched receive beams having a different directional gain pattern.

55. The method of claim 54, further comprising performing a second downconversion of said difference signals.

56. The method of claim 54, further comprising interrupting said plurality of signals, said interruption occurring at a reception interruption frequency.

57. The method of claim 56, further comprising performing a second downconversion of said difference signals.

58. The method of claim 33, further comprising performing a second downconversion of said difference signals.

59. The method of claim 33, wherein a bandwidth occupied during a coherent measurement time duration of said transmission signal is at least wideband.
